(19) United States
(12) Patent Application Publication
(10) Pub. No.: US 2025/0260046 A1
(43) Pub. Date: Aug. 14, 2025

(54) METHOD FOR MANUFACTURING CHALCOGENIDE-BASED SOLID ELECTROLYTE

(71) Applicant: Ampcera Inc., Milpitas, CA (US)

(72) Inventors: Hui Du, Tucson, AZ (US); James Emery Brown, Tucson, AZ (US)

(21) Appl. No.: 18/439,114

(22) Filed: Feb. 12, 2024

(51) Int. Cl. H01M 10/0562

(52) U.S. Cl. CPC H01M 10/0562; H01M 2300/008

(57) ABSTRACT

A method for manufacturing chalcogenide-based solid-state electrolytes, the method comprising generating a vapor of a first precursor material in a first effusion cell, generating a vapor of a second precursor material in a second effusion cell, generating a vapor of a third precursor material in a third effusion cell, bringing together the generated vapors of the first, second, and third precursor materials in a vacuum-compatible processing chamber, and initiating a reaction between the vapors of the first, second, and third precursor materials to produce the chalcogenide-based solid-state electrolyte, wherein the chemical formula of the chalcogenide-based solid-state electrolyte is governed by the flux ratio between the first, second, and third precursor vapors.

### FIELD

The present application relates to a method for manufacturing chalcogenide-based solid-state electrolyte materials.

### BACKGROUND

Solid-state electrolytes are the core material technology in next-generation solid-state batteries. They serve as the separating membrane between the cathode and anode, as well as the ionic conducting media in cathodes and anodes, referred to in the art as the catholyte and anolyte.

Among the many types of solid-state electrolytes, chalcogenide-based materials with an argyrodite crystal structure are advantageous owing to high ionic conductivity, high current density, low electronic conductivity, and excellent chemical stability. However, manufacturing chalcogenide-based solid-state electrolyte materials at scale remains a challenge.

### SUMMARY

An aspect of the present description pertains to a method for manufacturing chalcogenide-based solid-state electrolytes with the general formula A₁₂₋ₘ₋ₓM^{m}Y₍₆₋ₓ₎Xₓ, where A is lithium, sodium, potassium, cesium, or rubidium; M is boron (B³⁺), gallium (Ge³⁺), antimony (Sb³⁺), silicon (Si⁴⁺), germanium (Ga⁴⁺), tin (Sn⁴⁺), phosphorus (P⁵⁺), arsenic (As⁵⁺), or a combination thereof; Y is sulfur, selenium, tellurium, or a combination thereof, X is fluorine, chlorine, bromine, iodide, or a combination thereof, and x is in the range of 0≤x≤2. The method comprises: generating a vapor of a first precursor material in a first effusion cell; generating a vapor of a second precursor material in a second effusion cell; generating a vapor of a third precursor material in a third effusion cell; bringing together the generated vapors of the first, second, and third precursor materials in a vacuum-compatible processing chamber; and initiating a reaction between the vapors of the first, second, and third precursor materials to produce the chalcogenide-based solid-state electrolyte, wherein the chemical formula of the chalcogenide-based solid-state electrolyte is governed by the flux ratio between the first, second, and third precursor vapors.

In a further aspect, at least one of the three effusion cells is at a temperature in the range of 200≤T≤1500° C. and used to evaporate an alkali-metal sulfide with the general formula A₂Y where A is lithium, sodium, potassium, cesium, or rubidium, and Y is sulfur, selenium, or tellurium,

In a further aspect, at least one of the three effusion cells is at a temperature in the range of 100≤T≤2000° C. and is used to evaporate a compound with an empirical formula M_{y}^{m+}Yₘ^{y-} where M^{m+} is boron (B³⁺), gallium (Ga³⁺), antimony (Sb³⁺), silicon (Si⁴⁺), germanium (Ge⁴⁺), tin (Sn⁴⁺), phosphorus (P⁵⁺), or arsenic (As⁵⁺) and Y^{y-} is sulfur (S²⁻), selenium (Se²⁻), or tellurium (Te²⁻).

In a further aspect, at least one of the three effusion cells is at a temperature in the range of 500≤T≤2000° C. and is used to evaporate an alkali-metal halide salt with the general formula AX where A is lithium, sodium, potassium, cesium, or rubidium, and X is fluorine, chlorine, bromine, or iodine, and has a temperature in the range of 500≤T≤2000° C.

In a further aspect, the chemical formula of the chalcogenide-based solid-state electrolyte is governed by the flux ratio between the evaporated alkali-metal sulfide (A₂Y), the evaporated compound with an empirical formula M_{y}^{m+}Yₘ^{y-}, the evaporated alkali-metal halide salt (AX), and is derived from equation EQ1:

$$( 12 - m - 2 x ) {A}_{2} Y + ( \frac{2}{y} ) {M}_{y}^{m +} {Y}_{m}^{y -} + ( 2 x ) A X = 2 ( {A}_{( 12 - m - x )} {M}^{m +} {Y}_{( 6 - x )} {X}_{x} )$$

where A is lithium, sodium, potassium, cesium, or rubidium, M^{m+} is boron (B³⁺), gallium (Ge³⁺), antimony (Sb³⁺), silicon (Si⁴⁺), germanium (Ge⁴⁺), tin (Sn⁴⁺), phosphorus (P⁵⁺), or arsenic (As⁵⁺), Y is sulfur, selenium, or tellurium, X is fluorine, chlorine, bromine, iodide, and x is in the range of 0≤x≤2.

In a further aspect, the flux of the evaporated alkali-metal sulfide is derived from the equation 12−m−2x, where m is 3⁺, 4⁺, or 5⁺, and x is in the range of 0≤x≤2.

In a further aspect, the flux of the evaporated compound with an empirical formula M_{y}^{m+}Yₘ^{y-} is derived from the equation 2/y and can be kept at 1 as a constant.

In a further aspect, the flux of the evaporated alkali-metal halide salt (AX) is derived from equation 2x, where x is in the range of 0≤x≤2.

In a further aspect, the vacuum-compatible processing chamber further comprises a plasma generating system comprising a cathode, an anode, and an electric field therebetween, wherein the electric field generates a plasma plume that can activate the formation of chalcogenide-based solid-state electrolytes.

In another aspect, there is a method for manufacturing chalcogenide-based solid-state electrolytes with the general formula A₁₂₋ₘ₋ₓM^{m}Y₍₆₋ₓ₎Xₓ, where A is lithium, sodium, potassium, cesium, or rubidium; M is boron (B³⁺), gallium (Ge³⁺), antimony (Sb³⁺), silicon (Si⁴⁺), germanium (Ga⁴⁺), tin (Sn⁴⁺), phosphorus (P⁵⁺), arsenic (As⁵⁺), or a combination thereof; Y is sulfur, selenium, tellurium, or a combination thereof, X is fluorine, chlorine, bromine, iodide, or a combination thereof, and x is in the range of 00≤x≤2. The method comprises: generating a vapor of a first precursor material in a first effusion cell; generating a vapor of a second precursor material in a second effusion cell; generating a vapor of a third precursor material in a third effusion cell; providing a halogen gas acting as a fourth precursor material; bringing together the generated vapors of the first, second, third, and fourth precursor materials in a vacuum and halogen gas compatible processing chamber; and initiating a reaction between the vapors of the first, second, third and fourth precursor materials to produce the chalcogenide-based solid-state electrolyte, wherein the chemical formula of the chalcogenide-based solid-state electrolyte is governed by the flux ratio between the first, second, third, and fourth precursor vapors.

In a further aspect, at least one of the three effusion cells has a temperature in the range of 200≤T≤1500° C. and used to evaporate an alkali-metal (A) such as lithium, sodium, potassium, cesium, or rubidium.

In a further aspect, at least one of the three effusion cells is at a temperature in the range of 100≤T≤900° C. and used to evaporate elemental chalcogenide material (Y) such as sulfur, selenium, or tellurium.

In a further aspect, at least one of the three effusion cells is at a temperature in the range of 100≤T≤2000° C. and is used to evaporate a compound with an empirical formula M_{y}^{m+}Yₘ^{y-} where M^{m+} is boron (B³⁺), gallium (Ga³⁺), antimony (Sb³⁺), silicon (Si⁴⁺), germanium (Ge⁴⁺), tin (Sn⁴⁺), phosphorus (P⁵⁺), or arsenic (As⁵⁺) and Y^{y-} is sulfur (S²⁻), selenium (Se²⁻), or tellurium (Te²⁻).

In a further aspect, the halogen gas (X₂) includes fluorine gas, chlorine gas, bromine gas, iodine gas, or a combination thereof.

In a further aspect, the chemical formula of the chalcogenide-based solid-state electrolyte is governed by the flux ratio between the evaporated alkali-metal (A), the evaporated elemental chalcogenide material (Y), the evaporated compound with an empirical formula M_{y}^{m+}Yₘ^{y-}, and the halogen gas (X₂), and is derived from equation EQ2:

$$( 24 - 2 m - 2 x ) A + ( 12 - m - 2 x ) Y + ( \frac{2}{y} ) {M}_{y}^{m +} {Y}_{m}^{y -} + ( x ) {X}_{2} = 2 ( {A}_{( 12 - m - x )} {M}^{m} {Y}_{( 6 - x )} {X}_{x} )$$

where A is lithium, sodium, potassium, cesium, or rubidium, M^{m+} is boron (B³⁺), gallium (Ge³⁺), antimony (Sb³⁺), silicon (Si⁴⁺), germanium (Ge⁴⁺), tin (Sn⁴⁺), phosphorus (P⁵⁺), or arsenic (As⁵⁺), Y is sulfur, selenium, or tellurium, X is fluorine, chlorine, bromine, iodide, and x is in the range of 0≤x≤2.

In a further aspect, the flux of the evaporated alkali-metal is derived from the equation 24−2m−2x, where m is 3⁺, 4⁺, or 5⁺, and x is in the range of 0<x<2.

In a further aspect, the flux of the evaporated elemental chalcogenide material is derived from the equation 12−m−2x, where m is 3⁺, 4⁺, or 5⁺, and x is in the range of 0<x<2.

In a further aspect, the flux of the evaporated compound with an empirical formula M_{y}^{m+}Yₘ^{y-} is derived from the equation 2/y and can be kept at 1 as a constant.

In a further aspect, the flux of the halogen gas (X₂) is derived from x(X₂), where x is in the range of 0<x<2.

In a further aspect, the vacuum and halogen gas compatible processing chamber further comprises a plasma generating system comprising a cathode, an anode, and an electric field therebetween, wherein the electric field generates a plasma plume that can activate the formation of chalcogenide-based solid-state electrolytes.

Other embodiments of the disclosed system will become apparent from the following detailed description, the accompanying drawings, and the appended claims.

### BRIEF DESCRIPTION OF THE DRAWINGS

FIG. 1A: A schematic illustration of a heat-assisted vacuum processing approach for the manufacturing of chalcogenide-based solid-state electrolytes.

FIG. 1B: A schematic illustration of a heat-assisted vacuum processing approach for the manufacturing of chalcogenide-based solid-state electrolytes.

FIG. 1C: A schematic illustration of a heat-assisted vacuum processing approach for the manufacturing of chalcogenide-based solid-state electrolytes.

FIG. 1D: A schematic illustration of a heat-assisted vacuum processing approach for the manufacturing of chalcogenide-based solid-state electrolytes.

FIG. 1E: A flowchart of the heat-assisted vacuum processing approach for the manufacturing of chalcogenide-based solid-state electrolytes.

FIG. 2A: A schematic illustration of a heat-assisted halogen gas processing approach for the manufacturing of chalcogenide-based solid-state electrolytes.

FIG. 2B: A schematic illustration of a heat-assisted halogen gas processing approach for the manufacturing of chalcogenide-based solid-state electrolytes.

FIG. 2C: A schematic illustration of a heat-assisted halogen gas processing approach for the manufacturing of chalcogenide-based solid-state electrolytes.

FIG. 2D: A schematic illustration of a heat-assisted halogen gas processing approach for the manufacturing of chalcogenide-based solid-state electrolytes.

FIG. 2E: A flowchart of the heat-assisted halogen gas processing approach for the manufacturing of chalcogenide-based solid-state electrolytes.

FIG. 3A: A schematic illustration of a plasma-assisted vacuum processing approach for the manufacturing of chalcogenide-based solid-state electrolytes.

FIG. 3B: A schematic illustration of a plasma-assisted vacuum processing approach for the manufacturing of chalcogenide-based solid-state electrolytes.

FIG. 3C: A schematic illustration of a plasma-assisted vacuum processing approach for the manufacturing of chalcogenide-based solid-state electrolytes.

FIG. 3D: A schematic illustration of a plasma-assisted vacuum processing approach for the manufacturing of chalcogenide-based solid-state electrolytes.

FIG. 3E: A flowchart of the plasma-assisted processing vacuum approach for the manufacturing of chalcogenide-based solid-state electrolytes.

FIG. 4A: A schematic illustration of a plasma-assisted halogen gas processing approach for the manufacturing of chalcogenide-based solid-state electrolytes.

FIG. 4B: A schematic illustration of a plasma-assisted halogen gas processing approach for the manufacturing of chalcogenide-based solid-state electrolytes.

FIG. 4C: A schematic illustration of a plasma-assisted halogen gas processing approach for the manufacturing of chalcogenide-based solid-state electrolytes.

FIG. 4D: A schematic illustration of a plasma-assisted halogen gas processing approach for the manufacturing of chalcogenide-based solid-state electrolytes.

FIG. 4E: A flowchart of the plasma-assisted halogen gas processing approach for the manufacturing of chalcogenide-based solid-state electrolytes.

FIG. 5A: A schematic illustration of an effusion cell used in the manufacturing of chalcogenide-based solid-state electrolytes.

FIG. 5B: A digital image of an effusion cell used in the manufacturing of chalcogenide-based solid-state electrolytes.

FIG. 6A: A schematic illustration of a thermal cracker effusion cell used in the manufacturing of chalcogenide-based solid-state electrolytes.

FIG. 6B: A digital image of a thermal cracker effusion cell used in the manufacturing of chalcogenide-based solid-state electrolytes.

FIG. 7A: A schematic illustration of a rotating conveyor belt system used in the manufacturing of chalcogenide-based solid-state electrolytes.

FIG. 7B: A schematic illustration of a rotating conveyor belt system used in the manufacturing of chalcogenide-based solid-state electrolytes.

FIG. 8A: A representative X-ray diffraction pattern and Nyquist plot of a chalcogenide-based solid-state electrolyte.

FIG. 8B: A representative X-ray diffraction pattern and Nyquist plot of a chalcogenide-based solid-state electrolyte.

FIG. 8C: A representative X-ray diffraction pattern and Nyquist plot of a chalcogenide-based solid-state electrolyte.

FIG. 8D: A representative X-ray diffraction pattern and Nyquist plot of a chalcogenide-based solid-state electrolyte.

FIG. 9A: Representative scanning electron microscopy images of a chalcogenide-based solid-state electrolyte manufactured using a heat-assisted processing approach.

FIG. 9B: A representative particle size distribution of a chalcogenide-based solid-state electrolyte manufactured using a heat-assisted processing approach.

FIG. 10A: Representative scanning electron microscopy images of a chalcogenide-based solid-state electrolyte manufactured using a plasma-assisted processing approach.

FIG. 10B: A representative particle size distribution of a chalcogenide-based solid-state electrolyte manufactured using a plasma-assisted processing approach.

FIG. 11A: A schematic representation of a solid-state battery comprising a chalcogenide-based solid-state electrolyte.

FIG. 11B: A schematic representation of a solid-state battery comprising a chalcogenide-based solid-state electrolyte.

FIG. 11C: A schematic representation of a solid-state battery comprising a chalcogenide-based solid-state electrolyte.

### DETAILED DESCRIPTION

The present description relates to a method for manufacturing chalcogenide-based solid-state electrolytes with the general formula A₁₂₋ₘ₋ₓM^{m}Y₍₆₋ₓ₎Xₓ, where A is lithium, sodium, potassium, cesium, or rubidium; M is boron (B³⁺), gallium (Ge³⁺), antimony (Sb³⁺), silicon (Si⁴⁺), germanium (Ga⁴⁺), tin (Sn⁴⁺), phosphorus (P⁵⁺), arsenic (As⁵⁺), or a combination thereof; Y is sulfur, selenium, tellurium, or a combination thereof, X is fluorine, chlorine, bromine, iodide, or a combination thereof, and x is in the range of 0≤x≤2. The method comprises: generating a vapor of a first precursor material in a first effusion cell; generating a vapor of a second precursor material in a second effusion cell; generating a vapor of a third precursor material in a third effusion cell; bringing together the generated vapors of the first, second, and third precursor materials in a vacuum-compatible processing chamber; and initiating a reaction between the vapors of the first, second, and third precursor materials to produce the chalcogenide-based solid-state electrolyte, wherein the chemical formula of the chalcogenide-based solid-state electrolyte is governed by the flux ratio between the first, second, and third precursor vapors.

The present description also relates to a method for manufacturing chalcogenide-based solid-state electrolytes with the general formula A₁₂₋ₘ₋ₓM^{m}Y₍₆₋ₓ₎Xₓ, where A is lithium, sodium, potassium, cesium, or rubidium; M is boron (B³⁺), gallium (Ge³⁺), antimony (Sb³⁺), silicon (Si⁴⁺), germanium (Ga⁴⁺), tin (Sn⁴⁺), phosphorus (P⁵⁺), arsenic (As⁵⁺), or a combination thereof; Y is sulfur, selenium, tellurium, or a combination thereof, X is fluorine, chlorine, bromine, iodide, or a combination thereof, and x is in the range of 00≤x≤2. The method comprises: generating a vapor of a first precursor material in a first effusion cell; generating a vapor of a second precursor material in a second effusion cell; generating a vapor of a third precursor material in a third effusion cell; providing a halogen gas acting as a fourth precursor material; bringing together the generated vapors of the first, second, third, and fourth precursor materials in a vacuum and halogen gas compatible processing chamber; and initiating a reaction between the vapors of the first, second, third and fourth precursor materials to produce the chalcogenide-based solid-state electrolyte, wherein the chemical formula of the chalcogenide-based solid-state electrolyte is governed by the flux ratio between the first, second, third, and fourth precursor vapors.

Generation of Precursor Vapors: The method involves generating a vapor of at least one precursor material. This can be achieved through several techniques. One method is using an effusion cell where a precursor material is vaporized through heating, which could include evaporation or sublimation. The following detailed description focuses primarily on the generation of precursor vapor using the effusion cell, but the present description is not limited by this technique. Alternative methods may include thermal decomposition of precursor compounds, which can release precursor vapors without the need for a physical effusion cell. Electron beam evaporation is another technique, where an electron beam may be used to vaporize the precursor material. Additionally, sputtering can eject precursor vapors from a target material using high-energy ions. Laser ablation utilizes focused laser pulses to vaporize precursor material from a solid target. Gas-phase reactions may also generate precursor material in vapor form, potentially bypassing the need for direct physical evaporation. Furthermore, electrical methods can release precursor vapors through electrical heating.

Reaction to Produce Chalcogenide-Based Solid-State Electrolyte: The synthesis of the chalcogenide-based solid-state electrolyte is centered around the step of initiating a reaction between the precursor vapors. The reaction can be facilitated through heat-assisted techniques and through plasma-assisted techniques. The following detailed description focuses primarily on the initiation of the reaction using heat or plasma. However, the present description is not limited by this technique. Alternatively, electromagnetic fields, including those generated by microwaves or radio frequencies, can stimulate the reaction. Additionally, innovative methods such as photochemical reactions using light, ultrasonic techniques employing sound waves, or the introduction of reactive gases or chemicals may also be possible viable pathways for initiating chalcogenide-based solid-state electrolyte formation.

Herein, an exemplary method for manufacturing chalcogenide-based solid-state electrolytes with an argyrodite crystal structure at scale is presented. The method includes a processing chamber further comprising at least three effusion cells, a rotating conveyor belt system, and a rotating collection crucible. The at least three effusion cells may be used to evaporate precursor materials. The formulation of the chalcogenide-based solid-state electrolyte may be controlled by controlling the flux ratio of gaseous precursor materials.

The method for manufacturing chalcogenide-based solid-state electrolytes further comprises a rotating conveyor belt system that may be used to collect gaseous precursor materials and activate the formation of chalcogenide-base solid-state electrolytes through thermal treatment. A rotating collection crucible at the bottom of the processing chamber collects the chalcogenide-based solid-state electrolyte materials.

The method for manufacturing chalcogenide-based solid-state electrolytes may further comprise a plasma-generating system comprising a cathode, an anode, and an electric field therebetween, wherein the electric field generates a plasma plume that actives the formation of chalcogenide-based solid-state electrolytes. In such an instance, the rotating conveyor belt system may be used to quench the chalcogenide-based solid-state electrolytes to further reduce particle size.

In an embodiment, a method for manufacturing a chalcogenide-based solid-state electrolyte may comprise a processing chamber comprising at least three effusion cells and a means to collect the solid-state electrolyte. In an aspect of the embodiment, the chalcogenide-based solid-state electrolyte may have an argyrodite crystal structure with the general formula: A₁₂₋ₘ₋ₓM^{m}Y₍₆₋ₓ₎Xₓ, where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 0≤x≤2, with a preferred range of 1.0≤x≤2.0.

In another embodiment, a method for manufacturing a chalcogenide-based solid-state electrolyte with an argyrodite crystal structure may comprise a processing chamber further comprising at least three effusion cells and a vacuum environment, wherein the processing chamber and method thereof satisfies the following chemical equation (EQ1):

$$( 12 - m - 2 x ) {A}_{2} Y + ( \frac{2}{y} ) {M}_{y}^{m +} {Y}_{m}^{y -} + ( 2 x ) A X = 2 ( {A}_{( 12 - m - x )} {M}^{m +} {Y}_{( 6 - x )} {X}_{x} )$$

where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ge⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 0≤x≤2, with a preferred range of 1.0≤x≤2.0. In an aspect of the embodiment, one of the at least three effusion cells, designated as EC-1V, may be used to evaporate A₂Y, where A=Lithium (Li), Sodium (Na), Potassium (K), Cesium (Cs), Rubidium (Rb), or Francium (Fr), and Y=Sulfur (S), Selenium (Se), or Tellurium (Te). Preferably, A₂Y is lithium sulfide (Li₂S) or sodium sulfide (Na₂S. In another aspect of the embodiment, one of the at least three effusion cells, designated as EC-2V, may be used to evaporate M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-} =Sulfur (S²⁻), Selenium (Se²⁻), or Tellurium (Te²⁻), and M_{y}^{m+}Yₘ^{y-} is in empirical form. Preferably, M_{y}^{m+}Yₘ^{y-} is phosphorus pentasulfide (P₂S₅). In yet another aspect of the embodiment, one of the at least three effusion cells, designated as EC-3V, may be used to evaporate AX, where A=Lithium (Li), Sodium (Na), Potassium (K), Cesium (Cs), Rubidium (Rb), or Francium (Fr), X=Fluorine (F), Chlorine (Cl), Bromine (Br), or Iodide (I). Preferably, AX is lithium fluoride (LiF), lithium chloride (LiCl), lithium bromide (LiBr), sodium fluoride (NaF), sodium chloride (NaCl), or sodium bromide (NaBr). In yet another aspect of the embodiment, additional effusion cells, designated as EC-XV, with X designated as a number of four or higher, may be used to evaporate additional A₂Y, M_{y}^{m+}Yₘ^{y-}, or AX materials.

In yet another embodiment, a method for manufacturing a chalcogenide-based solid-state electrolyte with an argyrodite crystal structure may comprise a processing chamber further comprising at least three effusion cells and a halogen gas environment, wherein the processing chamber and method thereof satisfies the following chemical equation (EQ2):

$$( 24 - 2 m - 2 x ) A + ( 12 - m - 2 x ) Y + ( \frac{2}{y} ) {M}_{y}^{m +} {Y}_{m}^{y -} + ( x ) {X}_{2} = 2 ( {A}_{( 12 - m - x )} {M}^{m} {Y}_{( 6 - x )} {X}_{x} )$$

where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ge⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 0≤x≤2, with a preferred range of 1.0≤x≤2.0. In an aspect of the embodiment, one of the at least three effusion cells, designated as EC-1G, may be used to evaporate A, where A=Lithium (Li), Sodium (Na), Potassium (K), Cesium (Cs), Rubidium (Rb), or Francium (Fr). Preferably, A is Lithium (Li) or Sodium (Na). In another aspect of the embodiment, one of the at least three effusion cells, designated as EC-2G, may be used to evaporate Y, where Y=Sulfur (S), Selenium (Se), or Tellurium (Te). Preferably, Y is Sulfur (S) and EC-2B is a thermal cracker effusion cell. In yet another aspect of the embodiment, one of the at least three effusion cells, designated as EC-3G, may be used to evaporate M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-} =Sulfur (S²⁻), Selenium (Se²⁻), or Tellurium (Te²⁻), and M_{y}^{m+}Yₘ^{y-} is in empirical form. Preferably, M_{y}^{m+}Yₘ^{y-} is phosphorus pentasulfide (P₂S₅). In yet another aspect of the embodiment, additional effusion cells, designated as EC-XG, with X designated as a number of four or higher, may be used to evaporate additional A, Y, or M_{y}^{m+}Yₘ^{y-} materials. In yet another aspect of the embodiment, X₂ may be a halogen gas such as, for example, fluorine gas (F₂), chlorine gas (Cl₂), bromine gas (Br₂), iodide gas (I₂), or a combination thereof. The processing chamber may comprise one gas inlet, for a single halogen mixture, or more than one gas inlet, for a halogen gas mixture, to form a chalcogenide-based solid-state electrolyte with more than one halogen element.

In yet another embodiment, a method for manufacturing a chalcogenide-based solid-state electrolyte with the general formula: A₁₂₋ₘ₋ₓM^{m}Y₍₆₋ₓ₎Xₓ, where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 00≤x≤2, with a preferred range of 1.0≤x≤2.0, may comprise a heat-assisted approach. In an aspect of the embodiment, a processing chamber for a heat-assisted approach may comprise a rotating conveyor belt, wherein the materials evaporated from effusion cells EC-1V, EC-2V, and EC-3V (satisfying EQ1), or effusion cells EC-1G, EC-2G, EC-3G, and the halogen gas (satisfying EQ2), may condense on the surface of the conveyor belt. In another aspect of the embodiment, a processing chamber for a heat-assisted approach may comprise at least one temperature-controlled block between the rotating conveyor belt, wherein the temperature-controlled block is a heat block used to activate and drive the formation of the chalcogenide-based solid-state electrolyte.

In yet another embodiment, a method for manufacturing a chalcogenide-based solid-state electrolyte with the general formula: A₁₂₋ₘ₋ₓM^{m}Y₍₆₋ₓ₎Xₓ, where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 00≤x≤2, with a preferred range of 1.0≤x≤2.0, may comprise a plasma-assisted approach. In an aspect of the embodiment, a processing chamber for a plasma-assisted approach may comprise a plasma-generating system, comprising at least one cathode, at least one anode, and at least one power source external to the processing chamber, wherein the materials evaporated from effusion cells EC-1V, EC-2V, and EC-3V (satisfying EQ1), or effusion cells EC-1G, EC-2G, EC-3G, and the halogen gas (satisfying EQ2), react in the presence of an applied electric field between the at least one cathode and one anode forming a plasma plume, activating the formation of chalcogenide-based solid-state electrolyte. In another aspect of the embodiment, a processing chamber for a plasma-assisted approach may comprise a rotating conveyor belt to collect the formed chalcogenide-based solid-state electrolyte. In yet another aspect of the embodiment, a processing chamber for a plasma-assisted approach may comprise at least one temperature-controlled block between the rotating conveyor belt, wherein the temperature-controlled block is a heat block used to further activate and drive the formation of the chalcogenide-based solid-state electrolyte from any residual materials evaporated from effusion cells EC-1V, EC-2V, and EC-3V, or effusion cells EC-1G, EC-2G, EC-3G, and the halogen gas. In yet another aspect of the embodiment, and as an alternative, a temperature-controlled block is a cold block used to quench the chalcogen-based solid-state electrolyte materials to further reduce the particle size.

Other embodiments of the disclosed method will become apparent from the following detailed description, the accompanying drawings, and the appended claims.

This invention relates to a method for manufacturing a chalcogenide-based solid-state electrolyte material with an argyrodite crystal structure that may have the general formula A₁₂₋ₘ₋ₓM^{m}Y₍₆₋ₓ₎Xₓ, where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 0≤x≤2, with a preferred range of 1.0≤x≤2.0

This invention further relates to a method for manufacturing a sulfide-based solid-state electrolyte material with an argyrodite crystal structure and may have the general formula A₁₂₋ₘ₋ₓM^{m}S₍₆₋ₓ₎Xₓ, where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, X=Fluorine (F), Chlorine (Cl), Bromine (Br), Iodide (I), or a combination thereof, and x is in the range of 0≤x≤2, with a preferred range of 1.0≤x≤2.0

This invention further relates to a method for manufacturing a sulfide-based solid-state electrolyte material for lithium solid-state batteries with the general formula Li₁₂₋ₘ₋ₓM^{m}S₍₆₋ₓ₎Xₓ, where M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, X=Fluorine (F), Chlorine (Cl), Bromine (Br), Iodide (I), or a combination thereof, and x is in the range of 0≤x≤2, with a preferred range of 1.0≤x≤2.0.

This invention further relates to a method for manufacturing a sulfide-based solid-state electrolyte material for lithium solid-state batteries with the general formula Li₇₋ₓPS₍₆₋ₓ₎Xₓ, where X=Fluorine (F), Chlorine (Cl), Bromine (Br), Iodide (I), or a combination thereof, and x is in the range of 0≤x≤2, with a preferred range of 1.0≤x≤2.0.

This invention further relates to a method for manufacturing a sulfide-based solid-state electrolyte material for sodium solid-state batteries with the general formula Na₁₂₋ₘ₋ₓM^{m}S₍₆₋ₓ₎Xₓ, where M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, X=Fluorine (F), Chlorine (Cl), Bromine (Br), Iodide (I), or a combination thereof, and x is in the range of 0≤x≤2, with a preferred range of 1.0≤x≤2.0.

This invention further relates to a method for manufacturing a sulfide-based solid-state electrolyte material for sodium solid-state batteries with the general formula Na₇₋ₓPS₍₆₋ₓ₎Xₓ, where X=Fluorine (F), Chlorine (Cl), Bromine (Br), Iodide (I), or a combination thereof, and x is in the range of 0≤x≤2, with a preferred range of 1.0≤x≤2.0.

This invention further relates to a method for manufacturing a sulfide-based solid-state electrolyte material for potassium solid-state batteries with the general formula K₁₂₋ₘ₋ₓM^{m}S₍₆₋ₓ₎Xₓ, where M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵), or a combination thereof, X=Fluorine (F), Chlorine (Cl), Bromine (Br), Iodide (I), or a combination thereof, and x is in the range of 0≤x≤2, with a preferred range of 1.0≤x≤2.0.

This invention further relates to a method for manufacturing a sulfide-based solid-state electrolyte material for potassium solid-state batteries with the general formula K₇₋ₓPS₍₆₋ₓ₎Xₓ, where X=Fluorine (F), Chlorine (Cl), Bromine (Br), Iodide (I), or a combination thereof, and x is in the range of 0≤x≤2, with a preferred range of 1.0≤x≤2.0.

In the first embodiment of the disclosure, a chalcogenide-based solid-state electrolyte may be manufactured using a heat-assisted vacuum processing approach.

In an aspect of the first embodiment, a heat-assisted vacuum processing approach may comprise a vacuum-compatible processing chamber further comprising at least three effusion cells (EC-1V, EC-2V, and EC-3V) and a rotating conveyor belt system, wherein the processing chamber and method thereof satisfies the following chemical equation (EQ1):

$$( 12 - m - 2 x ) {A}_{2} Y + ( \frac{2}{y} ) {M}_{y}^{m +} {Y}_{m}^{y -} + ( 2 x ) A X = 2 ( {A}_{( 12 - m - x )} {M}^{m +} {Y}_{( 6 - x )} {X}_{x} )$$

where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ge⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 0≤x≤2, with a preferred range of 1.0≤x≤2.0.

In another aspect of the first embodiment, effusion cell EC-1V may be used to evaporate A₂Y, where A=Lithium (Li), Sodium (Na), Potassium (K), Cesium (Cs), Rubidium (Rb), or Francium (Fr), and Y=Sulfur (S), Selenium (Se), or Tellurium (Te). Preferably, A₂Y is lithium sulfide (Li₂S), sodium sulfide (Na₂S), or potassium sulfide (K₂S).

In another aspect of the first embodiment, effusion cell EC-2V may be used to evaporate M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-}=Sulfur (S²⁻), Selenium (Se²⁻), or Tellurium (Te²⁻), and M_{y}^{m+}Yₘ^{y-} is in empirical form. Preferably, M_{y}^{m+}Yₘ^{y-} is phosphorus pentasulfide (P₂S₅).

In yet another aspect of the first embodiment, effusion cell EC-3V may be used to evaporate AX, where A=Lithium (Li), Sodium (Na), Potassium (K), Cesium (Cs), Rubidium (Rb), or Francium (Fr), X=Fluorine (F), Chlorine (Cl), Bromine (Br), or Iodide (I). Preferably, AX is lithium fluoride (LiF), lithium chloride (LiCl), lithium bromide (LiBr), sodium fluoride (NaF), sodium chloride (NaCl), or sodium bromide (NaBr).

In yet another aspect of the first embodiment, additional effusion cells, designated as EC-XV, with X designated as a number of four or higher, may be used to evaporate additional A₂Y, M_{y}^{m+}Yₘ^{y-}, or AX materials.

In yet another aspect of the first embodiment, the materials evaporated from effusion cells EC-1V, EC-2V, and EC-3V may condense on the surface of a single rotating conveyor belt comprised within a rotating conveyor belt system.

In yet another aspect of the first embodiment, a rotating conveyor-belt system may further comprise at least one temperature-controlled block between the rotating conveyor belt, wherein the temperature-controlled block is a heat block used to activate and drive the formation of the chalcogenide-based solid-state electrolyte.

In yet another aspect of the first embodiment, a rotating conveyor-belt system may further comprise a knife or blade used to remove the chalcogenide-based solid-state electrolyte from said single rotating conveyor-belt, wherein the chalcogenide-based solid-state electrolyte is collected in a rotating collection crucible at the bottom of the processing chamber.

In the second embodiment of the disclosure, a chalcogenide-based solid-state electrolyte may be manufactured using a heat-assisted halogen gas processing approach.

In an aspect of the second embodiment, a heat-assisted vacuum processing approach may comprise a vacuum and halogen gas compatible processing chamber further comprising at least three effusion cells (EC-1G, EC-2G, and EC-3G) and a rotating conveyor belt system, wherein the processing chamber and method thereof satisfies the following chemical equation (EQ2):

$$( 24 - 2 m - 2 x ) A + ( 12 - m - 2 x ) Y + ( \frac{2}{y} ) {M}_{y}^{m +} {Y}_{m}^{y -} + ( x ) {X}_{2} = 2 ( {A}_{( 12 - m - x )} {M}^{m} {Y}_{( 6 - x )} {X}_{x} )$$

where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ge⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 0≤x≤2, with a preferred range of 1.0≤x≤2.0.

In another aspect of the second embodiment, effusion cell EC-1G may be used to evaporate A, where A=Lithium (Li), Sodium (Na), Potassium (K), Cesium (Cs), Rubidium (Rb), or Francium (Fr). Preferably, A is Lithium (Li), Sodium (Na), or Potassium (K).

In another aspect of the second embodiment, effusion cell EC-2G may be used to evaporate Y, where Y=Sulfur (S), Selenium (Se), or Tellurium (Te). Preferably, Y is Sulfur (S) and EC-2B is a thermal cracker effusion cell.

In yet another aspect of the second embodiment, effusion cell EC-3G may be used to evaporate M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-}=Sulfur (S²⁻), Selenium (Se²⁻), or Tellurium (Te²⁻), and M_{y}^{m+}Yₘ^{y-} is in empirical form. Preferably, M_{y}^{m+}Yₘ^{y-} is phosphorus pentasulfide (P₂S₅).

In yet another aspect of the second embodiment, additional effusion cells, designated as EC-XG, with X designated as a number of four or higher, may be used to evaporate additional A, Y, or M_{y}^{m+}Yₘ^{y-} materials.

In yet another aspect of the second embodiment, X₂ may be a halogen gas such as, for example, fluorine gas (F₂), chlorine gas (Cl₂), bromine gas (Br₂), iodide gas (I₂), or a combination thereof. The processing chamber may comprise one gas inlet, for a single halogen gas, or more than one gas inlet, for a halogen gas mixture, to form a chalcogenide-based solid-state electrolyte with more than one halogen element.

In yet another aspect of the second embodiment, the materials evaporated from effusion cells EC-1G, EC-2G, and EC-3G, as well as the halogen gas may deposit on the surface of a single rotating conveyor belt comprised within a rotating conveyor belt system.

In yet another aspect of the second embodiment, a rotating conveyor-belt system may further comprise at least one temperature-controlled block between the rotating conveyor belt, wherein the temperature-controlled block is a heat block used to activate and drive the formation of the chalcogenide-based solid-state electrolyte.

In yet another aspect of the second embodiment, a rotating conveyor-belt system may further comprise a knife or blade used to remove the chalcogenide-based solid-state electrolyte from said single rotating conveyor-belt, wherein the chalcogenide-based solid-state electrolyte is collected in a rotating collection crucible at the bottom of the processing chamber.

In the third embodiment of the disclosure, a chalcogenide-based solid-state electrolyte may be manufactured using a plasma-assisted vacuum processing approach.

In an aspect of the third embodiment, a plasma-assisted vacuum processing approach may comprise a vacuum-compatible processing chamber further comprising at least three effusion cells (EC-1V, EC-2V, and EC-3V), a plasma generating system, and a rotating conveyor belt system, wherein the processing chamber and method thereof satisfies the following chemical equation (EQ1):

$$( 12 - m - 2 x ) {A}_{2} Y + ( \frac{2}{y} ) {M}_{y}^{m +} {Y}_{m}^{y -} + ( 2 x ) A X = 2 ( {A}_{( 12 - m - x )} {M}^{m +} {Y}_{( 6 - x )} {X}_{x} )$$

where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ge⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 0≤x≤2, with a preferred range of 1.0≤x≤2.0.

In another aspect of the third embodiment, effusion cell EC-1V may be used to evaporate A₂Y, where A=Lithium (Li), Sodium (Na), Potassium (K), Cesium (Cs), Rubidium (Rb), or Francium (Fr), and Y=Sulfur (S), Selenium (Se), or Tellurium (Te). Preferably, A₂Y is lithium sulfide (Li₂S), sodium sulfide (Na₂S), or potassium sulfide (K₂S).

In another aspect of the third embodiment, effusion cell EC-2V may be used to evaporate M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-}=Sulfur (S²⁻), Selenium (Se²⁻), or Tellurium (Te²⁻), and M_{y}^{m+}Yₘ^{y-} is empirical form. Preferably, M_{y}^{m+}Yₘ^{y-} is phosphorus pentasulfide (P₂S₅).

In yet another aspect of the third embodiment, effusion cell EC-3V may be used to evaporate AX, where A=Lithium (Li), Sodium (Na), Potassium (K), Cesium (Cs), Rubidium (Rb), or Francium (Fr), X=Fluorine (F), Chlorine (Cl), Bromine (Br), or Iodide (I). Preferably, AX is lithium fluoride (LiF), lithium chloride (LiCl), lithium bromide (LiBr), sodium fluoride (NaF), sodium chloride (NaCl), or sodium bromide (NaBr).

In yet another aspect of the third embodiment, additional effusion cells, designated as EC-XV, with X designated as a number of four or higher, may be used to evaporate additional A₂Y, M_{y}^{m+}Yₘ^{y-}, or AX materials.

In yet another aspect of the third embodiment, a plasma-generating system may comprise at least one cathode, at least one anode, and at least one power source external to the processing chamber used to generate an electric field between the at least one cathode and the at least one anode.

In yet another aspect of the third embodiment, the materials evaporated from effusion cells EC-1V, EC-2V, and EC-3V may ionize and react in the presence of the generated electric field forming a plasma plume activating the formation of a chalcogenide-based solid-state electrolyte.

In yet another aspect of the third embodiment, the chalcogenide-based solid-state electrolyte formed in the plasma plume of the plasma generating system may be deposited on the surface of a single rotating conveyor belt comprised within a rotating conveyor belt system.

In yet another aspect of the third embodiment, a rotating conveyor-belt system may further comprise at least one temperature-controlled block between the single rotating conveyor belt, wherein the temperature-controlled block is a heat block used to further activate and drive the formation of the chalcogenide-based solid-state electrolyte.

In yet another aspect of the third embodiment, and as an alternative, the at least one temperature-controlled block may be a cold block used to quench the chalcogenide-based solid-state electrolyte to further reduce the particle size.

In yet another aspect of the third embodiment, a rotating conveyor-belt system may further comprise a knife or blade used to remove the chalcogenide-based solid-state electrolyte from said single rotating conveyor-belt, wherein the chalcogenide-based solid-state electrolyte is collected in a rotating collection crucible at the bottom of the processing chamber.

In the fourth embodiment of the disclosure, a chalcogenide-based solid-state electrolyte may be manufactured using a plasma-assisted halogen gas processing approach.

In an aspect of the fourth embodiment, a plasma-assisted halogen gas processing approach may comprise a vacuum and halogen gas compatible processing chamber further comprising at least three effusion cells (EC-1G, EC-2G, and EC-3G), a plasma generating system, and a rotating conveyor belt system, wherein the processing chamber and method thereof satisfies the following chemical equation (EQ2):

$$( 24 - 2 m - 2 x ) A + ( 12 - m - 2 x ) Y + ( \frac{2}{y} ) {M}_{y}^{m +} {Y}_{m}^{y -} + ( x ) {X}_{2} = 2 ( {A}_{( 12 - m - x )} {M}^{m} {Y}_{( 6 - x )} {X}_{x} )$$

where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ge⁴⁺), Tin (Sn⁴⁺), Phosphorus (P⁵⁺), Arsenic (As⁵⁺), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 0≤x≤2, with a preferred range of 1.0≤x≤2.0.

In another aspect of the fourth embodiment, effusion cell EC-1G may be used to evaporate A, where A=Lithium (Li), Sodium (Na), Potassium (K), Cesium (Cs), Rubidium (Rb), or Francium (Fr). Preferably, A is Lithium (Li), Sodium (Na), or Potassium (K).

In another aspect of the fourth embodiment, effusion cell EC-2G may be used to evaporate Y, where Y=Sulfur (S), Selenium (Se), or Tellurium (Te). Preferably, Y is Sulfur (S) and EC-2G is a thermal cracker effusion cell.

In yet another aspect of the fourth embodiment, effusion cell EC-3G may be used to evaporate M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-}=Sulfur (S²⁻), Selenium (Se²⁻), or Tellurium (Te²⁻), and M_{y}^{m+}Yₘ^{y-} is empirical form. Preferably, M_{y}^{m+}Yₘ^{y-} is phosphorus pentasulfide (P₂S₅).

In yet another aspect of the fourth embodiment, additional effusion cells, designated as EC-XG, with X designated as a number of four or higher, may be used to evaporate additional A, Y, or M_{y}^{m+}Yₘ^{y-} materials.

In yet another aspect of the fourth embodiment, X₂ may be a halogen gas such as, for example, fluorine gas (F₂), chlorine gas (Cl₂), bromine gas (Br₂), or iodide gas (I₂). The processing chamber may comprise one halogen gas inlet, for a single halogen gas, or more than one halogen gas inlet, for a halogen gas mixture, to form a chalcogenide-based solid-state electrolyte with more than one halogen element.

In yet another aspect of the fourth embodiment, a plasma-generating system may comprise at least one cathode, at least one anode, and at least one power source external to the processing chamber used to generate an electric field between the at least one cathode and the at least one anode.

In yet another aspect of the fourth embodiment, the materials evaporated from effusion cells EC-1G, EC-2G, and EC-3G, as well as the halogen gas may ionize and react in the presence of the generated electric field forming a plasma plume activating the formation of a chalcogenide-based solid-state electrolyte.

In yet another aspect of the fourth embodiment, the chalcogenide-based solid-state electrolyte formed in the plasma plume of the plasma generating system may be deposited on the surface of a single rotating conveyor belt comprised within a rotating conveyor belt system.

In yet another aspect of the fourth embodiment, a rotating conveyor-belt system may further comprise at least one temperature-controlled block between the single rotating conveyor belt, wherein the temperature-controlled block is a heat block used to further activate and drive the formation of the chalcogenide-based solid-state electrolyte.

In yet another aspect of the fourth embodiment, and as an alternative, the at least one temperature-controlled block may be a cold block used to quench the chalcogenide-based solid-state electrolyte to further reduce the particle size.

In yet another aspect of the fourth embodiment, a rotating conveyor-belt system may further comprise a knife or blade used to remove the chalcogenide-based solid-state electrolyte from said single rotating conveyor-belt, wherein the chalcogenide-based solid-state electrolyte is collected in a rotating collection crucible at the bottom of the processing chamber.

In the fifth embodiment of the disclosure, a chalcogenide-based solid-state electrolyte may be used in a solid-state battery.

In an aspect of the fifth embodiment, solid-state battery may comprise a cathode and chalcogenide-based solid-state electrolyte membrane.

In another aspect of the fifth embodiment, a cathode may comprise a chalcogenide-based solid-state electrolyte serving as a catholyte forming what is commonly referred to in the art as a composite cathode.

In yet another aspect of the fifth embodiment, a chalcogenide-based solid-state electrolyte membrane may comprise of a binding polymer forming what is commonly referred to in the art as a composite solid-state electrolyte membrane.

In yet another aspect of the fifth embodiment, a solid-state battery may further comprise an anode which is physically separated from the cathode by the chalcogenide-based solid-state electrolyte membrane.

In yet another aspect of the fifth embodiment, an anode may comprise of a chalcogenide-based solid-state electrolyte serving as an anolyte forming what is commonly referred to in the art as a composite anode.

In yet another aspect of the fifth embodiment, an anode may include an alkali-metal film such as, for example, lithium metal film or sodium metal film.

In yet another aspect of the fifth embodiment, a solid-state battery may not comprise an anode in what is commonly referred to in the art as an anodeless solid-state battery.

The present disclosure relates to a chalcogenide-based solid-state electrolyte.

A chalcogenide-based solid-state electrolyte material may include a solid-state ionic conducting material with an argyrodite crystal structure.

A chalcogenide-based solid-state electrolyte material may include a solid-state ionic conducting material with the general formula A₁₂₋ₘ₋ₓM^{m}Y₍₆₋ₓ₎Xₓ, where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵), or a combination thereof, Y=Sulfur (S), Selenium (Se), Tellurium (Te), or a combination thereof, X=Fluorine (F), Chlorine (Cl), Bromine (Br), Iodide (I), or a combination thereof, and x is in the range of 00≤x≤2, with a preferred range of 1.0≤x≤2.0.

A solid-state ionic conductive material is a type of material that can selectively allow a specific charged element to pass through under the presence of an electric field or chemical potential, such as concentration differences.

While this solid-state ionic conductive material allows charged ions to migrate through, it may not allow electrons to pass easily. Examples of the charged ions in the present disclosure include, for example, Li⁺, Na⁺, K⁺, etc. However, the details of this disclosure may be ascribed to solid-state ionic conducting materials that allow the passage of other ions such as, for example, H⁺, Ag⁺, Mg²⁺, Zn²⁺, Fe³⁺, Al³⁺, etc.

The ionic conductivity of the corresponding ions is preferably to be >10⁻⁷ S/cm. It is preferable to have lower electrical conductivity (<10⁻⁷ S/cm).

A sulfide-based solid-state electrolyte material may include an ionic conducting material with the general formula A₁₂₋ₘ₋ₓM^{m}S₍₆₋ₓ₎Xₓ, where A=Lithium (Li), Sodium (Na), Potassium (K), Cesium (Cs), Rubidium (Rb), Francium (Fr), or a combination thereof, M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, X=Fluorine (F), Chlorine (Cl), Bromine (Br), Iodide (I), or a combination thereof, and x is in the range of 0≤x≤2, with a preferred range of 1.0≤x≤2.0

A sulfide-based solid-state electrolyte material for lithium solid-state batteries may include an ionic conducting material with the general formula Li₁₂₋ₘ₋ₓM^{m}S₍₆₋ₓ₎Xₓ, where M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, X=Fluorine (F), Chlorine (Cl), Bromine (Br), Iodide (I), or a combination thereof, and x is in the range of 0≤x≤2, with a preferred range of 1.0≤x≤2.0.

A sulfide-based solid-state electrolyte material for lithium solid-state batteries may include an ionic conducting material with the general formula Li₇₋ₓPS₍₆₋ₓ₎Xₓ, where X=Fluorine (F), Chlorine (Cl), Bromine (Br), Iodide (I), or a combination thereof, and x is in the range of 0≤x≤2, with a preferred range of 1.0≤x≤2.0.

A sulfide-based solid-state electrolyte material for sodium solid-state batteries may include an ionic conducting material with the general formula Na₁₂₋ₘ₋ₓM^{m}S₍₆₋ₓ₎Xₓ, where M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, X=Fluorine (F), Chlorine (Cl), Bromine (Br), Iodide (I), or a combination thereof, and x is in the range of 0≤x≤2, with a preferred range of 1.0≤x≤2.0.

A sulfide-based solid-state electrolyte material for sodium solid-state batteries may include an ionic conducting material with the general formula Na₇₋ₓPS₍₆₋ₓ₎Xₓ, where X=Fluorine (F), Chlorine (Cl), Bromine (Br), Iodide (I), or a combination thereof, and x is in the range of 0≤x≤2, with a preferred range of 1.0≤x≤2.0.

A sulfide-based solid-state electrolyte material for potassium solid-state batteries may include an ionic conducting material with the general formula K₁₂₋ₘ₋ₓM^{m}S₍₆₋ₓ₎Xₓ, where M=Boron (B³⁺), Gallium (Ge³⁺), Antimony (Sb³⁺), Silicon (Si⁴⁺), Germanium (Ga⁴⁺), Tin (Sn⁴⁺), Phosphorus (P⁵⁺), Arsenic (As⁵⁺), or a combination thereof, X=Fluorine (F), Chlorine (Cl), Bromine (Br), Iodide (I), or a combination thereof, and x is in the range of 0≤x≤2, with a preferred range of 1.0≤x≤2.0.

A sulfide-based solid-state electrolyte material for potassium solid-state batteries may include an ionic conducting material with the general formula K₇₋ₓPS₍₆₋ₓ₎Xₓ, where X=Fluorine (F), Chlorine (Cl), Bromine (Br), Iodide (I), or a combination thereof, and x is in the range of 0≤x≤2, with a preferred range of 1.0≤x≤2.0.

The present disclosure relates to the first embodiment comprising a heat-assisted vacuum processing approach for the manufacturing of chalcogenide-based solid-state electrolytes.

A heat-assisted processing approach for the manufacturing of chalcogenide-based solid-state electrolyte materials may be a low-vacuum processing approach.

A heat-assisted processing approach for the manufacturing of chalcogenide-based solid-state electrolyte materials may include a vacuum-compatible processing chamber comprising at least three effusion cells, at least one rotating conveyor belt system, and at least one collection crucible.

The vacuum-compatible processing chamber and all other components associated with the manufacturing of chalcogenide-based solid-state electrolyte materials using a heat-assisted processing approach may be located in a dry room or an inert environment such as a glovebox.

A heat-assisted processing approach for the manufacturing of chalcogenide-based solid-state electrolyte materials may include the following steps. It should be noted that the steps are guidelines for manufacturing chalcogenide-based solid-state electrolyte materials and are not met to limit the scope of the manufacturing process. The manufacturing process may include additional steps are sub-steps that are not listed but would be apparent to those skilled in the art.

The present description of the first embodiment relates to the preparation steps for the heat-assisted vacuum processing approach for the manufacturing of chalcogenide-based solid-state electrolytes.

The at least three effusion cells (EC-1V, EC-2V, and EC-3V) may be loaded into the vacuum-compatible processing chamber, wherein the vacuum-compatible processing chamber comprises at least three ports with mounting flanges designed to match mounting flanges on the at least three effusion cells to secure them under vacuum conditions. Vacuum grease may be applied to the mounting flanges to provide lubrication and further seal the port.

Alternatively, the at least three effusion cells may already be loaded into the vacuum-compatible processing chamber, wherein the loading step can be omitted.

Effusion cell EC-1V may comprise a crucible that contains A₂Y, where A=Lithium (Li), Sodium (Na), Potassium (K), Cesium (Cs), Rubidium (Rb), or Francium (Fr), and Y=Sulfur (S), Selenium (Se), or Tellurium (Te). Preferably, A₂Y is an alkali-metal sulfide such as lithium sulfide (Li₂S), sodium sulfide (Na₂S), or potassium sulfide (K₂S). The alkali-metal sulfide may be in the form of powder, granules, or chunks. The alkali-metal sulfide may be packed into the crucible in an inert environment such as a glovebox. Alternatively, the alkali-metal sulfide may be packed into the crucible in a dry room with a moisture content below 1000 ppm.

The crucible containing the alkali-metal sulfide material may be loaded into effusion cell EC-1V after packing.

Effusion cell EC-2V may comprise a crucible that contains M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-} =Sulfur (S²⁻), Selenium (Se²⁻), or Tellurium (Te²⁻), and M_{y}^{m+}Yₘ^{y-} is in empirical form. Preferably, M_{y}^{m+}Yₘ^{y-} is phosphorus pentasulfide (P₂S₅). The phosphorous pentasulfide may be in the form of powder, granules, or chunks. The phosphorous pentasulfide may be packed into the crucible in an inert environment such as a glovebox. Alternatively, the phosphorous pentasulfide may be packed into the crucible in a dry room with a moisture content below 1000 ppm. In yet another alternative, the phosphorous pentasulfide may be packed into the crucible at ambient conditions.

The crucible containing the phosphorous pentasulfide may be loaded into effusion cell EC-2V after packing.

Effusion cell EC-3V may comprise a crucible that contains AX, where A=Lithium (Li), Sodium (Na), Potassium (K), Cesium (Cs), Rubidium (Rb), or Francium (Fr), and X=Fluorine (F), Chlorine (Cl), Bromine (Br), or Iodide (I). Preferably, AX is an alkali-metal halide salt such as, for example, lithium fluoride (LiF), lithium chloride (LiCl), lithium bromide (LiBr), sodium fluoride (NaF), sodium chloride (NaCl), sodium bromide (NaBr), potassium fluoride (KF), potassium chloride (KCl), or potassium bromide (KBr). The alkali-metal halide salt may be in the form of powder, granules, or chunks. The alkali-metal halide salt may be packed into the crucible in an inert environment such as a glovebox. Alternatively, the alkali-metal halide salt may be packed into the crucible in a dry room with a moisture content below 1000 ppm.

The crucible containing the alkali-metal halide salt may be loaded into effusion cell EC-3V after packing.

The present description of the first embodiment relates to the conditioning steps for the heat-assisted vacuum processing approach for the manufacturing of chalcogenide-based solid-state electrolytes.

The vacuum-compatible processing chamber may be evacuated to purge moisture, atmosphere, and other potential contaminants. The processing chamber may reach a vacuum level in the range of 10²≤p≤10⁻¹¹ torr, with a preferred range of 10⁰≤p≤10⁻⁷ torr.

During purging, the at least three effusion cells (EC-1V, EC-2V, and EC-3V) may be heated to a conditioning temperature in the range of 50≤T≤200° C. to remove any residual moisture within the alkali-metal sulfide, phosphorous pentasulfide, or alkali-metal halide salt. It should also be noted that during purging, any shutters on the at least three effusion cells should preferably be in the open position.

Purge duration may be in the range of 1≤t≤500,000 seconds, with a preferred range of 30≤t≤50,000 seconds.

The processing chamber may comprise a multi-vacuum level system including, for example, a dry roughing pump, an oil-based roughing pump, and a turbo pump.

Following the purge, the vacuum-compatible processing chamber may be backfilled with an inert gas such, for example, helium, nitrogen, or argon to a pressure in the range of 760≤p≤10⁻¹ torr. Inert gas purity may be in the range of 97≤p≤99.99999%.

The steps of purging followed by backfilling with inert gas may be repeated several times to reach the desired vacuum levels within the processing chamber.

After the final purging step, the processing chamber may have a vacuum level in the range of 10²≤p≤10⁻¹¹ torr, with a preferred range of 10⁰≤p≤10⁻⁷ torr.

The present description of the first embodiment relates to the processing steps of the heat-assisted vacuum processing approach for the manufacturing of chalcogenide-based solid-state electrolytes.

The at least three effusion cells may be heated to a temperature in the range of 100<T<2000° C. to begin the evaporation process.

Effusion cell EC-1V may be heated to a temperature in the preferred range of 200<T<1500° C. to evaporate an alkali-metal sulfide (A₂Y) with the chemical formula Li₂S, Na₂S, or K₂S.

Effusion cell EC-2V may be heated to a temperature in the preferred range of 100<T<750° C. to evaporate phosphorous pentasulfide (P₂S₅).

Effusion cell EC-3V may be heated to a temperature in the preferred range of 500<T<2000° C. to evaporate an alkali-metal halide salt (AX), where A is Lithium (Li), Sodium (Na), or Potassium (K), and X is Fluorine (F), Chlorine (Cl), Bromine (Br), or Iodide (I).

The flux ratio between the evaporated materials may be used to govern or control the chemical formula of the chalcogenide-based solid-state electrolyte.

The flux ratio between the evaporated materials may be derived from equation EQ1:

$$( 12 - m - 2 x ) {A}_{2} Y + ( \frac{2}{y} ) {M}_{y}^{m +} {Y}_{m}^{y -} + ( 2 x ) A X = 2 ( {A}_{( 12 - m - x )} {M}^{m +} {Y}_{( 6 - x )} {X}_{x} )$$

wherein the flux of A₂Y (EC-1V) may be derived from equation EQ_{A}: flux(A₂Y)=12−m−2x; the flux of M_{y}^{m+}Yₘ^{y-} (EC-2V), or more preferably phosphorus pentasulfide (P₂S₅), may be derived from equation EQ_{B}: flux(P₂S₅)=2/y which may be kept constant at one, and the flux of AX (EC-3V) may be derived from equation EQ_{C}: flux(AX)=2x.

Therefore, the flux ratio (A₂S:P₂S₅:AX) may be represented in equation EQ3:

$$12 - m - 2 x : 1 : 2 x = {A}_{12 - m - 2 x} P {S}_{6 - 1} {X}_{x}$$

In an example, to manufacture a chalcogenide-based solid-state electrolyte with the general formula A_{6.5}PS_{5.5}X_{0.5}, a flux ratio (A₂S:P₂S₅:AX) of 6:1:1 may be required; wherein the flux of the A₂S may be six times greater than the flux of P₂S₅ and AX.

In another example, to manufacture a chalcogenide-based solid-state electrolyte with the general formula A₆PS₅X, a flux ratio (A₂S:P₂S₅:AX) of 5:1:2 may be required; wherein the flux of the A₂S may be five times greater than the flux of P₂S₅, and the flux of AX may be two times greater than the flux of P₂S₅.

In yet another example, to manufacture a chalcogenide-based solid-state electrolyte with the general formula A_{5.5}PS_{4.5}X_{1.5} may have an A₂S:P₂S₅:AX flux ratio of 4:1:3; wherein the flux of the A₂S may be four times greater than the flux of P₂S₅, and the flux of AX may be three times greater than the flux of P₂S₅.

It should be noted that the measured or actual value of the flux may depend on a number of parameters including the size of the chamber and the size of the effusion cells (as well as the number of effusion cells if greater than three) and therefore cannot be defined in the scope of the specification.

The flux may be controlled by adjusting the set temperature point of each of the at least three effusion cells thereby controlling the evaporation rate of gaseous alkali-metal sulfide, phosphorus pentasulfide, and alkali-metal halide salt. The set temperature point may be controlled by controlling the amperage delivered to the effusion cell or the temperature of the chilled water circulating within the effusion cell if applicable.

The flux may be controlled by varying the temperature of one of the at least three effusion cells within a set range thereby controlling, but allowing for variation, the evaporation rate of gaseous alkali-metal sulfide, phosphorus pentasulfide, or alkali-metal halide salt. The temperature range can be controlled within the set range by controlling the amperage delivered to the effusion cell or the temperature of the chilled water circulating within the effusion cell if applicable.

The flux may be controlled by varying the temperature of two of the at least three effusion cells within a set range thereby controlling, but allowing for variation, the evaporation rate of gaseous alkali-metal sulfide, phosphorus pentasulfide, or alkali-metal halide salt. The temperature range can be controlled within the set range by controlling the amperage delivered to the effusion cell or the temperature of the chilled water circulating within the effusion cell if applicable.

The flux may be controlled by varying the temperature of all three effusion cells within a set range thereby controlling, but allowing for variation, the evaporation rate of gaseous alkali-metal sulfide, phosphorus pentasulfide, or alkali-metal halide salt. The temperature range can be controlled within the set range by controlling the amperage delivered to the effusion cell or the temperature of the chilled water circulating within the effusion cell if applicable.

In yet another alternative, or combination with any of the aforementioned temperature control strategies, the flux may be controlled by opening and closing the shutter on top of the effusion cell at set durations or intervals.

The evaporated alkali-metal sulfide, phosphorous pentasulfide, and alkali-metal halide salt gases may mix inside the processing chamber and form a mixed or alloy material layer on the surface of the single rotating conveyor belt.

The single rotating conveyor belt may rotate at a rate in the range of 0.01≤t≤1000 mm per second, with a preferred range of 0.1≤t≤10 mm per second.

The temperature of the single rotating conveyor belt may be controlled using a temperature-controlled block, such as a heat block, positioned in the headspace above the side of the belt facing the at least three effusions, or more accurately described as in between the single rotating conveyor belt.

The heat block may provide a temperature in the range of 0≤T≤2000° C., with a preferred range of 100≤T≤1000° C.

The heat block may provide a sufficient amount of heat to drive the reaction between the alkali-metal sulfide, phosphorous pentasulfide, and alkali-metal halide salt in the deposited material layer forming a chalcogenide-based solid-state electrolyte.

A knife or blade may be used to scrape the chalcogenide-based solid-state electrolyte off the single rotating conveyor belt and into the at least one collection crucible at the bottom of the processing chamber.

The present description of the first embodiment relates to the post-processing and collection steps of the heat-assisted vacuum processing approach for the manufacturing of chalcogenide-based solid-state electrolytes.

The heat-assisted processing approach may be considered complete when 1) the alkali-metal sulfide is depleted in effusion cell EC-1V, 2) the phosphorous pentasulfide is depleted in effusion cell EC-2V, 3) the alkali-metal halide salt is depleted in effusion cell EC-3V, or 4) the desired amount of chalcogenide-based solid-state electrolyte has been collected in the at least one collection crucible.

The at least three effusion cells may be turned off, allowing them to cool, with the shutters orientated in the closed position. Chilled water or antifreeze may run through coolant lines in the at least three effusion cells enabling a more rapid cooling.

The heat block located between the single rotating conveyor belt may be turned off allowing it to cool. The heat block may also comprise of chilled water or antifreeze lines enabling a more rapid cooling.

The processing chamber may be backfilled with an inert gas to a pressure of 760 torr. An inert gas may include, for example, helium, nitrogen, or argon.

A latched door on top of the processing chamber may be unlatched and opened to remove the at least one collection crucible comprising the chalcogenide-based solid-state electrolyte material.

The chalcogenide-based solid-state electrolyte may be further processed to convert any residual alkali-metal sulfide, phosphorus pentasulfide, or alkali-metal halide salt into a chalcogenide-based solid-state electrolyte material. Further processing may include thermal annealing at a temperature in the range of 100≤T≤1000° C.

The at least three effusion cells may be removed from the processing chamber for cleaning. Alternatively, the at least three effusion cell crucibles may be removed, cleaned, and repacked for additional heat-assisted processing.

The present disclosure relates to the second embodiment comprising a heat-assisted halogen gas processing approach for the manufacturing of chalcogenide-based solid-state electrolytes.

A heat-assisted processing approach for the manufacturing of chalcogenide-based solid-state electrolyte materials may be a halogen gas processing approach.

A heat-assisted processing approach for the manufacturing of chalcogenide-based solid-state electrolyte materials may include a vacuum and halogen gas compatible processing chamber comprising at least three effusion cells, at least one rotating conveyor belt system, and at least one collection crucible.

The vacuum and halogen gas compatible processing chamber and all other components associated with the manufacturing of chalcogenide-based solid-state electrolyte materials using a heat-assisted processing approach may be located in a dry room or an inert environment such as a glovebox.

A heat-assisted processing approach for the manufacturing of chalcogenide-based solid-state electrolyte materials may include the following steps. It should be noted that the steps are guidelines for manufacturing chalcogenide-based solid-state electrolyte materials and are not met to limit the scope of the manufacturing process. The manufacturing process may include additional steps are sub-steps that are not listed but would be apparent to those skilled in the art.

The present description of the second embodiment relates to the preparation steps for the heat-assisted halogen gas processing approach for the manufacturing of chalcogenide-based solid-state electrolytes.

The at least three effusion cells (EC-1G, EC-2G, and EC-3G) may be loaded into the vacuum and halogen gas compatible processing chamber, wherein the vacuum-compatible processing chamber comprises at least three ports with mounting flanges designed to match mounting flanges on the at least three effusion cells to secure them under vacuum conditions. Vacuum grease may be applied to the mounting flanges to provide lubrication and further seal the port.

Alternatively, the at least three effusion cells may already be loaded into the vacuum and halogen gas compatible processing chamber, wherein the loading step can be omitted.

Effusion cell EC-1G may comprise a crucible that contains alkali-metal A, where A=Lithium (Li), Sodium (Na), Potassium (K), Cesium (Cs), Rubidium (Rb), or Francium (Fr). Preferably, A is Lithium (Li), Sodium (Na), or potassium (K). The alkali-metal may be in the form of powder, granules, or chunks. The alkali-metal may be packed into the crucible in an inert environment such as a glovebox. Alternatively, the alkali-metal sulfide may be packed into the crucible in a dry room with a moisture content below 1000 ppm.

The crucible containing the alkali-metal sulfide material may be loaded into effusion cell EC-1G after packing.

Effusion cell EC-2G may comprise a crucible that contains Y, where Y=Sulfur (S), Selenium (Se), or Tellurium (Te). Preferably, Y is elemental sulfur and EC-2G is a thermal cracker effusion cell. The elemental sulfur may be in the form of powder, granules, or chunks. The elemental sulfur may be packed into the crucible in an inert environment such as a glovebox. Alternatively, the elemental sulfur may be packed into the crucible in a dry room with a moisture content below 1000 ppm. In yet another alternative, the elemental sulfur may be packed into the crucible in ambient conditions.

The crucible containing the elemental sulfur may be loaded into effusion cell EC-2G after packing.

Effusion cell EC-3G may comprise a crucible that contains M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-} =Sulfur (S²⁻), Selenium (Se²⁻), or Tellurium (Te²⁻), and M_{y}^{m+}Yₘ^{y-} is in empirical form. Preferably, M_{y}^{m+}Yₘ^{y-} is phosphorus pentasulfide (P₂S₅). The phosphorous pentasulfide may be in the form of powder, granules, or chunks. The phosphorous pentasulfide may be packed into the crucible in an inert environment such as a glovebox. Alternatively, the phosphorous pentasulfide may be packed into the crucible in a dry room with a moisture content below 1000 ppm. In yet another alternative, the phosphorous pentasulfide may be packed into the crucible at ambient conditions.

The crucible containing the phosphorous pentasulfide may be loaded into effusion cell EC-3G after packing.

The present description of the second embodiment relates to the conditioning steps for the heat-assisted halogen gas processing approach for the manufacturing of chalcogenide-based solid-state electrolytes.

The vacuum and halogen gas compatible processing chamber may be evacuated to purge moisture, atmosphere, and other potential contaminants. The processing chamber may reach a vacuum level in the range of 10²≤p≤10⁻¹¹ torr, with a preferred range of 10⁰≤p≤10⁷ torr.

During purging, the at least three effusion cells (EC-1G, EC-2G, and EC-3G) may be heated to a conditioning temperature in the range of 50≤T≤200° C. to remove any residual moisture within the alkali-metal, elemental sulfur, or phosphorous pentasulfide. It should also be noted that during purging, any shutters on the at least three effusion cells should preferably be in the open position.

Purge duration may be in the range of 1≤t≤500,000 seconds, with a preferred range of 30≤t≤50,000 seconds.

The processing chamber may comprise a multi-vacuum level system including, for example, a dry roughing pump, an oil-based roughing pump, and a turbo pump.

Following the purge, the vacuum and halogen gas compatible processing chamber may be backfilled with an inert gas such, for example, helium, nitrogen, or argon to a pressure in the range of 760≤p≤10⁻¹ torr. Inert gas purity may be in the range of 97≤p≤99.99999%.

The steps of purging followed by backfilling with inert gas may be repeated several times to reach the desired vacuum levels within the processing chamber.

After the final purging step, the processing chamber may have a vacuum level in the range of 10²p≤10⁻¹¹ torr, with a preferred range of 10⁰≤p≤10⁻⁷ torr.

The present description of the second embodiment relates to the processing steps of the heat-assisted halogen gas processing approach for the manufacturing of chalcogenide-based solid-state electrolytes.

The at least three effusion cells may be heated to a temperature in the range of 100<T<2000° C. to begin the evaporation process.

Effusion cell EC-1G may be heated to a temperature in the preferred range of 200<T<1500° C. to evaporate an alkali-metal such as, for example, Lithium (Li), Sodium (Na), or Potassium (K).

Effusion cell EC-2G may be heated to a temperature in the preferred range of 100<T<900° C. to evaporate a chalcogen element, preferably elemental sulfur (S)

Effusion cell EC-3G may be heated to a temperature in the preferred range of 100<T<750° C. to evaporate phosphorous pentasulfide (P₂S₅).

The flux ratio between the evaporated materials and halogen gas may be used to govern or control the chemical formula of the chalcogenide-based solid-state electrolyte.

The flux ratio between the evaporated materials may be derived from equation EQ2:

$$( 24 - 2 m - 2 x ) A + ( 12 - m - 2 x ) Y + ( \frac{2}{y} ) {M}_{y}^{m +} {Y}_{m}^{y -} + ( x ) {X}_{2} = 2 ( {A}_{( 12 - m - x )} {M}^{m} {Y}_{( 6 - x )} {X}_{x} )$$

wherein the flux of A (EC-1G) may be derived from equation EQ_{D}: flux(A)=24−2m−2x; the flux of Y (EC-2G) may be derived from equation EQ_{E}: flux(Y)=12−m−2x; the flux of M_{y}^{m+}Yₘ^{y-} (EC-3G), or more preferably phosphorus pentasulfide (P₂S₅), may be derived from equation EQ_{F}: flux(P₂S₅)=2/y which may be kept constant at one, and the flux of the halogen gas (X₂) may be derived from equation EQ_{G}: flux(X₂)=x.

Therefore, the flux ratio (A:Y:P₂S₅:X₂) may be represented in equation EQ4:

$$24 - 2 m - 2 x : 12 - m - 2 x : 1 : x = {A}_{12 - m - 2 x} {PS}_{6 - 1} {X}_{x}$$

In an example, to manufacture a chalcogenide-based solid-state electrolyte with the general formula A_{6.5}PS_{5.5}X_{0.5}, a flux ratio of 13:6:1:0.5 (A:Y:P₂S₅:X₂) may be required; wherein the flux of the A may be thirteen times greater than the flux of P₂S₅, the flux of Y may be six times greater than the flux of P₂S₅, and the flux of the halogen gas (X₂) may be 0.5 times the flux of P₂S₅.

In another example, to manufacture a chalcogenide-based solid-state electrolyte with the general formula A₆PS₅X, a flux ratio of 12:5:1:1 (A:Y:P₂S₅:X₂) may be required; wherein the flux of the A may be twelve times greater than the flux of P₂S₅, the flux of Y may be five times greater than the flux of P₂S₅, and the flux of the halogen gas (X₂) may be equal to the flux of P₂S₅.

In yet another example, to manufacture a chalcogenide-based solid-state electrolyte with the general formula A_{5.5}PS_{4.5}X_{1.5}, a flux ratio of 11:4:1:1.5 (A:Y:P₂S₅:X₂) may be required; wherein the flux of the A may be eleven times greater than the flux of P₂S₅, the flux of Y may be four times greater than the flux of P₂S₅, and the flux of the halogen gas (X₂) may be 1.5 times the flux of P₂S₅.

It should be noted that the measured or actual value of the flux may depend on many parameters including the size of the chamber and the size of the effusion cells (as well as the number of effusion cells if greater than three) and therefore cannot be defined in the scope of the specification.

The flux may be controlled by adjusting the set temperature point of each of the at least three effusion cells thereby controlling the evaporation rate of gaseous alkali-metal, elemental sulfur, and phosphorus pentasulfide. The set temperature point may be controlled by controlling the amperage delivered to the effusion cell or the temperature of the chilled water circulating within the effusion cell if applicable.

The flux may be controlled by varying the temperature of one of the at least three effusion cells within a set range thereby controlling, but allowing for variation, the evaporation rate of gaseous alkali-metal, elemental sulfur, or phosphorus pentasulfide. The temperature range can be controlled within the set range by controlling the amperage delivered to the effusion cell or the temperature of the chilled water circulating within the effusion cell if applicable.

The flux may be controlled by varying the temperature of two of the at least three effusion cells within a set range thereby controlling, but allowing for variation, the evaporation rate of gaseous alkali-metal, elemental sulfur, or phosphorus pentasulfide. The temperature range can be controlled within the set range by controlling the amperage delivered to the effusion cell or the temperature of the chilled water circulating within the effusion cell if applicable.

The flux may be controlled by varying the temperature of all three effusion cells within a set range thereby controlling, but allowing for variation, the evaporation rate of gaseous alkali-metal, elemental sulfur, and phosphorus pentasulfide. The temperature range can be controlled within the set range by controlling the amperage delivered to the effusion cell or the temperature of the chilled water circulating within the effusion cell if applicable.

The flux of the halogen gas may be controlled using a mass flow control system or unit external of the processing chamber.

In yet another alternative, or combination with any of the aforementioned temperature control strategies, the flux may be controlled by opening and closing the shutter on top of the effusion cell at set durations or intervals.

The evaporated alkali-metal, elemental sulfur, and phosphorus pentasulfide gases, and halogen gas may mix inside the processing chamber and form a mixed or alloy material layer on the surface of the single rotating conveyor belt.

The single rotating conveyor belt may rotate at a rate in the range of 0.01≤t≤1000 mm per second, with a preferred range of 0.1≤t≤10 mm per second.

The temperature of the single rotating conveyor belt may be controlled using a temperature-controlled block, such as a heat block, positioned in the headspace above the side of the belt facing the at least three effusions, or more accurately described as in between the single rotating conveyor belt.

The heat block may provide a temperature in the range of 0≤T≤2000° C., with a preferred range of 100≤T≤1000° C.

The heat block may provide a sufficient amount of heat to drive the reaction between the alkali-metal, elemental sulfur, phosphorus pentasulfide, and halogen gas in the deposited material layer forming a chalcogenide-based solid-state electrolyte.

A knife or blade may be used to scrape the chalcogenide-based solid-state electrolyte off the single rotating conveyor belt and into the at least one collection crucible at the bottom of the processing chamber.

The present description of the second embodiment relates to the post-processing and collection steps of the heat-assisted gas processing approach for the manufacturing of chalcogenide-based solid-state electrolytes.

The heat-assisted processing approach may be considered complete when 1) the alkali-metal is depleted in effusion cell EC-1G, 2) the elemental sulfur is depleted in effusion cell EC-2V, 3) the phosphorous pentasulfide is depleted in effusion cell EC-3V, or 4) the desired amount of chalcogenide-based solid-state electrolyte has been collected in the at least one collection crucible.

The at least three effusion cells may be turned off, allowing them to cool, with the shutters orientated in the closed position. Chilled water or antifreeze may run through coolant lines in the at least three effusion cells enabling a more rapid cooling.

The heat block located between the single rotating conveyor belt may be turned off allowing it to cool. The heat block may also comprise of chilled water or antifreeze lines enabling a more rapid cooling.

The processing chamber may be backfilled with an inert gas to a pressure of 760 torr. An inert gas may include, for example, helium, nitrogen, or argon.

A latched door on top of the processing chamber may be unlatched and opened to remove the at least one collection crucible comprising the chalcogenide-based solid-state electrolyte material.

The chalcogenide-based solid-state electrolyte may be further processed to convert any residual alkali-metal, elemental sulfur, or phosphorus pentasulfide into a chalcogenide-based solid-state electrolyte material. Further processing may include thermal annealing at a temperature in the range of 100≤T≤1000° C.

The at least three effusion cells may be removed from the processing chamber for cleaning. Alternatively, the at least three effusion cell crucibles may be removed, cleaned, and repacked for additional heat-assisted processing.

The present disclosure relates to the third embodiment comprising a plasma-assisted vacuum processing approach for the manufacturing of chalcogenide-based solid-state electrolytes.

A plasma-assisted processing approach for the manufacturing of chalcogenide-based solid-state electrolyte materials may be a high-vacuum processing approach.

A plasma-assisted processing approach for the manufacturing of chalcogenide-based solid-state electrolyte materials may include a vacuum-compatible processing chamber comprising at least three effusion cells, at least one plasma generation system comprising at least one cathode and one anode connected to an external power source, at least one rotating conveyor belt system, and at least one collection crucible.

The vacuum-compatible processing chamber and all other components associated with the manufacturing of chalcogenide-based solid-state electrolyte materials using a plasma-assisted processing approach may be located in a dry room or an inert environment such as a glovebox.

A plasma-assisted processing approach for the manufacturing of chalcogenide-based solid-state electrolyte materials may include the following steps. It should be noted that the steps are guidelines for manufacturing chalcogenide-based solid-state electrolyte materials and are not met to limit the scope of the manufacturing process. The manufacturing process may include additional steps are sub-steps that are not listed but would be apparent to those skilled in the art.

The present description of the third embodiment relates to the preparation steps for the plasma-assisted vacuum processing approach for the manufacturing of chalcogenide-based solid-state electrolytes.

The at least three effusion cells (EC-1V, EC-2V, and EC-3V) may be loaded into the vacuum-compatible processing chamber, wherein the vacuum-compatible processing chamber comprises at least three ports with mounting flanges designed to match mounting flanges on the at least three effusion cells to secure them under vacuum conditions. Vacuum grease may be applied to the mounting flanges to provide lubrication and further seal the port.

Alternatively, the at least three effusion cells may already be loaded into the vacuum-compatible processing chamber, wherein the loading step can be omitted.

Effusion cell EC-1V may comprise a crucible that contains A₂Y, where A=Lithium (Li), Sodium (Na), Potassium (K), Cesium (Cs), Rubidium (Rb), or Francium (Fr), and Y=Sulfur (S), Selenium (Se), or Tellurium (Te). Preferably, A₂Y is an alkali-metal sulfide such as lithium sulfide (Li₂S), sodium sulfide (Na₂S), or potassium sulfide (K₂S). The alkali-metal sulfide may be in the form of powder, granules, or chunks. The alkali-metal sulfide may be packed into the crucible in an inert environment such as a glovebox. Alternatively, the alkali-metal sulfide may be packed into the crucible in a dry room with a moisture content below 1000 ppm.

The crucible containing the alkali-metal sulfide material may be loaded into effusion cell EC-1V after packing.

Effusion cell EC-2V may comprise a crucible that contains M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-} =Sulfur (S²⁻), Selenium (Se²⁻), or Tellurium (Te²⁻), and M_{y}^{m+}Yₘ^{y-} is in empirical form. Preferably, M_{y}^{m+}Yₘ^{y-} is phosphorus pentasulfide (P₂S₅). The phosphorous pentasulfide may be in the form of powder, granules, or chunks. The phosphorous pentasulfide may be packed into the crucible in an inert environment such as a glovebox. Alternatively, the phosphorous pentasulfide may be packed into the crucible in a dry room with a moisture content below 1000 ppm. In yet another alternative, the phosphorous pentasulfide may be packed into the crucible at ambient conditions.

The crucible containing the phosphorous pentasulfide may be loaded into effusion cell EC-2V after packing.

Effusion cell EC-3V may comprise a crucible that contains AX, where A=Lithium (Li), Sodium (Na), Potassium (K), Cesium (Cs), Rubidium (Rb), or Francium (Fr), and X=Fluorine (F), Chlorine (Cl), Bromine (Br), or Iodide (I). Preferably, AX is an alkali-metal halide salt such as, for example, lithium fluoride (LiF), lithium chloride (LiCl), lithium bromide (LiBr), sodium fluoride (NaF), sodium chloride (NaCl), sodium bromide (NaBr), potassium fluoride (KF), potassium chloride (KCl), or potassium bromide (KBr). The alkali-metal halide salt may be in the form of powder, granules, or chunks. The alkali-metal halide salt may be packed into the crucible in an inert environment such as a glovebox. Alternatively, the alkali-metal halide salt may be packed into the crucible in a dry room with a moisture content below 1000 ppm.

The crucible containing the alkali-metal halide salt may be loaded into effusion cell EC-3V after packing.

The present description of the third embodiment relates to the conditioning steps for the plasma-assisted vacuum processing approach for the manufacturing of chalcogenide-based solid-state electrolytes.

The vacuum-compatible processing chamber may be evacuated to purge moisture, atmosphere, and other potential contaminants. The processing chamber may reach a vacuum level in the range of 10²≤p≤10⁻¹¹ torr, with a preferred range of 10⁰≤p≤10⁻⁷ torr.

During purging, the at least three effusion cells (EC-1V, EC-2V, and EC-3V) may be heated to a conditioning temperature in the range of 50≤T≤200° C. to remove any residual moisture within the alkali-metal sulfide, phosphorous pentasulfide, or alkali-metal halide salt. It should also be noted that during purging, any shutters on the at least three effusion cells should preferably be in the open position.

Purge duration may be in the range of 1≤t≤500,000 seconds, with a preferred range of 30≤t≤50,000 seconds.

The processing chamber may comprise a multi-vacuum level system including, for example, a dry roughing pump, an oil-based roughing pump, and a turbo pump. For plasma-assisted processing, the processing chamber may further comprise one or more ion-getter pumps.

Following the purge, the vacuum-compatible processing chamber may be backfilled with an inert gas such, for example, helium, nitrogen, or argon to a pressure in the range of 760≤p≤10⁻¹ torr. Inert gas purity may be in the range of 97≤p≤99.99999%.

The steps of purging followed by backfilling with inert gas may be repeated several times to reach the desired vacuum levels within the processing chamber.

After the final purging step, the processing chamber may have a vacuum level in the range of 10²≤p≤10⁻¹¹ torr, with a preferred range of 10⁰≤p≤10⁻⁷ torr.

The present description of the third embodiment relates to the processing steps of the plasma-assisted vacuum processing approach for the manufacturing of chalcogenide-based solid-state electrolytes.

A DC voltage may be applied across the at least one cathode and one anode to generate an electric field with a strength in the range of 0≤P≤100,000 kilovolts per meter (kV/m). Alternatively, an AC voltage may be applied in certain situations or applications where an alternating voltage field is desired.

The at least three effusion cells may be heated to a temperature in the range of 100<T<2000° C. to begin the evaporation process.

Effusion cell EC-1V may be heated to a temperature in the preferred range of 200<T<1500° C. to evaporate an alkali-metal sulfide (A₂Y) with the chemical formula Li₂S, Na₂S, or K₂S.

Effusion cell EC-2V may be heated to a temperature in the preferred range of 100<T<750° C. to evaporate phosphorous pentasulfide (P₂S₅).

Effusion cell EC-3V may be heated to a temperature in the preferred range of 500<T<2000° C. to evaporate an alkali-metal halide salt (AX), where A is Lithium (Li), Sodium (Na), or Potassium (K), and X is Fluorine (F), Chlorine (Cl), Bromine (Br), or Iodide (I).

The flux ratio between the evaporated materials may be used to govern or control the chemical formula of the chalcogenide-based solid-state electrolyte.

The flux ratio between the evaporated materials may be derived from equation EQ1:

$$( 12 - m - 2 x ) {A}_{2} Y + ( \frac{2}{y} ) {M}_{y}^{m +} {Y}_{m}^{y -} + ( 2 x ) A X = 2 ( {A}_{( 12 - m - x )} {M}^{m +} {Y}_{( 6 - x )} {X}_{x} )$$

wherein the flux of A₂Y (EC-1V) may be derived from equation EQ_{A}: flux(A₂Y)=12−m−2x; the flux of M_{y}^{m+}Yₘ^{y-} (EC-2V), or more preferably phosphorus pentasulfide (P₂S₅), may be derived from equation EQ_{B}: flux(P₂S₅)=2/y which may be kept constant at one, and the flux of AX (EC-3V) may be derived from equation EQ_{C}: flux(AX)=2x.

Therefore, the flux ratio (A₂S:P₂S₅:AX) may be represented in equation EQ3:

$$12 - m - 2 x : 1 : 2 x = {A}_{12 - m - 2 x} P {S}_{6 - 1} {X}_{x}$$

In an example, to manufacture a chalcogenide-based solid-state electrolyte with the general formula A_{6.5}PS_{5.5}X_{0.5}, a flux ratio (A₂S:P₂S₅:AX) of 6:1:1 may be required; wherein the flux of the A₂S may be six times greater than the flux of P₂S₅ and AX.

In another example, to manufacture a chalcogenide-based solid-state electrolyte with the general formula A₆PS₅X, a flux ratio (A₂S:P₂S₅:AX) of 5:1:2 may be required; wherein the flux of the A₂S may be five times greater than the flux of P₂S₅, and the flux of AX may be two times greater than the flux of P₂S₅.

In yet another example, to manufacture a chalcogenide-based solid-state electrolyte with the general formula A_{5.5}PS_{4.5}X_{1.5} may have an A₂S:P₂S₅:AX flux ratio of 4:1:3; wherein the flux of the A₂S may be four times greater than the flux of P₂S₅, and the flux of AX may be three times greater than the flux of P₂S₅.

It should be noted that the measured or actual value of the flux may depend on a number of parameters including the size of the chamber and the size of the effusion cells (as well as the number of effusion cells if greater than three) and therefore cannot be defined in the scope of the specification.

The flux may be controlled by adjusting the set temperature point of each of the at least three effusion cells thereby controlling the evaporation rate of gaseous alkali-metal sulfide, phosphorus pentasulfide, and alkali-metal halide salt. The set temperature point may be controlled by controlling the amperage delivered to the effusion cell or the temperature of the chilled water circulating within the effusion cell if applicable.

The flux may be controlled by varying the temperature of one of the at least three effusion cells within a set range thereby controlling, but allowing for variation, the evaporation rate of gaseous alkali-metal sulfide, phosphorus pentasulfide, or alkali-metal halide salt. The temperature range can be controlled within the set range by controlling the amperage delivered to the effusion cell or the temperature of the chilled water circulating within the effusion cell if applicable.

The flux may be controlled by varying the temperature of two of the at least three effusion cells within a set range thereby controlling, but allowing for variation, the evaporation rate of gaseous alkali-metal sulfide, phosphorus pentasulfide, or alkali-metal halide salt. The temperature range can be controlled within the set range by controlling the amperage delivered to the effusion cell or the temperature of the chilled water circulating within the effusion cell if applicable.

The flux may be controlled by varying the temperature of all three effusion cells within a set range thereby controlling, but allowing for variation, the evaporation rate of gaseous alkali-metal sulfide, phosphorus pentasulfide, or alkali-metal halide salt. The temperature range can be controlled within the set range by controlling the amperage delivered to the effusion cell or the temperature of the chilled water circulating within the effusion cell if applicable.

In yet another alternative, or combination with any of the aforementioned temperature control strategies, the flux may be controlled by opening and closing the shutter on top of the effusion cell at set durations or intervals.

The gaseous alkali-metal sulfide, phosphorous pentasulfide, and alkali-metal halide salt may mix as they enter the generated electric field between the cathode and anode, wherein the gaseous mix may ionize resulting in the formation of a plasma plume.

In some instances, an inert gas may be introduced directly into the plasma plume to enhance ionization and chalcogenide-based solid-state electrolyte formation. An inert gas may include, for example, argon, nitrogen, helium, neon, krypton, xenon, etc.

The chalcogenide-based solid-state electrolyte may form inside the plasma plume and either deposit onto the single rotating conveyor belt above, fall to the at least one collection crucible below, or a combination of the two.

While the deposited layer is presumed to be entirely chalcogenide-based solid-state electrolyte (with the general formula: A₁₂₋ₘ₋ₓMₘY₍₆₋ₓ₎Xₓ), there may still be some residual alkali-metal sulfide, phosphorous pentasulfide, and/or alkali-metal halide salt in the deposited layer. The percentage of residual alkali-metal sulfide, phosphorous pentasulfide, and alkali-metal halide salt in the layer is less than 99%, more preferably less than 50%, more preferably less than 25%, more preferably less than 10%, more preferably less than 1%, more preferably less than 0.5%, more preferably less than 0.25%, more preferably less than 0.1%, more preferably less than 0.05%, more preferably less than 0.01%, more preferably less than 0.001%.

The temperature of the single rotating conveyor belt may be controlled using a temperature-controlled block such as a heat block positioned in the headspace above the side of the belt facing the at least three effusion cells or more accurately described as in between the single rotating conveyor belt.

The heat block may provide a temperature in the range of 0≤T≤2000° C., with a preferred range of 100≤T≤1000° C.

The heat block may provide a sufficient amount of heat to drive the reaction between the residual alkali-metal sulfide, phosphorous pentasulfide, and alkali-metal halide salt forming chalcogenide-based solid-state electrolyte.

Alternatively, the temperature of the single rotating conveyor belt may be controlled using a cold block positioned in the headspace above the side of the belt facing the at least three effusions or more accurately described as in between the rotating conveyor belt.

The cold block may provide a temperature in the range of −270≤T≤500° C., with a preferred range of −200≤T≤100° C.

The cold block may rapidly cool or quench the chalcogenide-based solid-state electrolyte to enhance crystal structure and further reduce particle size. It is presumed that the cold block is used when the percentage of residual alkali-metal sulfide, phosphorous pentasulfide, and/or alkali-metal halide salt is negligible.

A knife or blade may be used to scrape the chalcogenide-based solid-state electrolyte off the single rotating conveyor belt and into the at least one collection crucible at the bottom of the processing chamber.

The particle size of the chalcogenide-based solid-state electrolyte may be controlled in the plasma-assisted processing by 1) controlling the flux of the alkali-metal sulfide, 2) controlling the flux of the phosphorous pentasulfide, 3) controlling the flux of the alkali-metal halide salt, 4) adjusting the electric field strength between the cathode and anode, 5) enhancing quenching efficiency or rate of a cold block, or 6) a combination thereof.

The present description of the third embodiment relates to the post-processing and collection steps of the plasma-assisted vacuum processing approach for the manufacturing of chalcogenide-based solid-state electrolytes.

The plasma-assisted processing approach may be considered complete when 1) the alkali-metal sulfide is depleted in effusion cell EC-1V, 2) the phosphorous pentasulfide is depleted in effusion cell EC-2V, 3) the alkali-metal halide salt is depleted in effusion cell EC-3V, or 4) the desired amount of chalcogenide-based solid-state electrolyte has been collected in the at least one collection crucible.

The at least three effusion cells may be turned off, allowing them to cool, with the shutters orientated in the closed position. Chilled water or antifreeze may run through coolant lines in the at least three effusion cells enabling a more rapid cooling.

The heat block located between the single rotating conveyor belt may be turned off allowing it to cool. The heat block may also comprise of chilled water or antifreeze lines enabling a more rapid cooling.

The processing chamber may be backfilled with an inert gas to a pressure of 760 torr. An inert gas may include, for example, helium, nitrogen, or argon.

A latched door on top of the processing chamber may be unlatched and opened to remove the at least one collection crucible comprising the chalcogenide-based solid-state electrolyte material.

The chalcogenide-based solid-state electrolyte may be further processed to convert any residual alkali-metal sulfide, phosphorus pentasulfide, or alkali-metal halide salt into a chalcogenide-based solid-state electrolyte material. Further processing may include thermal annealing at a temperature in the range of 100≤T≤1000° C.

The at least three effusion cells may be removed from the processing chamber for cleaning. Alternatively, the at least three effusion cell crucibles may be removed, cleaned, and repacked for additional plasma-assisted processing.

The present disclosure relates to the fourth embodiment comprising a plasma-assisted halogen-gas processing approach for the manufacturing of chalcogenide-based solid-state electrolytes.

A plasma-assisted processing approach for the manufacturing of chalcogenide-based solid-state electrolyte materials may be a halogen gas processing approach.

A plasma-assisted processing approach for the manufacturing of chalcogenide-based materials may include a vacuum and halogen gas compatible processing chamber comprising at least three effusion cells, at least one plasma generation system comprising at least one cathode and one anode connected to an external power source, at least one rotating conveyor belt system, and at least one collection crucible.

The vacuum and halogen gas compatible processing chamber and all other components associated with the manufacturing of chalcogenide-based solid-state electrolyte materials using a plasma-assisted processing approach may be located in a dry room or an inert environment such as a glovebox.

A plasma-assisted processing approach for the manufacturing of chalcogenide-based solid-state electrolyte materials may include the following steps. It should be noted that the steps are guidelines for manufacturing chalcogenide-based solid-state electrolyte materials and are not met to limit the scope of the manufacturing process. The manufacturing process may include additional steps are sub-steps that are not listed but would be apparent to those skilled in the art.

The present description of the fourth embodiment relates to the preparation steps for the plasma-assisted gas processing approach for the manufacturing of chalcogenide-based solid-state electrolytes.

The at least three effusion cells (EC-1G, EC-2G, and EC-3G) may be loaded into the vacuum and halogen gas compatible processing chamber, wherein the vacuum-compatible processing chamber comprises at least three ports with mounting flanges designed to match mounting flanges on the at least three effusion cells to secure them under vacuum conditions. Vacuum grease may be applied to the mounting flanges to provide lubrication and further seal the port.

Alternatively, the at least three effusion cells may already be loaded into the vacuum-compatible processing, wherein the loading step can be omitted.

Effusion cell EC-1G may comprise a crucible that contains alkali-metal A, where A=Lithium (Li), Sodium (Na), Potassium (K), Cesium (Cs), Rubidium (Rb), or Francium (Fr). Preferably, A is Lithium (Li), Sodium (Na), or potassium (K). The alkali-metal may be in the form of powder, granules, or chunks. The alkali-metal may be packed into the crucible in an inert environment such as a glovebox. Alternatively, the alkali-metal sulfide may be packed into the crucible in a dry room with a moisture content below 1000 ppm.

The crucible containing the alkali-metal sulfide material may be loaded into effusion cell EC-1G after packing.

Effusion cell EC-2G may comprise a crucible that contains Y, where Y=Sulfur (S), Selenium (Se), or Tellurium (Te). Preferably, Y is elemental sulfur and EC-2G is a thermal cracker effusion cell. The elemental sulfur may be in the form of powder, granules, or chunks. The elemental sulfur may be packed into the crucible in an inert environment such as a glovebox. Alternatively, the elemental sulfur may be packed into the crucible in a dry room with a moisture content below 1000 ppm. In yet another alternative, the elemental sulfur may be packed into the crucible in ambient conditions.

The crucible containing the elemental sulfur may be loaded into effusion cell EC-2G after packing.

Effusion cell EC-3G may comprise a crucible that contains M_{y}^{m+}Yₘ^{y-}, where M=Boron (B³⁺), Gallium (Ga³⁺), Antimony (Sb³⁺), Silicon (Si⁴⁺), Germanium (Ge⁴⁺), Tin (Sn⁴⁺), Phosphorus (P⁵⁺), or Arsenic (As⁵⁺), Y^{y-}=Sulfur (S²⁻), Selenium (Se²⁻), or Tellurium (Te²⁻), and M_{y}^{m+}Yₘ^{y-} is in empirical form. Preferably, M_{y}^{m+}Yₘ^{y-} is phosphorus pentasulfide (P₂S₅). The phosphorous pentasulfide may be in the form of powder, granules, or chunks. The phosphorous pentasulfide may be packed into the crucible in an inert environment such as a glovebox. Alternatively, the phosphorous pentasulfide may be packed into the crucible in a dry room with a moisture content below 1000 ppm. In yet another alternative, the phosphorous pentasulfide may be packed into the crucible at ambient conditions.

The crucible containing the phosphorous pentasulfide may be loaded into effusion cell EC-3G after packing.

The present description of the fourth embodiment relates to the conditioning steps for the plasma-assisted gas processing approach for the manufacturing of chalcogenide-based solid-state electrolytes.

The vacuum and halogen gas compatible processing chamber may be evacuated to purge moisture, atmosphere, and other potential contaminants. The processing chamber may reach a vacuum level in the range of 10²p≤10⁻¹¹ torr, with a preferred range of 10⁰≤p≤10⁻⁷ torr.

During purging, the at least three effusion cells (EC-1G, EC-2G, and EC-3G) may be heated to a conditioning temperature in the range of 50≤T≤200° C. to remove any residual moisture within the alkali-metal, elemental sulfur, or phosphorous pentasulfide, or alkali-metal halide salt. It should also be noted that during purging, any shutters on the at least three effusion cells should preferably be in the open position.

Purge duration may be in the range of 1≤t≤500,000 seconds, with a preferred range of 30≤t≤50,000 seconds.

The processing chamber may comprise a multi-vacuum level system including, for example, a dry roughing pump, an oil-based roughing pump, and a turbo pump. For plasma-assisted processing, the processing chamber may further comprise one or more ion-getter pumps.

Following the purge, the vacuum and halogen gas compatible processing chamber may be backfilled with an inert gas such, for example, helium, nitrogen, or argon to a pressure in the range of 760≤p≤10⁻¹ torr. Inert gas purity may be in the range of 97≤p≤99.99999%.

The steps of purging followed by backfilling with inert gas may be repeated several times to reach the desired vacuum levels within the processing chamber.

After the final purging step, the processing chamber may have a vacuum level in the range of 10²≤p≤10⁻¹¹ torr, with a preferred range of 10⁰≤p≤10⁻⁷ torr.

The present description of the fourth embodiment relates to the processing steps of the plasma-assisted gas processing approach for the manufacturing of chalcogenide-based solid-state electrolytes.

A DC voltage may be applied across the at least one cathode and one anode to generate an electric field with a strength in the range of 0≤P≤100,000 kilovolts per meter (kV/m).

Alternatively, an AC voltage may be applied in certain situations or applications where an alternating voltage field is desired.

The at least three effusion cells may be heated to a temperature in the range of 100<T<2000° C. to begin the evaporation process.

Effusion cell EC-1G may be heated to a temperature in the preferred range of 200<T<1500° C. to evaporate an alkali-metal such as, for example, Lithium (Li), Sodium (Na), or Potassium (K).

Effusion cell EC-2G may be heated to a temperature in the preferred range of 100<T<900° C. to evaporate a chalcogen element, preferably elemental sulfur (S)

Effusion cell EC-3G may be heated to a temperature in the preferred range of 100<T<750° C. to evaporate phosphorous pentasulfide (P₂S₅).

The flux ratio between the evaporated materials and halogen gas may be used to govern or control the chemical formula of the chalcogenide-based solid-state electrolyte.

The flux ratio between the evaporated materials may be derived from equation EQ2:

$$( 24 - 2 m - 2 x ) A + ( 12 - m - 2 x ) Y + ( \frac{2}{y} ) {M}_{y}^{m +} {Y}_{m}^{y -} + ( x ) {X}_{2} = 2 ( {A}_{( 12 - m - x )} {M}^{m} {Y}_{( 6 - x )} {X}_{x} )$$

wherein the flux of A (EC-1G) may be derived from equation EQ_{D}: flux(A)=24−2m−2x; the flux of Y (EC-2G) may be derived from equation EQ_{E}: flux(Y)=12−m−2x; the flux of M_{y}^{m+}Yₘ^{y-} (EC-3G), or more preferably phosphorus pentasulfide (P₂S₅), may be derived from equation EQ_{F}: flux(P₂S₅)=2/y which may be kept constant at one, and the flux of the halogen gas (X₂) may be derived from equation EQ_{G}: flux(X₂)=x.

Therefore, the flux ratio (A:Y:P₂S₅:X₂) may be represented in equation EQ4:

$$24 - 2 m - 2 x : 12 - m - 2 x : 1 : x = {A}_{12 - m - 2 x} {PS}_{6 - 1} {X}_{x}$$

In an example, to manufacture a chalcogenide-based solid-state electrolyte with the general formula A_{6.5}PS_{5.5}X_{0.5}, a flux ratio of 13:6:1:0.5 (A:Y:P₂S₅:X₂) may be required; wherein the flux of the A may be thirteen times greater than the flux of P₂S₅, the flux of Y may be six times greater than the flux of P₂S₅, and the flux of the halogen gas (X₂) may be 0.5 times the flux of P₂S₅.

In another example, to manufacture a chalcogenide-based solid-state electrolyte with the general formula A₆PS₅X, a flux ratio of 12:5:1:1 (A:Y:P₂S₅:X₂) may be required; wherein the flux of the A may be twelve times greater than the flux of P₂S₅, the flux of Y may be five times greater than the flux of P₂S₅, and the flux of the halogen gas (X₂) may be equal to the flux of P₂S₅.

In yet another example, to manufacture a chalcogenide-based solid-state electrolyte with the general formula A_{5.5}PS_{4.5}X_{1.5}, a flux ratio of 11:4:1:1.5 (A:Y:P₂S₅:X₂) may be required; wherein the flux of the A may be eleven times greater than the flux of P₂S₅, the flux of Y may be four times greater than the flux of P₂S₅, and the flux of the halogen gas (X₂) may be 1.5 times the flux of P₂S₅.

It should be noted that the measured or actual value of the flux may depend on many parameters including the size of the chamber and the size of the effusion cells (as well as the number of effusion cells if greater than three) and therefore cannot be defined in the scope of the specification.

The flux may be controlled by adjusting the set temperature point of each of the at least three effusion cells thereby controlling the evaporation rate of gaseous alkali-metal, elemental sulfur, and phosphorus pentasulfide. The set temperature point may be controlled by controlling the amperage delivered to the effusion cell or the temperature of the chilled water circulating within the effusion cell if applicable.

The flux may be controlled by varying the temperature of one of the at least three effusion cells within a set range thereby controlling, but allowing for variation, the evaporation rate of gaseous alkali-metal, elemental sulfur, or phosphorus pentasulfide. The temperature range can be controlled within the set range by controlling the amperage delivered to the effusion cell or the temperature of the chilled water circulating within the effusion cell if applicable.

The flux may be controlled by varying the temperature of two of the at least three effusion cells within a set range thereby controlling, but allowing for variation, the evaporation rate of gaseous alkali-metal, elemental sulfur, or phosphorus pentasulfide. The temperature range can be controlled within the set range by controlling the amperage delivered to the effusion cell or the temperature of the chilled water circulating within the effusion cell if applicable.

The flux may be controlled by varying the temperature of all three effusion cells within a set range thereby controlling, but allowing for variation, the evaporation rate of gaseous alkali-metal, elemental sulfur, and phosphorus pentasulfide. The temperature range can be controlled within the set range by controlling the amperage delivered to the effusion cell or the temperature of the chilled water circulating within the effusion cell if applicable.

The flux of the halogen gas may be controlled using a mass flow control system or unit external of the processing chamber.

In yet another alternative, or combination with any of the aforementioned temperature control strategies, the flux may be controlled by opening and closing the shutter on top of the effusion cell at set durations or intervals.

The gaseous alkali-metal, elemental sulfur, phosphorus pentasulfide, and halogen gas may mix as they enter the generated electric field between the cathode and anode, wherein the gaseous mix may ionize resulting in the formation of a plasma plume.

In some instances, an inert gas may be introduced directly into the plasma plume to enhance ionization and chalcogenide-based solid-state electrolyte formation. An inert gas may include, for example, argon, nitrogen, helium, neon, krypton, xenon, etc.

The chalcogenide-based solid-state electrolyte may form inside the plasma plume and either deposit onto the single rotating conveyor belt above, fall to the at least one collection crucible below, or a combination of the two.

While the deposited layer is presumed to be entirely chalcogenide-based solid-state electrolyte (with the general formula: A₁₂₋ₘ₋ₓM^{m}Y₍₆₋ₓ₎Xₓ), there may still be some residual alkali-metal, elemental sulfur, and phosphorus pentasulfide in the deposited layer. The percentage of residual alkali-metal, elemental sulfur, and/or phosphorus pentasulfide in the layer is less than 99%, more preferably less than 50%, more preferably less than 25%, more preferably less than 10%, more preferably less than 1%, more preferably less than 0.5%, more preferably less than 0.25%, more preferably less than 0.1%, more preferably less than 0.05%, more preferably less than 0.01%, more preferably less than 0.001%.

The temperature of the single rotating conveyor belt may be controlled using a temperature-controlled block such as a heat block positioned in the headspace above the side of the belt facing the at least three effusion cells or more accurately described as in between the single rotating conveyor belt.

The heat block may provide a temperature in the range of 0≤T≤2000° C., with a preferred range of 100≤T≤1000° C.

The heat block may provide a sufficient amount of heat to drive the reaction between the residual alkali-metal, elemental sulfur, and phosphorus pentasulfide forming chalcogenide-based solid-state electrolyte.

Alternatively, the temperature of the single rotating conveyor belt may be controlled using a cold block positioned in the headspace above the side of the belt facing the at least three effusions or more accurately described as in between the rotating conveyor belt.

The cold block may provide a temperature in the range of −270≤T≤500° C., with a preferred range of −200≤T≤100° C.

The cold block may rapidly cool or quench the chalcogenide-based solid-state electrolyte to enhance crystal structure and further reduce particle size. It is presumed that the cold block is used when the percentage of residual alkali-metal, elemental sulfur, and/or phosphorus pentasulfide is negligible.

A knife or blade may be used to scrape the chalcogenide-based solid-state electrolyte off the single rotating conveyor belt and into the at least one collection crucible at the bottom of the processing chamber.

The particle size of the chalcogenide-based solid-state electrolyte may be controlled in the plasma-assisted processing by 1) controlling the flux of the alkali-metal, 2) controlling the flux of the elemental sulfur, 3) controlling the flux of the phosphorous pentasulfide, 4) controlling the flux of the halogen gas, 5) adjusting the electric field strength between the cathode and anode, 6) enhancing quenching efficiency or rate of a cold block, or 7) a combination thereof.

The present description of the fourth embodiment relates to the post-processing and collection steps of the gas-assisted vacuum processing approach for the manufacturing of chalcogenide-based solid-state electrolytes.

The plasma-assisted processing approach may be considered complete when 1) the alkali-metal is depleted in effusion cell EC-1G, 2) the elemental sulfur is depleted in effusion cell EC-2G, 3) the phosphorous pentasulfide is depleted in effusion cell EC-3G, or 4) the desired amount of chalcogenide-based solid-state electrolyte has been collected in the at least one collection crucible.

The at least three effusion cells may be turned off, allowing them to cool, with the shutters orientated in the closed position. Chilled water or antifreeze may run through coolant lines in the at least three effusion cells enabling a more rapid cooling.

The heat block located between the single rotating conveyor belt may be turned off allowing it to cool. The heat block may also comprise of chilled water or antifreeze lines enabling a more rapid cooling.

The processing chamber may be backfilled with an inert gas to a pressure of 760 torr. An inert gas may include, for example, helium, nitrogen, or argon.

A latched door on top of the processing chamber may be unlatched and opened to remove the at least one collection crucible comprising the chalcogenide-based solid-state electrolyte material.

The chalcogenide-based solid-state electrolyte may be further processed to convert any residual alkali-metal, elemental sulfur, or phosphorus pentasulfide into a chalcogenide-based solid-state electrolyte material. Further processing may include thermal annealing at a temperature in the range of 100≤T≤1000° C.

The at least three effusion cells may be removed from the processing chamber for cleaning. Alternatively, the at least three effusion cell crucibles may be removed, cleaned, and repacked for additional plasma-assisted processing.

The present disclosure relates to a processing chamber for the manufacturing of chalcogenide-based solid-state electrolytes.

A processing chamber for the heat-assisted manufacturing of chalcogenide-based solid-state electrolyte materials comprises a vacuum-compatible, or a vacuum and halogen gas compatible, chamber, at least three effusion cells, at least one rotating conveyor belt system comprising a single rotating conveyor belt, two or more pulley wheels, one or more temperature-control blocks, and one knife or blade, and at least one collection crucible.

A processing chamber for the plasma-assisted manufacturing of chalcogenide-based solid-state electrolyte materials comprises a vacuum-compatible, or a vacuum and halogen gas compatible, chamber, at least three effusion cells, at least one plasma generation system comprising at least one cathode, and one anode connected to an external power source, at least one rotating conveyor belt system comprising a single rotating conveyor belt, two or more pulley wheels, one or more temperature-control blocks, and one knife or blade, and at least one collection crucible.

The present description relates to the processing chamber used for manufacturing chalcogenide-based solid-state electrolytes.

A processing chamber used in the manufacturing of chalcogenide-based solid-state electrolyte materials using the vacuum approach of the first embodiment (heat-assisted that satisfies equation EQ1) may be vacuum-compatible and preferably comprised of stainless steel. Alternatively, the vacuum-compatible processing chamber may comprise any material that is thermally compatible with the at least three effusion cells, the at least one heat block used to control the temperature of the single rotating conveyor belt and is chemically compatible with evaporated alkali-metal sulfide, phosphorous pentasulfide, and alkali-metal halide salt.

A processing chamber used in the manufacturing of chalcogenide-based solid-state electrolyte materials using the halogen gas approach of the second embodiment (heat-assisted that satisfies equation EQ2) may be vacuum and halogen gas compatible and preferably comprised of stainless steel with an optional chemical resistive coating. Alternatively, the vacuum and halogen gas compatible processing chamber may comprise any material that is thermally compatible with the at least three effusion cells, the at least one heat block used to control the temperature of the single rotating conveyor belt and is chemically compatible with evaporated alkali-metal, elemental sulfur, phosphorous pentasulfide, and halogen gas.

A processing chamber used in the manufacturing of chalcogenide-based solid-state electrolyte materials using the vacuum approach of the third embodiment (plasma-assisted that satisfies equation EQ1) may be vacuum-compatible and preferably comprised of stainless steel. Alternatively, the vacuum-compatible processing chamber may comprise any material that is thermally compatible with the at least three effusion cells, the at least one heat block used to control the temperature of the single rotating conveyor belt, and the generated plasma plume, and is chemically compatible with evaporated alkali-metal sulfide, phosphorous pentasulfide, and alkali-metal halide salt.

A processing chamber used in the manufacturing of chalcogenide-based solid-state electrolyte materials using the halogen gas approach of the fourth embodiment (plasma-assisted that satisfies equation EQ2) may be vacuum and halogen gas compatible and preferably comprised of stainless steel with an optional chemical resistive coating. Alternatively, the vacuum and halogen gas compatible processing chamber may comprise any material that is thermally compatible with the at least three effusion cells, the at least one heat block used to control the temperature of the single rotating conveyor belt, and the generated plasma plume, and is chemically compatible with evaporated alkali-metal, elemental sulfur, phosphorous pentasulfide, and halogen gas.

While there are no limits to the size and shape of the processing chamber used in the manufacturing of chalcogenide-based solid-state electrolyte materials, whether heat-assisted or plasma-assisted, that would restrict the scope of the method, the processing chamber has a preferred volume in the range of 1≤V≤10,000 liters or 0.001≤V≤10 cubic meters.

While the description herein describes a system in the preferred volume range of 1≤V≤10,000 liters or 0.001≤V≤10 cubic meters, it should be noted that chambers may be sufficient enough in size to allow human entry and with an interior best described as the size of a standard room to a small or medium-sized building with volumes that far exceed, with no restrictive limits, great than 10 cubic meters.

The processing chamber described herein may be described as an upside-down bell-shaped chamber with a flat top and a curved bottom. Alternatively, the processing chamber may be more tubular with a flat top and a flat bottom.

The processing chamber described herein may have a latched door on top that opens to the exterior of the chamber to allow the removal of the processed and collected chalcogenide-based solid-state electrolyte.

The present description relates to an effusion cell used in the manufacturing of chalcogenide-based solid-state electrolytes.

A processing chamber may comprise at least three effusion cells used for the evaporation of 1) alkali-metal sulfide (EC-1V), phosphorus pentasulfide (EC-2V), and alkali-metal halide salt (EC-3V) or 2) alkali-metal (EC-1G), elemental sulfur (EC-2G), and phosphorous pentasulfide (EC-3G).

The at least three effusion cells may have a reservoir or heat sink, exterior of the processing chamber, serving as a passive heat exchanger that transfers the heat generated by the heating element to the outside air or a liquid coolant, where it is dissipated away from the cell, thereby allowing regulation of the effusion cells temperature.

The at least three effusion cells may have a filament port, exterior of the processing chamber, for delivering current to the heating elements inside the cell.

The at least three effusion cells may have a thermocouple port, exterior of the processing chamber, that allows a thermocouple to be inserted for monitoring cell temperature.

The at least three effusion cells may have a chilled water or antifreeze port, exterior of the processing chamber, that allows for cooling and temperature regulation.

The at least three effusion cells may have a mounting flange with a diameter in the range of 2≤D≤1000 cm, with a preferred range of 4≤D≤25 cm. The mounting flange should match the size of the mounting flange on the processing chamber. Alternatively, an adaptor may be used if the flange sizes are different.

The at least three effusion cells may have a tube comprising, for example, the heating elements, cooling lines, and ceramic crucibles.

The at least three effusion cells may comprise a ceramic crucible with a diameter in the range of 1≤D≤99 cm, with a preferred range of 2≤D≤30 cm. The ceramic crucible may comprise of, for example, alumina, silicon carbide, zirconia, graphite, magnesium oxide, etc.

The at least three effusion cells may comprise a ceramic crucible in the shape of an elliptical cone with a round bottom.

The at least three effusion cells may have a shutter on the open end to control the flux of the evaporated material. The shutter position may be controlled through a computer or automation.

The at least three effusion cells may operate in a temperature range of 100≤T≤2000° C.

The at least three effusion cells may have a directional orientation as follows. Briefly, the at least three effusion cells have an axis that runs along the center of the tube through the crucible and into the processing chamber. In a heat-assisted approach, this axis may have a point of intersection with the axis of the other effusion cells preferably at the surface of the single rotating conveyor belt. More specifically, the point of intersection may be at the center of the belt equal distance from the axis of both pulley wheels. Alternatively, the point of intersection may not be at the surface of the rotating conveyor belt and is closer to one of the pulley wheels than the other. In a plasma-assisted approach, the axis may have a point of intersection with the axis of the other effusion cells preferably at the center of the electric field between the at least one cathode and one anode or at the surface of the rotating conveyor belt. Alternatively, the point of intersection may not be at the center of the electric field and is closer to either the cathode or anode.

The present description relates to the at least one rotating conveyor belt system used in the manufacturing of chalcogenide-based solid-state electrolytes.

A processing chamber may comprise one or more rotating conveyor belt systems used to collect deposited 1) alkali-metal sulfide, phosphorus pentasulfide, and alkali-metal halide salt, or 2) alkali-metal, elemental sulfur, and phosphorous pentasulfide, in a heat-assisted processing approach for the manufacturing of chalcogenide-based solid-state electrolytes.

A processing chamber may comprise one or more rotating conveyor belt systems used to collect chalcogenide-based solid-state electrolytes and residual 1) alkali-metal sulfide, phosphorus pentasulfide, and alkali-metal halide salt, or 2) alkali-metal, elemental sulfur, and phosphorous pentasulfide, in a plasma-assisted processing approach for the manufacturing of chalcogenide-based solid-state electrolytes.

The one or more rotating conveyor belt systems may comprise a single rotating conveyor belt, two or more pulley wheels that govern the rotation of the belt, a temperature-controlled block between the single rotating conveyor belt, and a knife or blade to remove the chalcogenide-based solid-state electrolyte.

The following characteristics describe the single-rotating conveyor belt.

The single rotating conveyor belt may be comprised of, for example, polyester, polyethylene terephthalate (PET), polyetherimide (PEI), polyether ether ketone (PEEK), polytetrafluoroethylene (PTFE), polyphenylene sulfide, polyamide-imide (PAI), polysulfone (PSU), polydicyclopentadiene (pDCPD), polybenzimidazole (PBI), silicone, nitrile rubber (Buna-N), Teflon, Mylar, Vespel, Ultem, Torlon, etc.

Alternatively, the single rotating conveyor belt may be metallic with a high temperature resin or thin ceramic coating on top to protect against sulfur corrosion.

In yet another alternative, the single rotating conveyor belt may comprise any material or combination of materials flexible enough to withstand the forces applied by the two or more pulley wheels while thermally compatible with the processing temperatures within the processing chamber and chemically compatible with 1) alkali-metal sulfide, phosphorus pentasulfide, and alkali-metal halide salt, or 2) alkali-metal, elemental sulfur, phosphorous pentasulfide, and halogen gas, as well as any ionic species generated inside the plasma plume in the case of a plasma-assisted approach.

The single rotating conveyor belt may have two sides: Side A which faces the at least three effusion cells, and Side B which comes in physical contact with the two or more pulley wheels.

It is preferred that the surface of Side A be flat so that the deposited material layer can be removed with a knife or blade. Alternatively, Side A may not be flat, wherein any surface features are compatible with the knife or blade edge needed to remove the deposited material layer.

Side B may be flat or have features, such as grooves, that allow it to rotate with the two or more pulley wheels.

The following characteristics describes the two or more pulley wheels that govern the rotation of the single rotating conveyor belt.

The two or more pulley wheels may be comprised of stainless steel or stainless steel with a chemically resistive coating.

Alternatively, the two or more pulley wheels may comprise any material thermally compatible with the processing temperatures within the processing chamber and chemically compatible with 1) alkali-metal sulfide, phosphorus pentasulfide, and alkali-metal halide salt, or 2) alkali-metal, elemental sulfur, phosphorous pentasulfide, and halogen gas, as well as any ionic species generated inside the plasma plume in the case of a plasma-assisted approach.

Briefly, the single rotating conveyor belt rotates around two or more pulley wheels, preferably two, that govern and control the rotation rate of the belt. The two or more pulley wheels may be described as a sheave with grooves that keep the conveyor belt in place. Alternatively, the two or more pulley wheels may be described as a cylinder or roller that is designed to keep tension on the single rotating conveyor belt. In yet another alternative, the pulley wheels may have any design or features that allow for them to operate in the manufacturing process of chalcogenide-based solid-state electrolyte materials and therefore have no restrictions. Moreover, the two or more pulley wheels may have different features. A detailed discussion of the designs and features of which are beyond the scope of this disclosure.

The diameter of the two or more pulley wheels and the distance between the axis of the two or more pulley wheels may vary widely and are governed by the size of the processing chamber or system. Moreover, the diameter of the two or more pulley wheels may be the same or different. Therefore, there is no restriction on the size of the pulley wheels, the number of pulley wheels, or the distance between them. However, the diameter of the two or more pulley wheels and the distance between the two axes may govern the length of the single rotating conveyor belt and the rotation speed. Therefore, the two or more pulley wheels may rotate at a rotation per second rate (or rotation per minute rate) needed to reach a conveyor belt rate in the range of 0≤t≤1000 mm per second, with a preferred range of 0≤t≤10 mm per second.

The rotation of the two or more pulley wheels may be automated and controlled using a computer external to the processing system. The rotation of the conveyor belt may be constant or vary depending on the processing needs. Moreover, there may be interment stops in the rotation to allow the build-up of the materials layer on the surface.

The rotation of the two or more pulley wheels is preferably clockwise when looked at from the front of the processing chamber. However, the two or more pulley wheels may rotate counterclockwise depending on the setup of the processing chamber.

The following characteristics describes the one or more temperature-controlled blocks between the single rotating conveyor belt.

A rotating conveyor belt system comprises one or more temperature-controlled blocks between the single rotating conveyor belts. The one or more temperature-controlled blocks have two sides: Side 1 which faces up toward the top or latched door of the processing chamber and Side 2 which faces down toward the at least three effusion cells.

Side 2 of the temperature-controlled block is preferably in physical contact with Side B of the single rotating conveyor belt, wherein the temperature of the block is transferred to the conveyor belt through thermal conduction.

Alternatively, a temperature-controlled block may not be in physical contact with Side B of the single rotating conveyor belt, wherein the temperature of the block is transferred to the single rotating conveyor belt through radiation. In such an instance it is assumed that the temperature-controlled block and the single rotating conveyor belt are still in close proximity.

Side 1 of the temperature-controlled block may also be in Physical contact with Side B of the single rotating conveyor belt or in close proximity thereof.

A temperature-controlled block may be a heat block used to drive the reaction between 1) alkali-metal sulfide, phosphorus pentasulfide, and alkali-metal halide salt, or 2) alkali-metal, elemental sulfur, phosphorous pentasulfide, and halogen gas. A heat block may be used in both heat-assisted and plasma-assisted processing.

A heat block may have a temperature in the range of 0≤T≤2000° C., with a preferred range of 100≤T≤1000° C.

A heat block is preferably heated using resistive heating, wherein the current supplied to the block is controlled through a mechanism external to the processing chamber.

The temperature of a heat block may be constant and kept at a set point or vary within a range. When varied in a range it may oscillate at a constant rate or have different set points within the range.

A temperature-controlled block may be a cold block used to quench the chalcogenide-based solid-state electrolyte to enhance crystal structure and reduce particle size. It is anticipated that a cold block is primarily used in plasma-assisted processing to quench the less packed particles, with respect to the layer formed using heat-assisted processing, on the surface of the single rotating conveyor belt However, in some instances, a cold block may also be used in heat-assisted processing.

A cold block may have a temperature in the range of −270≤T≤500° C., with a preferred range of −200≤T≤100° C.

The temperature of the cold block may be controlled by, for example, chilled water, antifreeze, dry ice, liquid nitrogen, or a combination thereof.

The temperature of a cold block may be constant and kept at a set point or vary within a range. When varied in a range it may oscillate at a constant rate or have different set points within the range.

A processing chamber may comprise both a heat block and a cold block between the single rotating conveyor belt. In such an instance, it is anticipated that Side B of the single rotating conveyor belt will first come in contact with Side 2 of the heat block followed by Side 2 of the cold block.

Additional temperature-controlled blocks may also be positioned above the rotating conveyor belt, wherein Side 2 of the block comes into contact with Side A of the rotating conveyor belt for better or more constant temperature control.

The temperature of a temperature-controlled block may be governed by the temperature of the single rotating conveyor belt using a thermocouple and feedback loop. For example, the thermocouple may be in contact with Side A of the single rotating conveyor belt. The thermocouple and temperature-controlled block are controlled through the same computerized system external to the processing chamber. The system has a set temperature point the single rotating conveyor belt needs to reach to either drive the reaction of chalcogenide-based solid-state electrolyte or quench the chalcogenide-based solid-state electrolyte. The temperature of the block may be adjusted to reach the set temperature point.

The following characteristics describe the knife or blade used to remove the formed chalcogenide-based solid-state electrolyte on the surface of the single rotating conveyor belt.

The knife or blade may be positioned over one of the two or more pulley wheels and in physical contact with Side A of the single rotating conveyor belt to remove the chalcogenide-based solid-state electrolyte.

The pulley wheel in which the knife or blade is positioned over may have a larger diameter to enhance the removal of chalcogenide-based solid-state electrolyte.

The knife or blade may be composed of stainless steel and have a V or flat ground edge, a convex edge, an asymmetrical V or flat ground edge, a chisel or single bevel, etc.

Alternatively, the knife or blade may comprise any material or material combination with the mechanical properties sufficient to remove the chalcogenide-based solid-state electrolyte, thermally compatible with the processing temperatures within the processing chamber and chemically compatible 1) alkali-metal sulfide, phosphorus pentasulfide, and alkali-metal halide salt, or 2) alkali-metal, elemental sulfur, phosphorous pentasulfide, and halogen gas, and any ionic species generated inside the plasma plume in the case of a plasma-assisted approach.

The knife or blade may be connected to a computer-controlled or automated lever which allows it to detach or move away from the single rotating conveyor belt. In this instance, the knife or blade is moved away from the single rotating conveyor belt to allow the buildup of the chalcogenide-based solid-state electrolyte on the surface. When the buildup reaches a set thickness or a sufficient amount of time has passed, the knife or blade will be retracted and brought into contact with the single rotating conveyor belt.

The present description relates to the at least one collection crucible used in the manufacturing of chalcogenide-based solid-state electrolytes.

A processing chamber may comprise at least one collection crucible at the bottom of the processing chamber used to collect chalcogenide-based solid-state electrolyte materials as part of the manufacturing method.

It is preferred that the processing chamber comprises one large collection crucible at the bottom that can be transferred in and out of the system through the latched door on top. Moreover, it is assumed that the collection crucible is designed or customized to fit the curvature of the collection chamber to ensure the highest yield of collected chalcogenide-based solid-state electrolyte.

The collection crucible may have a rotation feature wherein it is connected to and supported by a gearbox positioned outside of the processing chamber. The rotation feature may enhance the collection of chalcogenide-based solid-state electrolyte.

The at least one collection crucible may be comprised entirely of, for example, alumina, silicon carbide, zirconia, graphite, magnesium oxide, etc.

For larger processing chambers, the collection crucible may comprise a stainless-steel bottom with a ceramic coating on top, wherein the stainless-steel bottom can be pulled out of the processing chamber through the latched door using an external pulley system. Alternatively, the collection crucible may comprise any metal that is chemically compatible with chalcogenide-based solid-state electrolyte and halogen gas.

The ceramic top may comprise, for example, alumina, silicon carbide, zirconia, graphite, magnesium oxide, etc.

The present description relates to the at least one plasma generation system in plasma-assisted processing.

A processing chamber may comprise at least one plasma generation system for plasma-assisted processing.

A plasma generation system may comprise at least one cathode, at least one anode, and a power source external to the processing chamber. The external power source may be connected to at least one cathode and one anode.

The distance between the at least one cathode and one anode may be in the range of 1≤D≤10,000 cm, with a preferred range of 5≤D≤1,000 cm.

The electric field generated between the at least one cathode and one anode may have a strength in the range of 0≤P≤100,000 kilovolts per meter (kV/m).

A plasma plume may be generated between the at least one cathode and one anode when an electric field is generated therebetween and 1) alkali-metal sulfide, phosphorus pentasulfide, and alkali-metal halide salt, or 2) alkali-metal, elemental sulfur, phosphorous pentasulfide in the gaseous phase (as well as halogen gas) are present.

Preferably, a DC voltage may be applied across the at least one cathode and one anode. Alternatively, an AC voltage may be applied in certain situations or applications where an alternating voltage field is desired.

The at least one cathode and one anode may be positioned between Side A of the single rotating conveyor belt and the collection crucible.

The present disclosure relates to a solid-state battery comprising a chalcogenide-based solid-state electrolyte.

A solid-state battery may comprise a cathode and chalcogenide-based solid-state electrolyte membrane.

A cathode may comprise a chalcogenide-based solid-state electrolyte serving as a catholyte forming what is commonly referred to in the art as a composite cathode.

Composite cathode may further comprise a cathode active material (CAM) including, for example, layered YMO₂, Y-rich layered Y₁₊ₓM₁₋ₓO₂, spinel YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K, Mg, Zn, Al, etc.), vanadium oxides, sulfur, lithium sulfide, iron sulfide, FeF₃, LiSe.

In the case of a lithium intercalation, a CAM may include, for example, lithium iron phosphate (LiFePO₄), lithium cobalt oxide (LiCoO₂), lithium manganese oxide (LiMn₂O₄), and lithium nickel oxide (LiNiO₂), lithium nickel cobalt manganese oxide (LiNiₓCo_{y}Mn_{z}O₂, 0.95≥x≥0.5, 0.3≥y≥0.025, 0.2≥z≥0.025), lithium nickel cobalt aluminum oxide (LiNiₓCo_{y}Al_{z}O₂, 0.95≥x≥0.5, 0.3≥y≥0.025, 0.2≥z≥0.025), lithium nickel manganese spinel (LiNi_{0.5}Mn_{1.5}O₄), etc.

A CAM may be single crystal, polycrystalline, or amorphous.

A CAM may be coated with a protected layer to enhance chemical stability with a chalcogenide-based solid-state electrolyte membrane and chalcogenide-based catholyte.

Protective coatings may include, for example, carbon, lithium niobate (LiNbO₃), lithium borate (Li₂B₄O₇), lithium zirconate (Li₂ZrO₃), lithium titanate (Li₄Ti₅O₁₂), aluminum oxide (Al₂O₃), etc.

A composite cathode may further comprise an inactive binder such as, for example, polyvinylidene fluoride, polyacrylic acid, lotader, carboxymethyl cellulose, styrene-butadiene rubber, sodium alginate, etc.

A composite cathode may further comprise an electronically conductive additive such as, for example, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc. Alternatively, a composite cathode may include metal binding materials that serves as an electronically conductive. Metal binding material may be in the form of, for example, wires, fibers, nanofibers, nanowires, nanorods, microfibers, etc.

A composite cathode may have a thickness in the range of 0.01<T<1000 μm, with a preferred range of 10<T<500 μm.

A composite cathode may be formed onto a positive current collector. A positive current collector may include, for example, aluminum foil, carbon coated aluminum foil, titanium foil, nickel foil, etc.

A chalcogenide-based solid-state electrolyte membrane may include a binding polymer forming what is referred to in the art as a ceramic-polymer composite solid-state electrolyte membrane. A binding polymer may include, for example, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK).

A chalcogenide-based solid-state electrolyte membrane may further include an ionic conducting salt such as, for example, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

A chalcogenide-based solid-state electrolyte membrane may have a thickness in the range of 0.01<T<1000 μm, with a preferred range of 1<T<100 μm.

A solid-state battery may further comprise of an anode which is physically separated from the cathode by the chalcogenide-based solid-state electrolyte membrane.

An anode may comprise a chalcogenide-based solid-state electrolyte serving as an anolyte forming what is commonly referred to in the art as a composite anode.

A composite anode may further comprise an active anode material including, for example, titanium oxide, silicon, tin oxide, germanium, antimony, silicon oxide, iron oxide, cobalt oxide, ruthenium oxide, molybdenum oxide, molybdenum sulfide, chromium oxide, nickel oxide, manganese oxide, alkali-metal, carbon-based materials (hard carbons, soft carbons, graphene, graphite's, carbon nanofibers, carbon nanotubes, etc.).

A composite anode may further comprise an inactive binder such as, for example, polyvinylidene fluoride, polyacrylic acid, lotader, carboxymethyl cellulose, styrene-butadiene rubber, sodium alginate, etc.

A composite anode may further comprise an electronically conductive additive such as, for example, graphene, reduced graphene oxide, carbon nanotubes, carbon black, Super P, acetylene black, carbon nanofibers or a conductive polymer such as polyaniline, polypyrrole, poly(3,4-ethylenedioxythiophene (PEDOT), polyphenylene vinylene etc. Alternatively, a composite anode may include metal binding materials that serves as an electronically conductive.

Metal binding material may be in the form of, for example, wires, fibers, nanofibers, nanowires, nanorods, microfibers, etc.

A composite anode may have a thickness in the range of 0.01<T<1000 μm, with a preferred range of 10<T<500 μm.

A composite anode may be formed onto a negative current collector. A negative current collector may include, for example, copper foil, stainless steel, titanium foil, nickel foil, etc.

Alternatively, an anode may include an alkali-metal film such as, for example, lithium metal, sodium metal, or potassium metal coated onto a negative current collector. A negative current collector may include, for example, copper foil, stainless steel, titanium foil, nickel foil, etc. An alkali-metal film may have a thicknesses in the range of 1<T<1000 μm, with a preferred range of 5<T<100 μm.

In yet another alternative, a solid-state battery may not comprise an anode in what is commonly referred to in the art as a solid-state anodeless battery.

The drawings of the present disclosure further describe the method for chalcogenide-based solid-state electrolyte production and a solid-state battery comprising the chalcogenide-based solid-state electrolyte thereof.

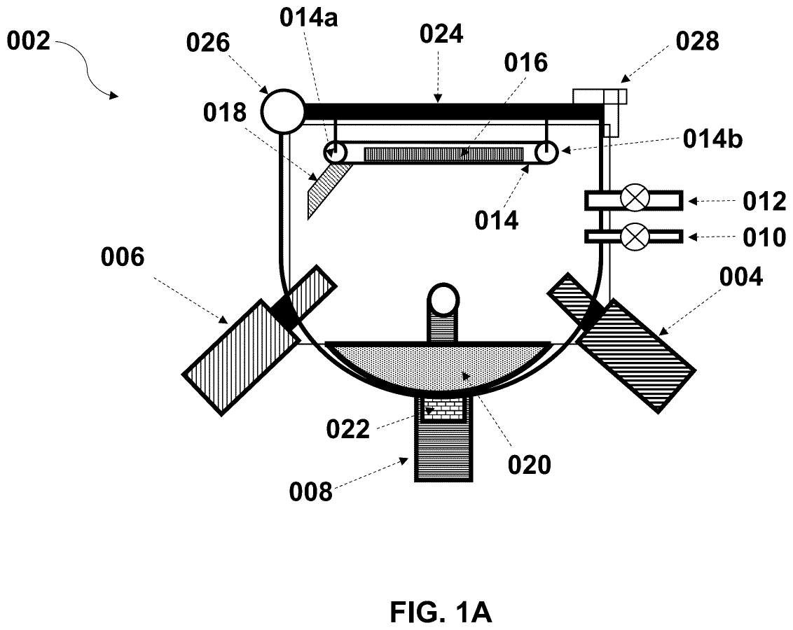

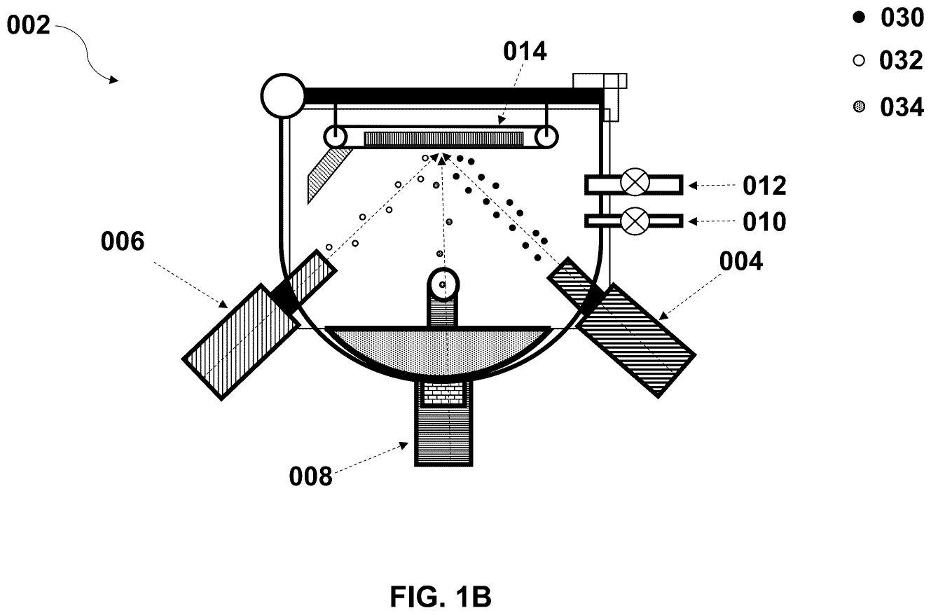

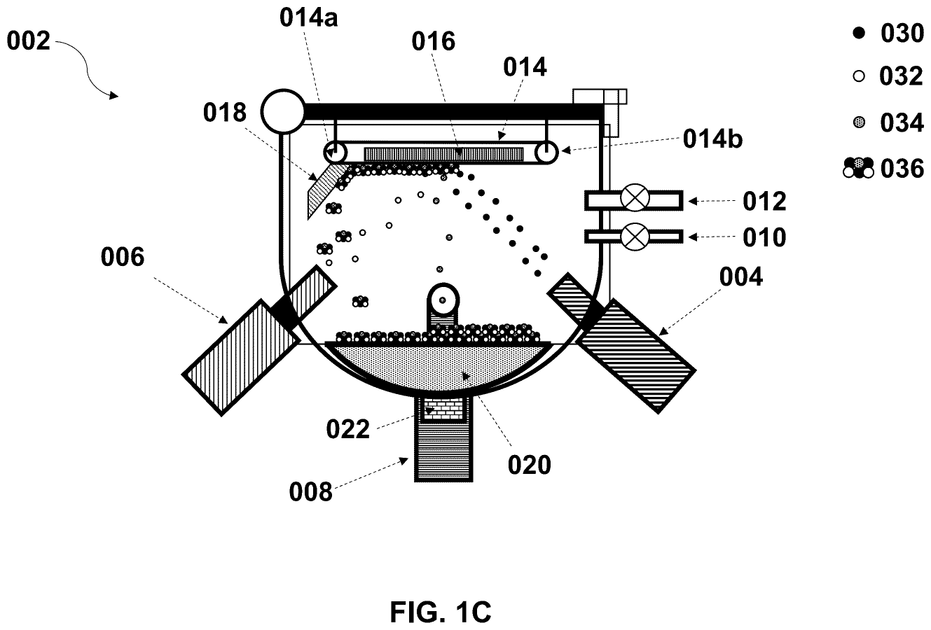

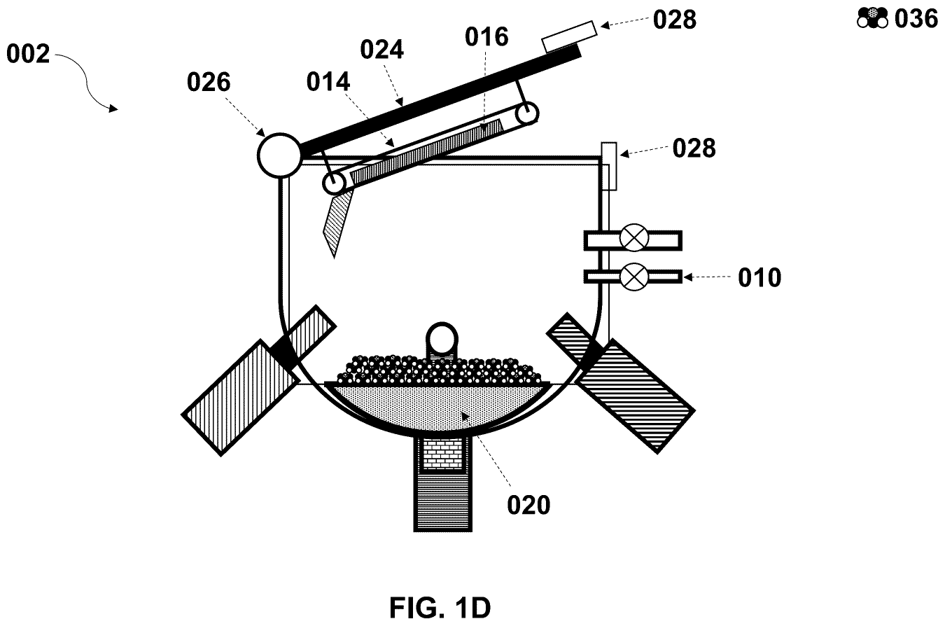

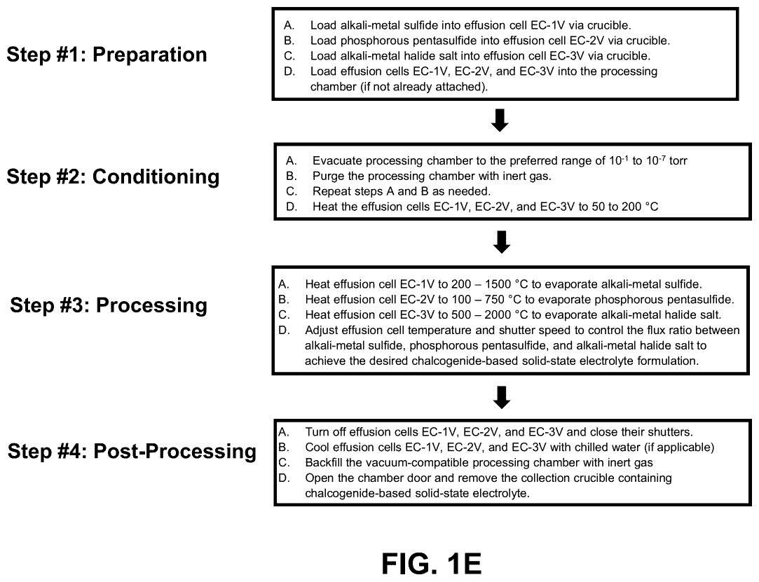

FIGS. 1A-1E relate to the manufacturing of chalcogenide-based solid-state electrolytes described in the first embodiment. The manufacturing process includes a heat-assisted vacuum processing approach that satisfies equation EQ1.

FIG. 1A: A schematic illustration of the processing chamber for heat-assisted manufacturing of chalcogenide-based solid-state electrolytes. The heat-assisted approach comprises an upside-down bell-shaped vacuum-compatible processing chamber (002) further comprising effusion cell EC-1V (004) for the evaporation of alkali-metal sulfide, effusion cell EC-2V (006) for the evaporation of phosphorous pentasulfide, effusion cell EC-3V (008) for the evaporation of alkali-metal halide salt, an inert gas inlet (010) for chamber purging, a vacuum inlet (012) for chamber evacuation, a single rotating conveyor belt (014), controlled by two pulley wheels (014a and 014b) to collect the evaporated alkali-metal sulfide, phosphorous pentasulfide, and alkali-metal halide salt, a heat block between the rotating conveyor belt (016) to activate and drive the formation of chalcogenide-based solid-state electrolytes using the deposited alkali-metal sulfide, phosphorous pentasulfide, and alkali-metal halide salt, a knife/blade (018) to remove the formed chalcogenide-based solid-state electrolyte from the single rotating conveyor belt (016), and a collection crucible (020) connected to a rotating gearbox (022) located at the bottom of the processing chamber to collect the chalcogenide-based solid-state electrolyte. The illustration further comprises a chamber door on top (024), along with a latch (026) and hinge (028), to remove the chalcogenide-based solid-state electrolyte.

FIG. 1B: A schematic illustration of the heat-assisted vacuum processing approach during the manufacturing of chalcogenide-based solid-state electrolytes. The heat-assisted approach comprises a vacuum-compatible processing chamber (002) further comprising an inert gas (010) and vacuum (012) inlet for chamber purging and evacuation to remove moisture, oxygen, and other potential contaminants prior to the manufacturing of chalcogenide-based solid-state electrolytes. The vacuum-compatible processing chamber (002) further comprises effusion cell EC-1V (004) for the evaporation of alkali-metal sulfide (030), effusion cell EC-2V (006) for the evaporation of phosphorous pentasulfide (032), effusion cell EC-3V (008) for the evaporation of alkali-metal halide salt (034). The schematic further illustrates the orientation of, and point of intersection between, effusion cells EC-1V (004), EC-2V (006), and EC-3V (008) in relation to the single rotating conveyor belt (014) (gray arrows), as well as provides a visual representation of the flux ratio between the evaporated alkali-metal sulfide (030), phosphorous pentasulfide (032), and alkali-metal halide salt (034).

FIG. 1C: A schematic illustration of the heat-assisted vacuum processing approach during the manufacturing of chalcogenide-based solid-state electrolytes. The heat-assisted approach comprises a vacuum-compatible processing chamber (002) further comprising effusion cell EC-1V (004) for the evaporation of alkali-metal sulfide (030), effusion cell EC-2V (006) for the evaporation of phosphorous pentasulfide (032), effusion cell EC-3V (008) for the evaporation of alkali-metal halide salt (034), a single rotating conveyor belt (014) for the collection of the alkali-metal sulfide (030), phosphorous pentasulfide (032), and alkali-metal halide salt (034). A heat block (016), between the single rotating conveyor belt (014), is used to activate the formation of chalcogenide-based solid-state electrolyte (036) by thermally treating the deposited alkali-metal sulfide (030), phosphorous pentasulfide (032), and alkali-metal halide salt (034). The formed chalcogenide-based solid-state electrolyte (036) is removed from the single rotating conveyor belt (014) using a knife or blade (018). The rotating conveyor belt (014) is in physical contact with the knife or blade (018), wherein the belt is rotated over the edge of the knife or blade (018) to remove the chalcogenide-based solid-state electrolyte (036), wherein the rotation of the belt is controlled by the two pulley wheels (014a and 014b) shown in the illustration. The chalcogenide-based solid-state electrolyte is collected in the collection crucible (020) at the bottom of the processing chamber (002). The collection crucible may rotate, controlled by the gearbox (022) outside the processing chamber (002), to fully utilize the entire crucible volume.

FIG. 1D: A schematic illustration of the heat-assisted vacuum processing approach after the manufacturing of chalcogen-based solid-state electrolytes has concluded. The heat-assisted approach comprises a vacuum-compatible processing chamber (002) further comprising an inert gas inlet (010) to backfill the chamber and bring it to atmospheric pressure. The processing chamber (002) further comprises a chamber door on top (024) that unlatches from the chamber (via latch 028) and opens to the external environment (via hinge 026). The external environment is preferably a dry room with a moisture content below 1000 ppm or an inert atmosphere in a glovebox. The schematic further illustrates that the single rotating conveyor belt (014) and heat block (016) are attached to the chamber door (024), the specific details of which with regards to how they are attached are beyond the scope of this disclosure. The collection crucible (020) containing the chalcogenide-based solid-state electrolyte (036) may be removed from the processing chamber (002) out through the top.

FIG. 1E: A flowchart for the heat-assisted vacuum processing of chalcogenide-based solid-state electrolyte production comprising four overarching steps: Preparation (Step #1), Conditioning (Step #2), Processing (Step #3), and Post-Processing (Step #4). Each step contains one or more sub-steps outlined below.

Preparation (Step #1) comprises four sub-steps including loading alkali-metal sulfide into effusion cell EC-1V via crucible (1A), loading phosphorous pentasulfide into effusion cell EC-2V via crucible (1B), loading alkali-metal halide salt into effusion cell EC-3V (1C) via crucible, and loading effusion cells EC-1V, EC-2V, and EC-3V into the processing chamber and sealing (1D). Note that 1D may not be needed if the effusion cells are already loaded onto the processing chamber and sealed.

Conditioning (Step #2) comprises three sub-steps including evacuating the processing chamber to the preferred vacuum range of 10⁻¹ to 10⁻⁷ torr (2A), purging or backfilling the processing chamber with an inert gas (2B), and heating effusion cells EC-1V, EC-2V, and EC-3V to a temperature in the range of 50≤T≤200° C. to remove potential contamination (2C). Note that 2A and 2B may be repeated through multiple iterations to achieve the desired processing conditions.

Processing (Step #3) comprises four sub-steps including heating effusion cell EC-1V to a temperature in the range of 200≤T≤1500° C. to evaporate alkali-metal sulfide (3A), heating effusion cell EC-2V to a temperature in the range of 100≤T≤750° C. to evaporate phosphorous pentasulfide (3B), heating effusion cell EC-3V to a temperature in the range of 500≤T≤2000° C. to evaporate alkali-metal halide salt (3C), and adjusting effusion cell temperature and shutter speed to control the flux ratio between alkali-metal sulfide, phosphorous pentasulfide, and alkali-metal halide salt to achieve the desired chalcogenide-based solid-state electrolyte formulation (3D).

Post-Processing (Step #4) comprises four sub-steps including turning off effusion cells EC-1V, EC-2V, and EC-3V and closing their shutters to terminate the evaporation process (4A), cooling effusion cells EC-1V, EC-2V, and EC-3V with chilled water or antifreeze (4B), backfilling the processing chamber with inter gas to bring to atmospheric pressure (4C), and opening the chamber door to remove the collection crucible (4D).

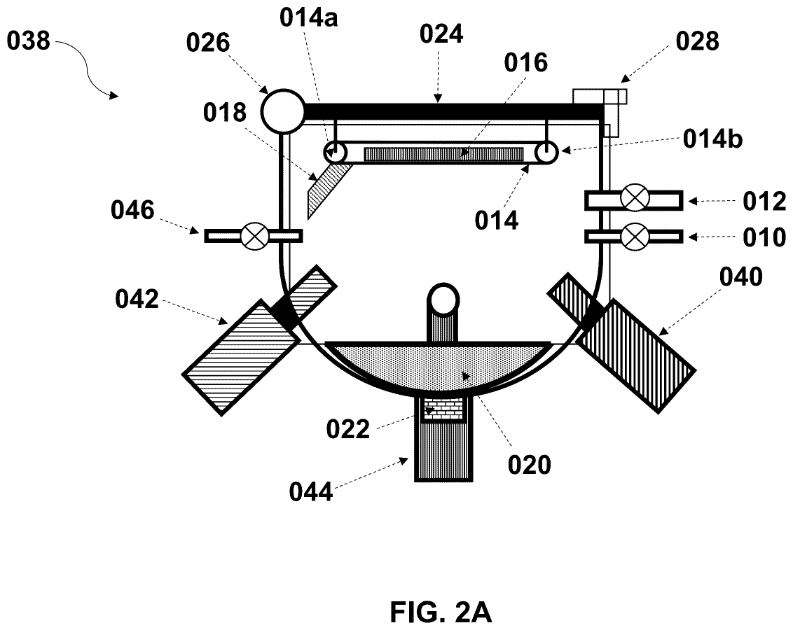

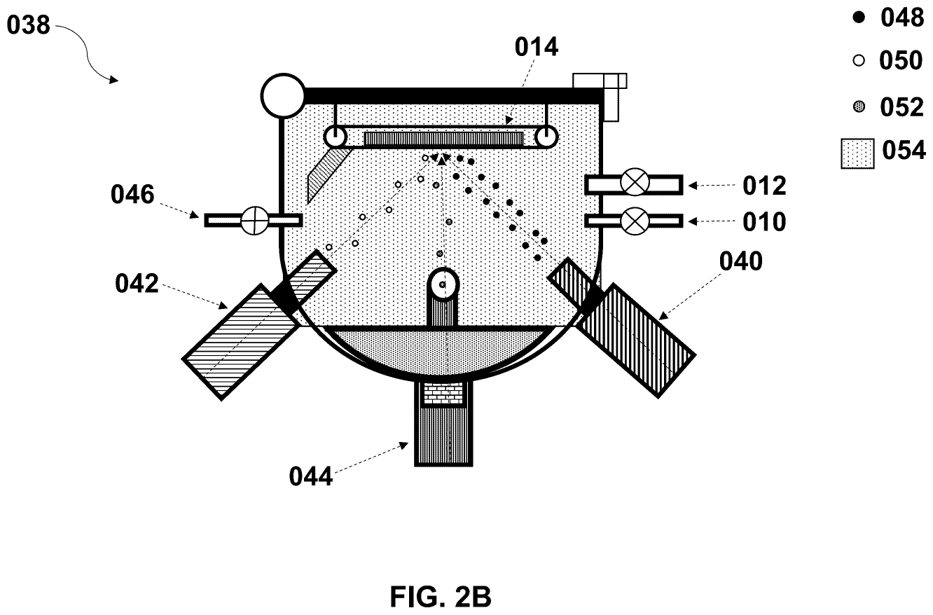

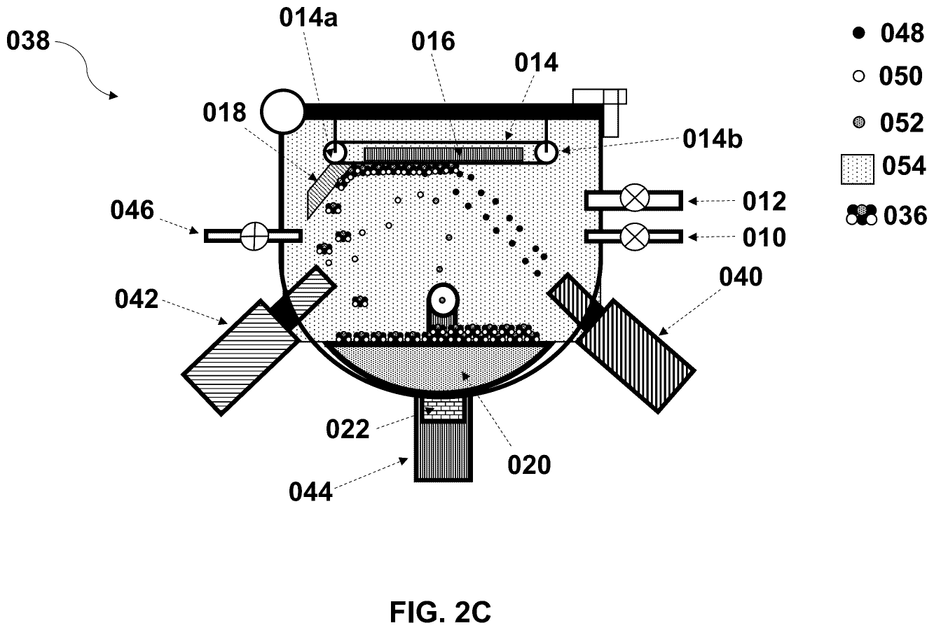

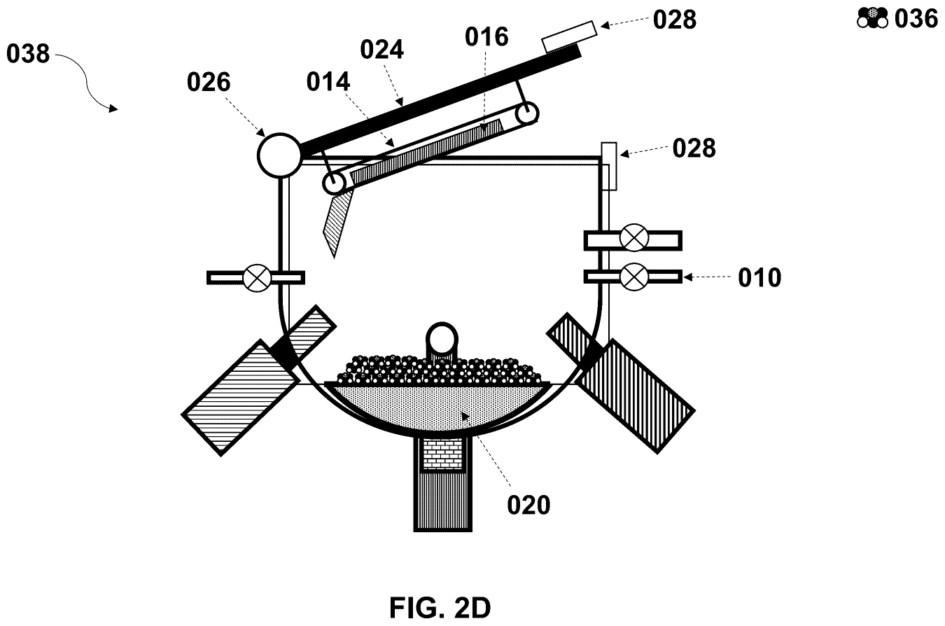

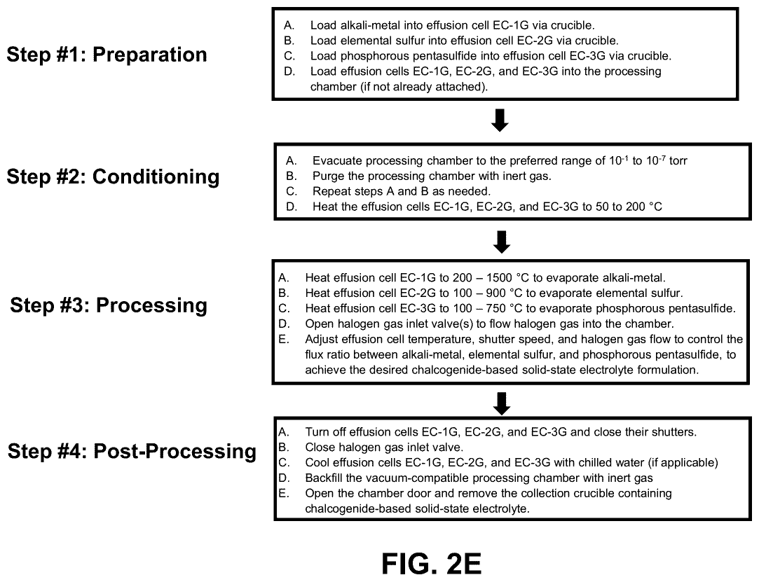

FIGS. 2A-2E relate to the manufacturing of chalcogenide-based solid-state electrolytes described in the second embodiment. The manufacturing process includes a heat-assisted halogen gas processing approach that satisfies equation EQ2.

FIG. 2A: A schematic illustration of the processing chamber for heat-assisted manufacturing of chalcogenide-based solid-state electrolytes. The heat-assisted approach comprises an upside-down bell-shaped vacuum and halogen gas compatible processing chamber (038) further comprising effusion cell EC-1G (040) for the evaporation of alkali-metal, effusion cell EC-2G (042) for the evaporation of elemental sulfur, effusion cell EC-3G (044) for the evaporation of phosphorous pentasulfide, a halogen-gas inlet (046), an inert gas inlet (010) for chamber purging, a vacuum inlet (012) for chamber evacuation, a single rotating conveyor belt (014), controlled by two pulley wheels (014a and 014b) to collect the evaporated alkali-metal, elemental sulfur, and phosphorous pentasulfide, a heat block between the rotating conveyor belt (016) to activate and drive the formation of chalcogenide-based solid-state electrolytes using the deposited alkali-metal, elemental sulfur, phosphorous pentasulfide, and halogen gas, a knife/blade (018) to remove the formed chalcogenide-based solid-state electrolyte from the single rotating conveyor belt (016), and a collection crucible (020) connected to a rotating gearbox (022) located at the bottom of the processing chamber to collect the chalcogenide-based solid-state electrolyte. The illustration further comprises a chamber door on top (024), along with a latch (026) and hinge (028), to remove the chalcogenide-based solid-state electrolyte.

FIG. 2B: A schematic illustration of the heat-assisted halogen gas processing approach during the manufacturing of chalcogenide-based solid-state electrolytes. The heat-assisted approach comprises a vacuum and halogen gas compatible processing chamber (038) further comprising a halogen gas inlet (046), an inert gas (010) and vacuum (012) inlet for chamber purging and evacuation to remove moisture, oxygen, and other potential contaminants prior to the manufacturing of chalcogenide-based solid-state electrolytes. The vacuum and halogen gas compatible processing chamber (038) further comprises effusion cell EC-1G (040) for the evaporation of alkali-metal (048), effusion cell EC-2G (042) for the evaporation of elemental sulfur (050), effusion cell EC-3G (044) for the evaporation of phosphorous pentasulfide (052), and halogen gas (054). The schematic further illustrates the orientation of, and point of intersection between, effusion cells EC-1G (040), EC-2G (042), and EC-3G (044) in relation to the single rotating conveyor belt (014) (gray arrows), as well as provides a visual representation of the flux ratio between the evaporated alkali-metal (048), elemental sulfur (050), and phosphorous pentasulfide (052).

FIG. 2C: A schematic illustration of the heat-assisted halogen gas processing approach during the manufacturing of chalcogenide-based solid-state electrolytes. The heat-assisted approach comprises a vacuum and halogen gas compatible processing chamber (038) further comprising effusion cell EC-1G (040) for the evaporation of alkali-metal (048), effusion cell EC-2G (042) for the evaporation of elemental sulfur (050), effusion cell EC-3G (044) for the evaporation of phosphorous pentasulfide (052), a halogen gas inlet (046), a single rotating conveyor belt (014) for the collection of the alkali-metal (048), elemental sulfur (050), and phosphorous pentasulfide (052). A heat block (016), between the single rotating conveyor belt (014), is used to activate the formation of chalcogenide-based solid-state electrolyte (036) by thermally treating the deposited alkali-metal (048), elemental sulfur (050), phosphorous pentasulfide (052), and halogen gas (054). The formed chalcogenide-based solid-state electrolyte (036) is removed from the single rotating conveyor belt (014) using a knife or blade (018). The rotating conveyor belt (014) is in physical contact with the knife or blade (018), wherein the belt is rotated over the edge of the knife or blade (018) to remove the chalcogenide-based solid-state electrolyte (036), wherein the rotation of the belt is controlled by the two pulley wheels (014a and 014b) shown in the illustration. The chalcogenide-based solid-state electrolyte is collected in the collection crucible (020) at the bottom of the processing chamber (002). The collection crucible may rotate, controlled by the gearbox (022) outside the processing chamber (002), to fully utilize the entire crucible volume.

FIG. 2D: A schematic illustration of the heat-assisted halogen gas processing approach after the manufacturing of chalcogen-based solid-state electrolytes has concluded. The heat-assisted approach comprises a vacuum and halogen gas-compatible processing chamber (038) further comprising an inert gas inlet (010) to backfill the chamber and bring it to atmospheric pressure. The processing chamber (002) further comprises a chamber door on top (024) that unlatches from the chamber (via latch 028) and opens to the external environment (via hinge 026). The external environment is preferably a dry room with a moisture content below 1000 ppm or an inert atmosphere in a glovebox. The schematic further illustrates that the single rotating conveyor belt (014) and heat block (016) are attached to the chamber door (024), the specific details of which with regards to how they are attached are beyond the scope of this disclosure. The collection crucible (020) containing the chalcogenide-based solid-state electrolyte (036) may be removed from the processing chamber (002) out through the top.

FIG. 2E: A flowchart for the heat-assisted halogen gas processing of chalcogenide-based solid-state electrolyte production comprising four overarching steps: Preparation (Step #1), Conditioning (Step #2), Processing (Step #3), and Post-Processing (Step #4). Each step contains one or more sub-steps outlined below.

Preparation (Step #1) comprises four sub-steps including loading alkali-metal into effusion cell EC-1G via crucible (1A), loading elemental sulfur into effusion cell EC-2G via crucible (1B), loading phosphorous pentasulfide into effusion cell EC-3G (1C) via crucible, and loading effusion cells EC-1G, EC-2G, and EC-3G into the processing chamber and sealing (1D). Note that 1D may not be needed if the effusion cells are already loaded onto the processing chamber and sealed.

Conditioning (Step #2) comprises three sub-steps including evacuating the processing chamber to the preferred vacuum range of 10⁻¹ to 10⁻⁷ torr (2A), purging or backfilling the processing chamber with an inert gas (2B), and heating effusion cells EC-1G, EC-2G, and EC-3G to a temperature in the range of 50≤T≤200° C. to remove potential contamination (2C). Note that 2A and 2B may be repeated through multiple iterations to achieve the desired processing conditions.

Processing (Step #3) comprises five sub-steps including heating effusion cell EC-1G to a temperature in the range of 200≤T≤1500° C. to evaporate alkali-metal (3A), heating effusion cell EC-2G to a temperature in the range of 100≤T≤900° C. to evaporate elemental sulfur (3B), heating effusion cell EC-3G to a temperature in the range of 100≤T≤750° C. to evaporate phosphorous pentasulfide (3C), opening the halogen gas inlet valve to flow halogen gas into the processing chamber (3D), and adjusting effusion cell temperature and shutter speed to control the flux ratio between alkali-metal, elemental sulfur, phosphorous pentasulfide, and halogen gas to achieve the desired chalcogenide-based solid-state electrolyte formulation (3E).

Post-Processing (Step #4) comprises five sub-steps including turning off effusion cells EC-1G, EC-2G, and EC-3G and closing their shutters to terminate the evaporation process (4A), closing the halogen gas inlet valve to shut off halogen gas flow (4B), cooling effusion cells EC-1G, EC-2G, and EC-3G with chilled water or antifreeze (4C), backfilling the processing chamber with inter gas to bring to atmospheric pressure (4D), and opening the chamber door to remove the collection crucible (4E).

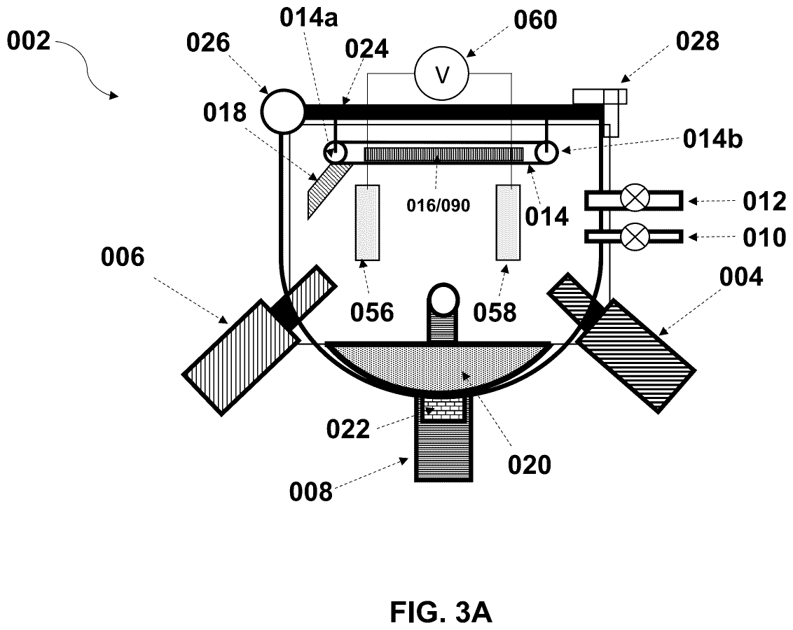

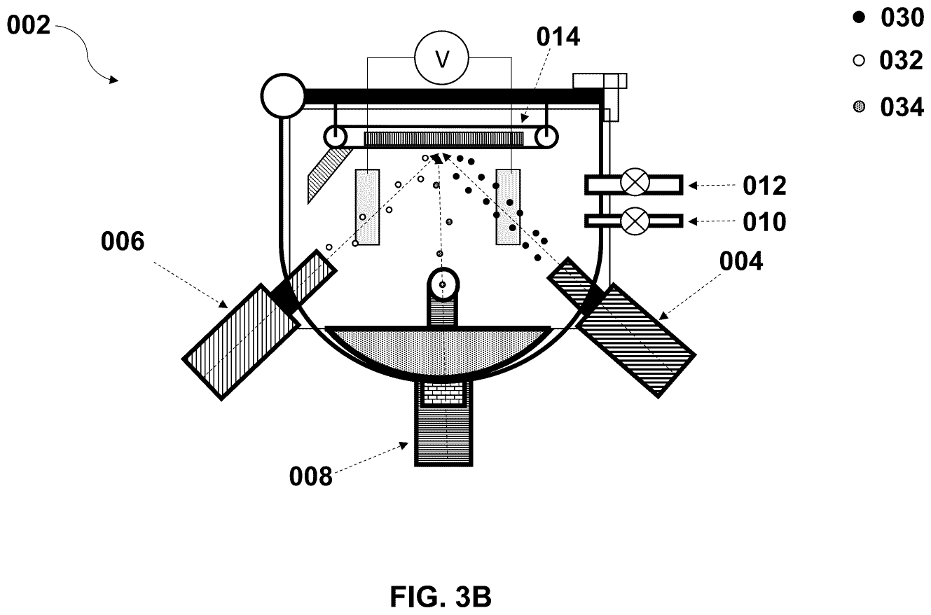

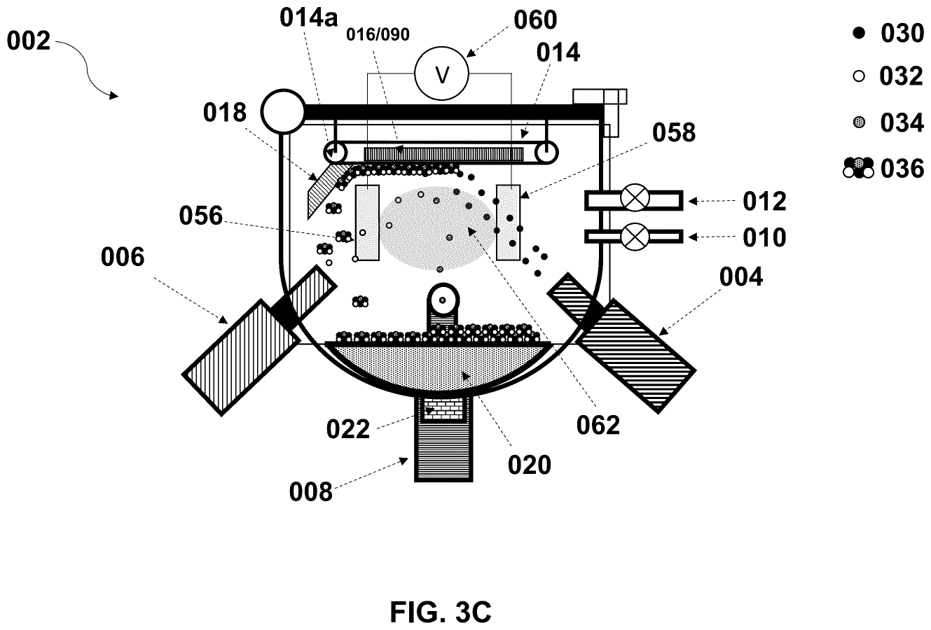

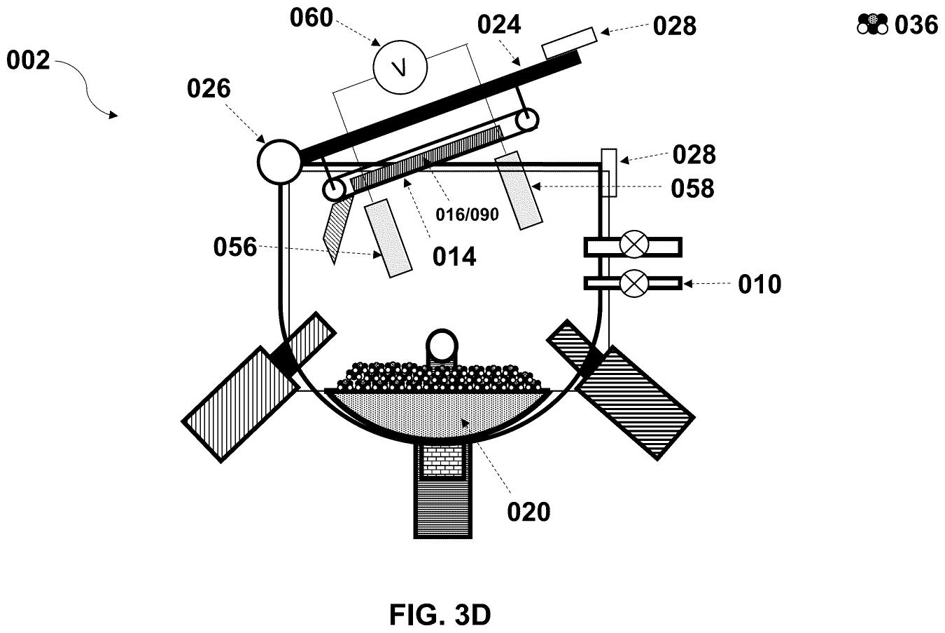

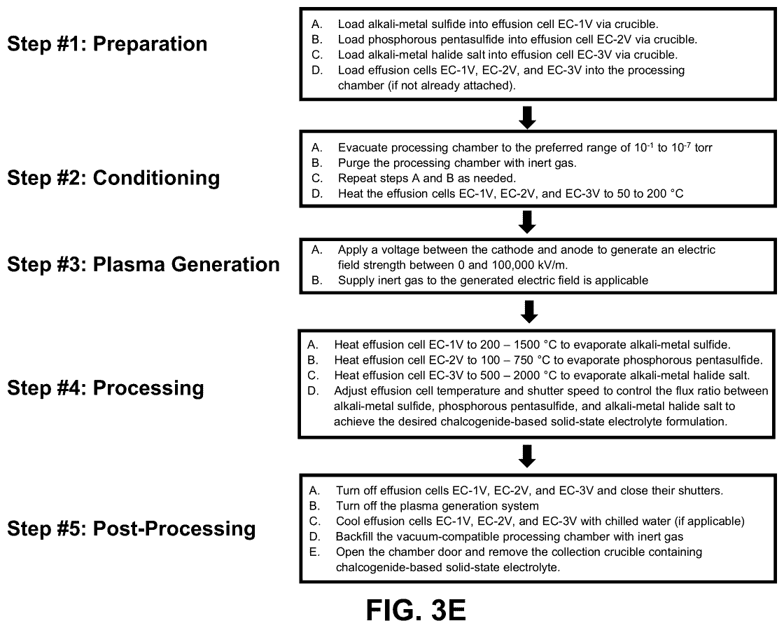

FIGS. 3A-3E relate to the manufacturing of chalcogenide-based solid-state electrolytes described in the third embodiment. The manufacturing process includes a plasma-assisted approach that satisfies equation EQ1.

FIG. 3A: A schematic illustration of the processing chamber for plasma-assisted manufacturing of chalcogenide-based solid-state electrolytes. The plasma-assisted approach comprises an upside-down bell-shaped vacuum-compatible processing chamber (002) further comprising effusion cell EC-1V (004) for the evaporation of alkali-metal sulfide, effusion cell EC-2V (006) for the evaporation of phosphorous pentasulfide, effusion cell EC-3V (008) for the evaporation of alkali-metal halide salt, an inert gas inlet (010) for chamber purging, a vacuum inlet (012) for chamber evacuation, a cathode (058) and anode (056) connected to a voltage source (060) for electric field generation, a single rotating conveyor belt (014), controlled by two pulley wheels (014a and 014b) to collect the chalcogenide-based solid-state electrolytes, a heat (016) or cold (090) block between the rotating conveyor belt to further activate and drive the formation of chalcogenide-based solid-state electrolytes from any residual alkali-metal sulfide, phosphorous pentasulfide, and/or alkali-metal halide salt, or quench the formed chalcogenide-based solid-state electrolyte, a knife or blade (018) to remove the formed chalcogenide-based solid-state electrolyte from the single rotating conveyor belt (014), and a collection crucible (020) connected to a rotating gear box (022) located at the bottom of the processing chamber to collect the chalcogenide-based solid-state electrolyte. The illustration further comprises a chamber door on top (024), along with a latch (026) and hinge (028), to remove the chalcogenide-based solid-state electrolytes.

FIG. 3B: A schematic illustration of the plasma-assisted vacuum processing approach during the manufacturing of chalcogenide-based solid-state electrolytes. The plasma-assisted approach comprises a vacuum-compatible processing chamber (002) further comprising an inert gas (010) and vacuum (012) inlet for chamber purging and evacuation to remove moisture, oxygen, and other potential contaminants prior to the manufacturing of chalcogenide-based solid-state electrolytes. The vacuum-compatible processing chamber (002) further comprises effusion cell EC-1V (004) for the evaporation of alkali-metal sulfide (030), effusion cell EC-2V (006) for the evaporation of phosphorous pentasulfide (032), effusion cell EC-3V (008) for the evaporation of alkali-metal halide salt (034). The schematic further illustrates the orientation of, and point of intersection between, effusion cells EC-1V (004), EC-2V (006), and EC-3V (008) in relation to the single rotating conveyor belt (014) (gray arrows), as well as provide a visual representation of the flux ratio between the evaporated alkali-metal sulfide (030), phosphorous pentasulfide (032), and alkali-metal halide salt (034).

FIG. 3C: A schematic illustration of the plasma-assisted processing approach during the manufacturing of chalcogenide-based solid-state electrolyte. The plasma-assisted approach comprises a vacuum-compatible processing chamber (002) further comprising effusion cell EC-1V (004) for the evaporation of alkali-metal sulfide (030), effusion cell EC-2V (006) for the evaporation of phosphorous pentasulfide (032), effusion cell EC-3V (008) for the evaporation of alkali-metal halide salt (034), and a cathode (058) and anode (056) connected to an external power source (060) to generate an electric field. A plasma plume (062) is generated between the cathode (058) and anode (056), wherein the formation of chalcogenide-based solid-state electrolyte (036) is activated. A portion of the chalcogenide-based solid-state electrolyte (036) may be deposited directly into the collection crucible (020) at the bottom of the processing chamber (002). Alternatively, the formed chalcogenide-based solid-state electrolyte (036), as well as residual alkali-metal sulfide (030), phosphorous pentasulfide (032), and alkali-metal halide salt (034) may be deposited on the single rotating conveyor belt (014). A heat block (016) between the single rotating conveyor belt (014), may be used to further activate and drive the formation of chalcogenide-based solid-state electrolyte (036) by thermally treating any residual alkali-metal sulfide (030), phosphorous pentasulfide (032), and/or alkali-metal halide salt on the surface of the single rotating conveyor belt (014). Alternatively, a cold block (090) may rapidly quench the deposited chalcogenide-based solid-state electrolyte (036) to further reduce particle size. The formed chalcogenide-based solid-state electrolyte (036) is removed from the single rotating conveyor belt (014) using a knife or blade (018). The single rotating conveyor belt (014) is in physical contact with the knife or blade (018), wherein the belt is rotated over the edge of the knife or blade (018) to remove the chalcogenide-based solid-state electrolyte (036), wherein the rotation of the belt is controlled by the two pulley wheels (014a and 014b) shown in the illustration. The chalcogenide-based solid-state electrolyte is collected in the collection crucible (020) at the bottom of the processing chamber (002). The collection crucible may rotate, controlled by the gearbox (022) outside the processing chamber (002), to fully utilize the entire crucible volume.

FIG. 3D: A schematic illustration of the plasma-assisted processing approach after the manufacturing of chalcogenide-based solid-state electrolytes has concluded. The plasma-assisted approach comprises a vacuum-compatible processing chamber (002) further comprising an inert gas inlet (010) to backfill the chamber and bring it to atmospheric pressure. The processing chamber (002) further comprises a chamber door on top (024) that unlatches from the chamber (via latch 028) and opens to the external environment (via hinge 026). The external environment is preferably a dry room with a moisture content below 1000 ppm or an inert atmosphere in a glovebox. The schematic further illustrates that the single rotating conveyor belt (014), a heat (016) or cold (090) block, the cathode (058), and the anode (056) are attached to the chamber door (024), the specific details of which with regards to how they are attached are beyond the scope of this disclosure. The collection crucible (020) containing the chalcogenide-based solid-state electrolyte (036) may be removed from the processing chamber (002) out through the top.

FIG. 3E: A flowchart for the plasma-assisted vacuum processing of chalcogenide-based solid-state electrolyte production comprising five overarching steps: Preparation (Step #1), Conditioning (Step #2), Plasma Generation (Step #3), Processing (Step #4), and Post-Processing (Step #5). Each step contains one or more sub-steps outlined below.

Preparation (Step #1) comprises four sub-steps including loading alkali-metal sulfide into effusion cell EC-1V via crucible (1A), loading phosphorous pentasulfide into effusion cell EC-2V via crucible (1B), loading alkali-metal halide salt into effusion cell EC-3V via crucible (1C), and loading effusion cells EC-1V, EC-2V, and EC-3V into the processing chamber and sealing (1D). Note that 1D may not be needed if the effusion cells are already loaded onto the processing chamber and sealed.

Conditioning (Step #2) comprises three sub-steps including evacuating the processing chamber to the preferred vacuum range of 10⁻¹ to 10⁻⁷ torr (2A), purging or backfilling the processing chamber with an inert gas (2B), and heating effusion cells EC-1V, EC-2V, and EC-3V to a temperature in the range of 50≤T≤200° C. to remove potential contamination (2C). Note that 2A and 2B may be repeated through multiple iterations to achieve the desired processing conditions.

Plasma Generation (Step #3) comprises applying a voltage between the at least one cathode and one anode using an external power source to generate an electric field with a strength between 0 and 100,000 kV/m and supplying inert gas to the electric field if applicable.

Processing (Step #4) comprises four sub-steps including heating effusion cell EC-1V to a temperature in the range of 200≤T≤1500° C. to evaporate alkali-metal sulfide (4A), heating effusion cell EC-2V to a temperature in the range of 100≤T≤750° C. to evaporate phosphorous pentasulfide (4B), heating effusion cell EC-3V to a temperature in the range of 500≤T≤2000° C. to evaporate alkali-metal halide salt (4C), and adjusting effusion cell temperature and shutter speed to control the flux ratio between alkali-metal sulfide, phosphorous pentasulfide, and alkali-metal halide salt to achieve the desired chalcogenide-based solid-state electrolyte formulation (4D).

Post-Processing (Step #5) comprises fives sub-steps including turning off effusion cells EC-1V, EC-2V, and EC-3V and closing their shutters to terminate the evaporation process (5A), turning off the plasma generation system (5B), cooling effusion cells EC-1V, EC-2V, and EC-3V with chilled water or antifreeze (5C), backfilling the processing chamber with inter gas to bring to atmospheric pressure (5D), and opening the chamber door to remove the collection crucible (5E).

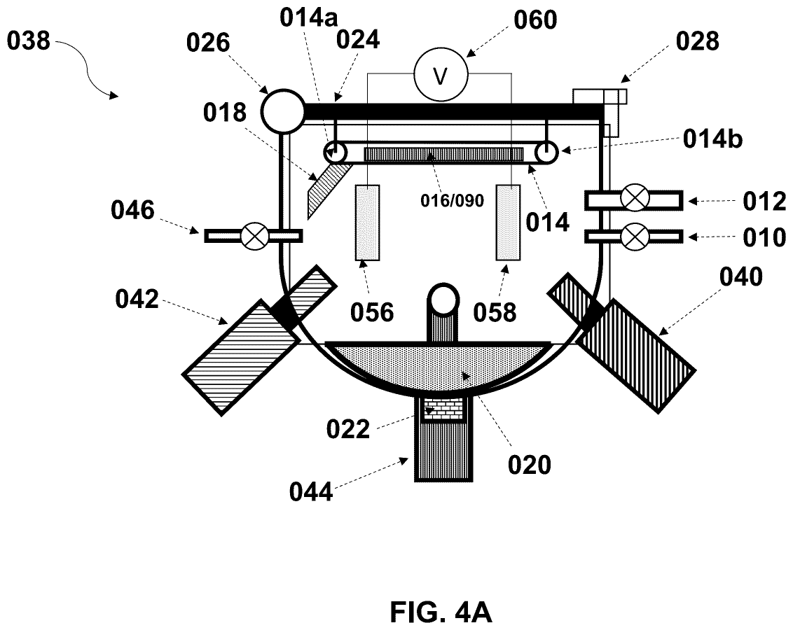

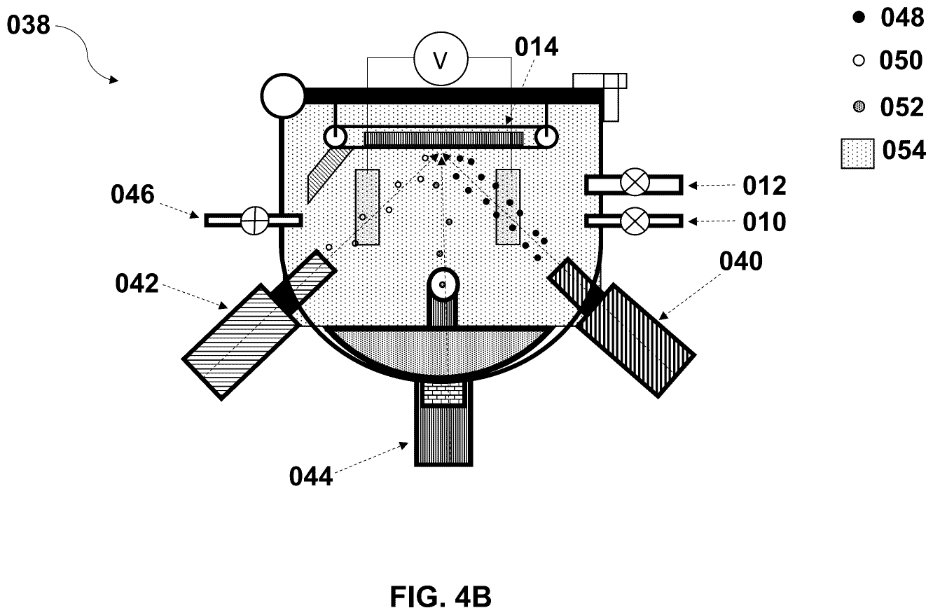

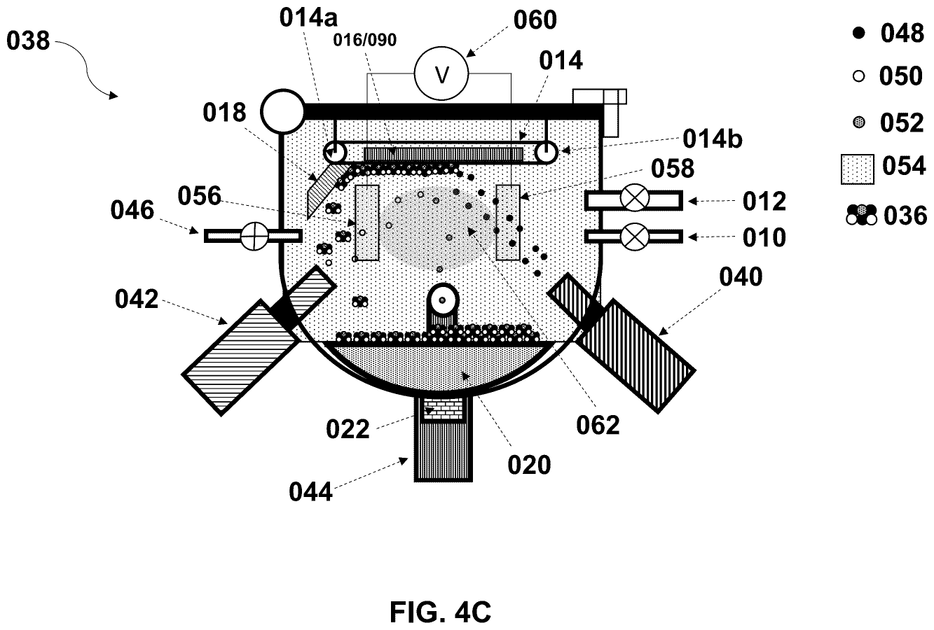

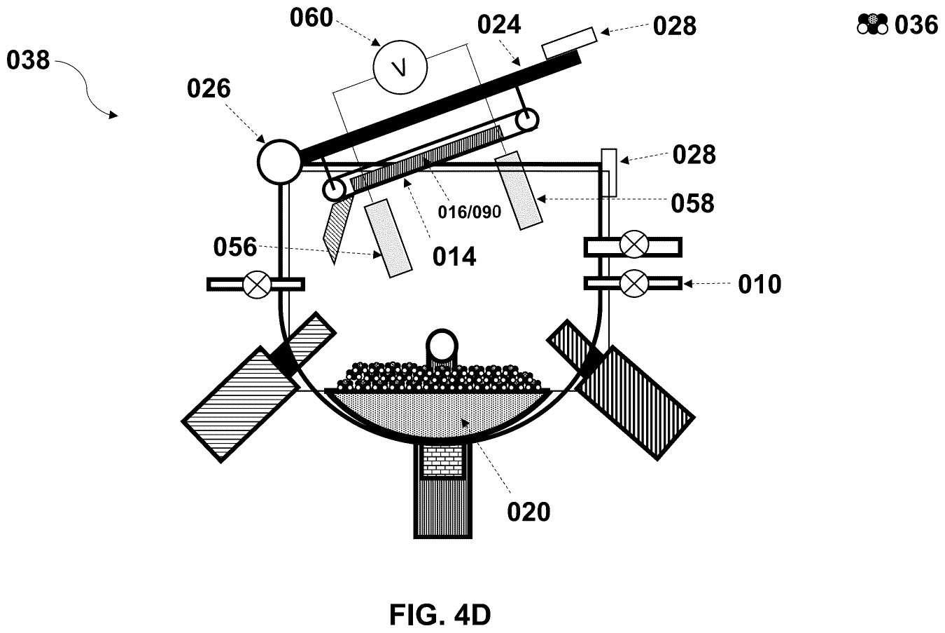

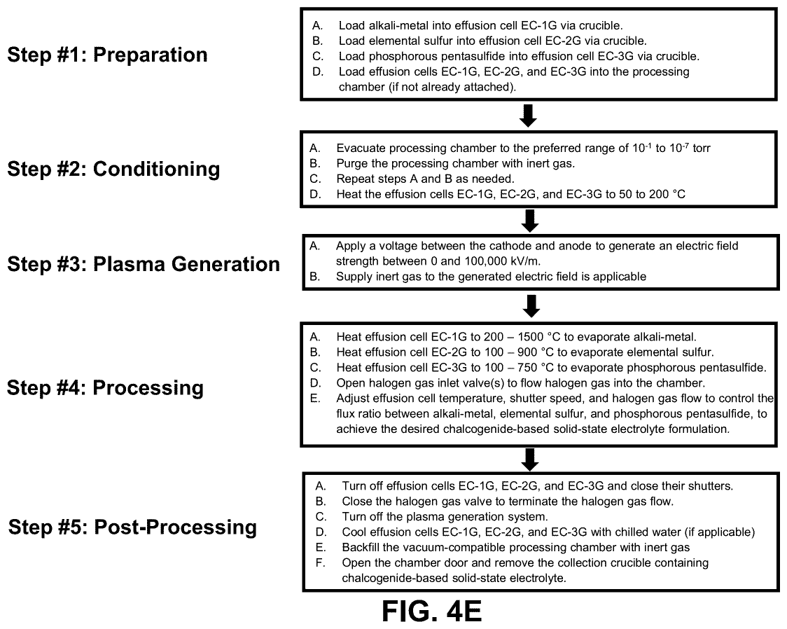

FIGS. 4A-4E relate to the manufacturing of chalcogenide-based solid-state electrolytes described in the fourth embodiment. The manufacturing process includes a plasma-assisted approach that satisfies equation EQ2.

FIG. 4A: A schematic illustration of the processing chamber for plasma-assisted manufacturing of chalcogenide-based solid-state electrolytes. The plasma-assisted approach comprises an upside-down bell-shaped vacuum and halogen gas compatible processing chamber (038) further comprising effusion cell EC-1G (040) for the evaporation of alkali-metal, effusion cell EC-2G (042) for the evaporation of elemental sulfur, effusion cell EC-3G (044) for the evaporation of phosphorous pentasulfide, a halogen-gas inlet (046), an inert gas inlet (010) for chamber purging, a vacuum inlet (012) for chamber evacuation, a cathode (058) and anode (056) connected to a voltage source (060) for electric field generation, a single rotating conveyor belt (014), controlled by two pulley wheels (014a and 014b) to collect the chalcogenide-based solid-state electrolytes, a heat (016) or cold (090) block between the rotating conveyor belt to further activate and drive the formation of chalcogenide-based solid-state electrolytes from any residual alkali-metal, elemental sulfur, and/or phosphorous pentasulfide, or quench the formed chalcogenide-based solid-state electrolyte, a knife or blade (018) to remove the formed chalcogenide-based solid-state electrolyte from the single rotating conveyor belt (014), and a collection crucible (020) connected to a rotating gear box (022) located at the bottom of the processing chamber to collect the chalcogenide-based solid-state electrolyte. The illustration further comprises a chamber door on top (024), along with a latch (026) and hinge (028), to remove the chalcogenide-based solid-state electrolytes.

FIG. 4B: A schematic illustration of the plasma-assisted halogen gas processing approach during the manufacturing of chalcogenide-based solid-state electrolytes. The plasma-assisted approach comprises a vacuum and halogen gas compatible processing chamber (038) further comprising a halogen gas inlet (046), an inert gas (010) and vacuum (012) inlet for chamber purging and evacuation to remove moisture, oxygen, and other potential contaminants prior to the manufacturing of chalcogenide-based solid-state electrolytes. The vacuum and halogen gas compatible processing chamber (038) further comprises effusion cell EC-1G (040) for the evaporation of alkali-metal (048), effusion cell EC-2G (042) for the evaporation of elemental sulfur (050), effusion cell EC-3G (044) for the evaporation of phosphorous pentasulfide (052), and halogen gas (054). The schematic further illustrates the orientation of, and point of intersection between, effusion cells EC-1G (040), EC-2G (042), and EC-3G (044) in relation to the single rotating conveyor belt (014) (gray arrows), as well as provides a visual representation of the flux ratio between the evaporated alkali-metal (048), elemental sulfur (050), and phosphorous pentasulfide (052).

FIG. 4C: A schematic illustration of the plasma-assisted processing approach during the manufacturing of chalcogenide-based solid-state electrolyte. The plasma-assisted approach comprises a vacuum and halogen gas compatible processing chamber (038) further comprising effusion cell EC-1G (040) for the evaporation of alkali-metal (048), effusion cell EC-2G (042) for the evaporation of elemental sulfur (050), effusion cell EC-3G (044) for the evaporation of phosphorous pentasulfide (052), a halogen gas inlet (046), and a cathode (058) and anode (056) connected to an external power source (060) to generate an electric field. A plasma plume (062) is generated between the cathode (058) and anode (056), wherein the formation of chalcogenide-based solid-state electrolyte (036) is activated. A portion of the chalcogenide-based solid-state electrolyte (036) may be deposited directly into the collection crucible (020) at the bottom of the processing chamber (002). Alternatively, the formed chalcogenide-based solid-state electrolyte (036), as well as residual alkali-metal (048), elemental sulfur (050), and/or phosphorous pentasulfide (052) may be deposited on the single rotating conveyor belt (014). A heat block (016) between the single rotating conveyor belt (014), may be used further active and drive the formation of chalcogenide-based solid-state electrolyte (036) by thermally treating any residual alkali-metal (048), elemental sulfur (050), and/or phosphorous pentasulfide (052) on the surface of the single rotating conveyor belt (014). Alternatively, a cold block (090) may rapidly quench the deposited chalcogenide-based solid-state electrolyte (036) to further reduce particle size. The formed chalcogenide-based solid-state electrolyte (036) is removed from the single rotating conveyor belt (014) using a knife or blade (018). The single rotating conveyor belt (014) is in physical contact with the knife or blade (018), wherein the belt is rotated over the edge of the knife or blade (018) to remove the chalcogenide-based solid-state electrolyte (036), wherein the rotation of the belt is controlled by the two pulley wheels (014a and 014b) shown in the illustration. The chalcogenide-based solid-state electrolyte is collected in the collection crucible (020) at the bottom of the processing chamber (002). The collection crucible may rotate, controlled by the gearbox (022) outside the processing chamber (002), to fully utilize the entire crucible volume.

FIG. 4D: A schematic illustration of the plasma-assisted processing approach after the manufacturing of chalcogenide-based solid-state electrolytes has concluded. The plasma-assisted approach comprises a vacuum and halogen gas compatible processing chamber (038) further comprising an inert gas inlet (010) to backfill the chamber and bring it to atmospheric pressure. The processing chamber (038) further comprises a chamber door on top (024) that unlatches from the chamber (via latch 028) and opens to the external environment (via hinge 026). The external environment is preferably a dry room with a moisture content below 1000 ppm or an inert atmosphere in a glovebox. The schematic further illustrates that the single rotating conveyor belt (014), a heat (016) or cold (090) block, the cathode (058), and the anode (056) are attached to the chamber door (024), the specific details of which with regards to how they are attached are beyond the scope of this disclosure. The collection crucible (020) containing the chalcogenide-based solid-state electrolyte (036) may be removed from the processing chamber (002) out through the top.

FIG. 4E: A flowchart for the plasma-assisted halogen gas processing of chalcogenide-based solid-state electrolyte production comprising five overarching steps: Preparation (Step #1), Conditioning (Step #2), Plasma Generation (Step #3), Processing (Step #4), and Post-Processing (Step #5). Each step contains one or more sub-steps outlined below.

Preparation (Step #1) comprises four sub-steps including loading alkali-metal into effusion cell EC-1G via crucible (1A), loading elemental sulfur into effusion cell EC-2G via crucible (1B), loading phosphorous pentasulfide into effusion cell EC-3G (1C) via crucible, and loading effusion cells EC-1G, EC-2G, and EC-3G into the processing chamber and sealing (1D). Note that 1D may not be needed if the effusion cells are already loaded onto the processing chamber and sealed.

Conditioning (Step #2) comprises three sub-steps including evacuating the processing chamber to the preferred vacuum range of 10⁻¹ to 10⁻⁷ torr (2A), purging or backfilling the processing chamber with an inert gas (2B), and heating effusion cells EC-1G, EC-2G, and EC-3G to a temperature in the range of 50≤T≤200° C. to remove potential contamination (2C). Note that 2A and 2B may be repeated through multiple iterations to achieve the desired processing conditions.

Plasma Generation (Step #3) comprises applying a voltage between the at least one cathode and one anode using an external power source to generate an electric field with a strength between 0 and 100,000 kV/m and supplying inert gas to the electric field if applicable.

Processing (Step #3) comprises five sub-steps including heating effusion cell EC-1G to a temperature in the range of 200≤T≤1500° C. to evaporate alkali-metal (3A), heating effusion cell EC-2G to a temperature in the range of 100≤T≤900° C. to evaporate elemental sulfur (3B), heating effusion cell EC-3G to a temperature in the range of 100≤T≤750° C. to evaporate phosphorous pentasulfide (3C), opening the halogen gas inlet valve to flow halogen gas into the processing chamber (3D), and adjusting effusion cell temperature, shutter speed, and halogen gas flow to control the flux ratio between alkali-metal, elemental sulfur, phosphorous pentasulfide, and halogen gas to achieve the desired chalcogenide-based solid-state electrolyte formulation (3E).

Post-Processing (Step #4) comprises six sub-steps including turning off effusion cells EC-1G, EC-2G, and EC-3G and closing their shutters to terminate the evaporation process (4A), closing the halogen gas inlet valve to shut off halogen gas flow (4B), turning off the plasma generation system (4C), cooling effusion cells EC-1G, EC-2G, and EC-3G with chilled water or antifreeze (4D), backfilling the processing chamber with inter gas to bring to atmospheric pressure (4E), and opening the chamber door to remove the collection crucible (4F).

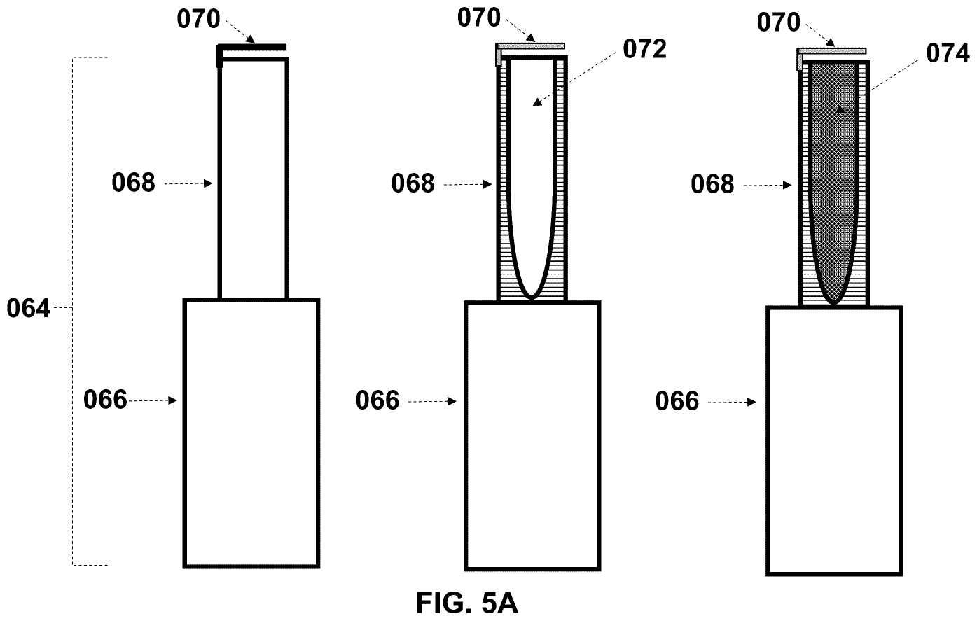

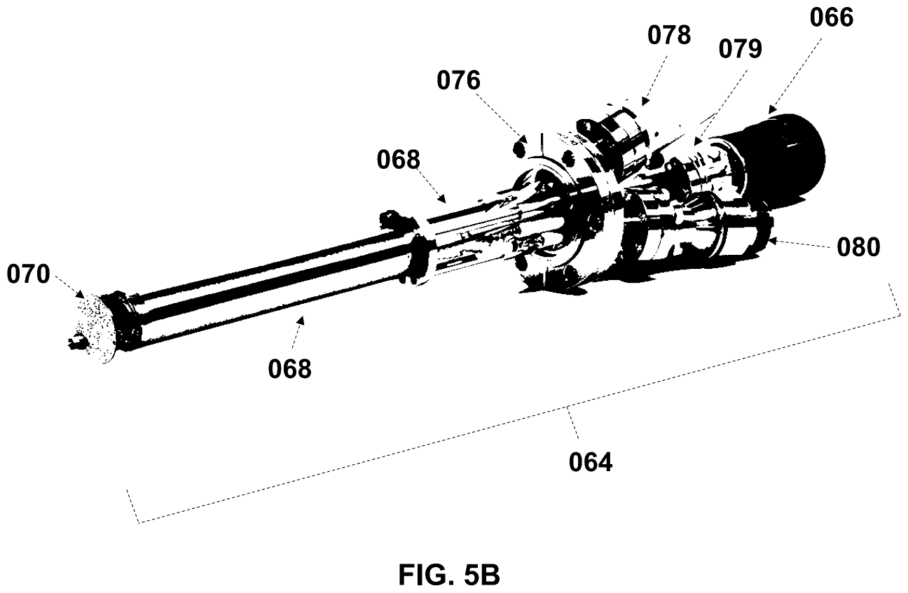

FIG. 5A: A schematic illustration of an effusion cell (064) comprising a reservoir/heat sink (066), a tube (068), a shutter (070), a crucible (072), and a precursor (074) packed into the crucible. Precursor materials may include, for example, alkali-metals sulfide, alkali-metal halide salt, alkali-metal, or phosphorous pentasulfide. The tube (068) may further comprise (not shown) one or more heat filaments, chilled cooling lines, a thermocouple, etc.

FIG. 5B: A digital image of an effusion cell (064) comprising a reservoir/heat sink (066), a tube (068), a shutter (070), a mounting flange (076), a filament port (078), and a thermocouple port (079). The tube (068) may further comprise (not shown) one or more heat filaments, chilled cooling lines, a thermocouple, etc.

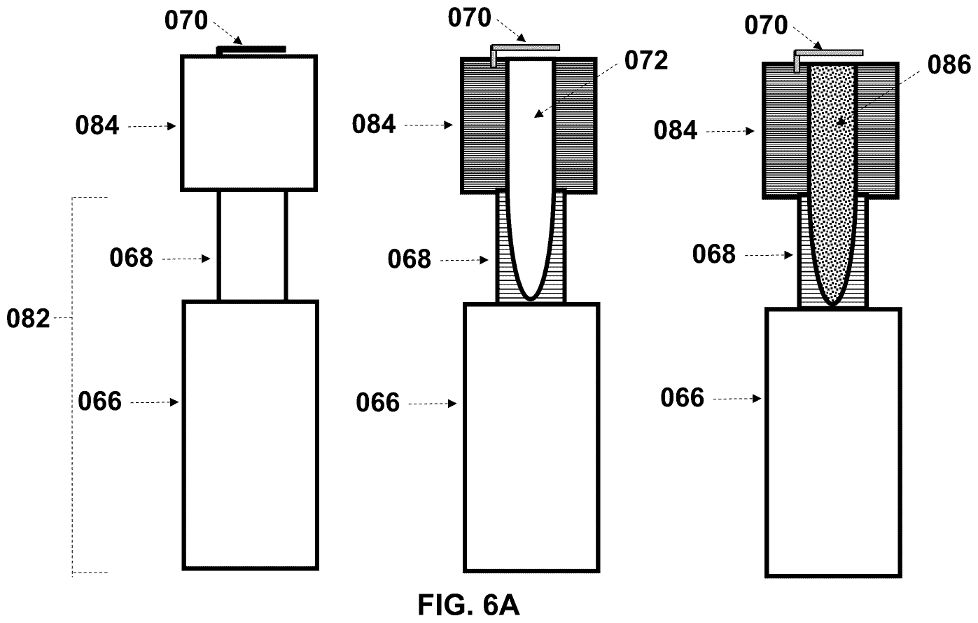

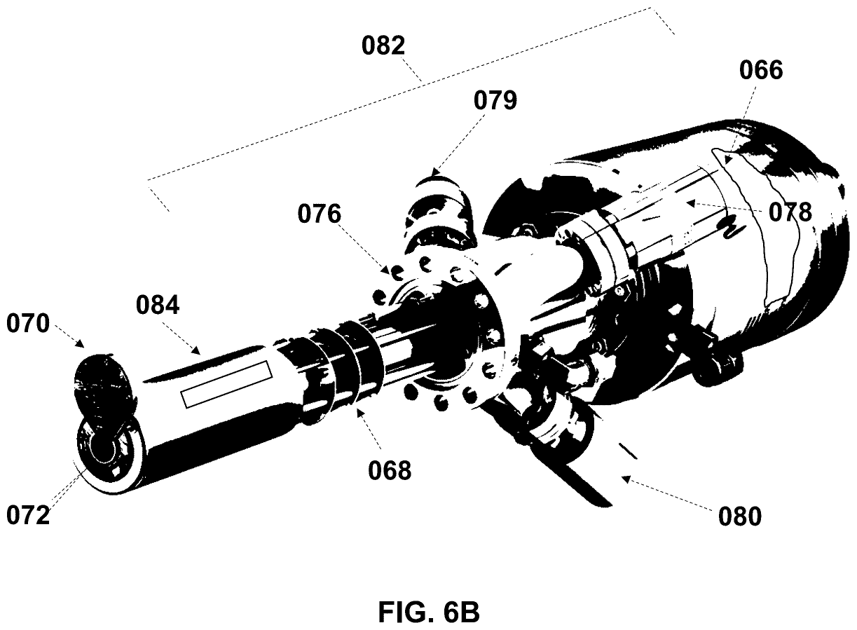

FIG. 6A: A schematic illustration of a thermal cracker cell (082), or effusion cell EC-2G, comprising a thermal cracker head (084), a reservoir/heat sink (066), a tube (068), a shutter (070), a crucible (072), and elemental sulfur (086) packed into the crucible. The tube (068) may further comprise (not shown) one or more heat filaments, chilled cooling lines, a thermocouple, etc.

FIG. 6B: A digital image of a thermal cracker cell (082) comprising a thermal cracker head (084), a reservoir/heat sink (066), a tube (068), a shutter (070), a crucible (072), a mounting flange (076), a filament port (078), a thermocouple port (079), and chilled water port (080). The tube (068) may further comprise (not shown) one or more heat filaments, chilled cooling lines, a thermocouple, etc.

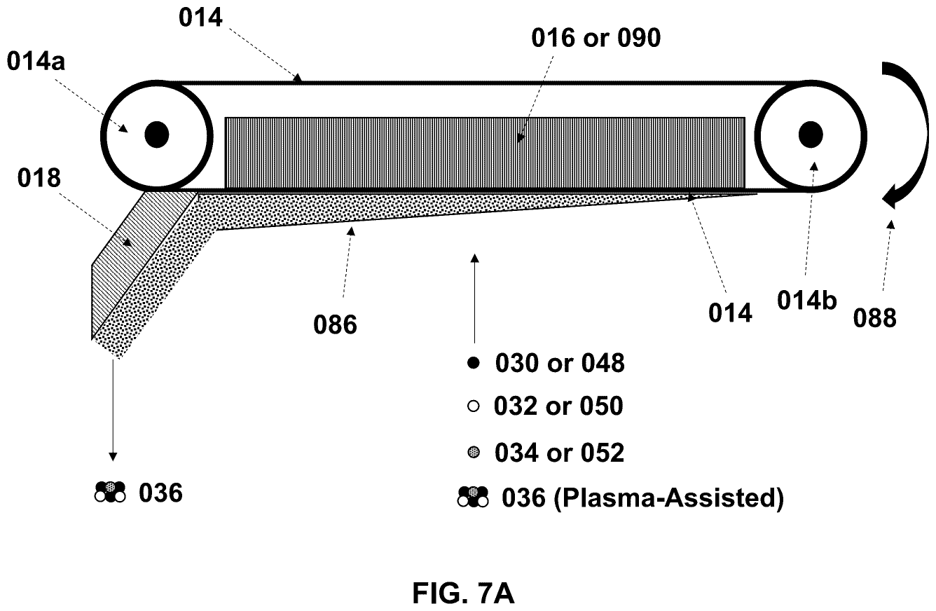

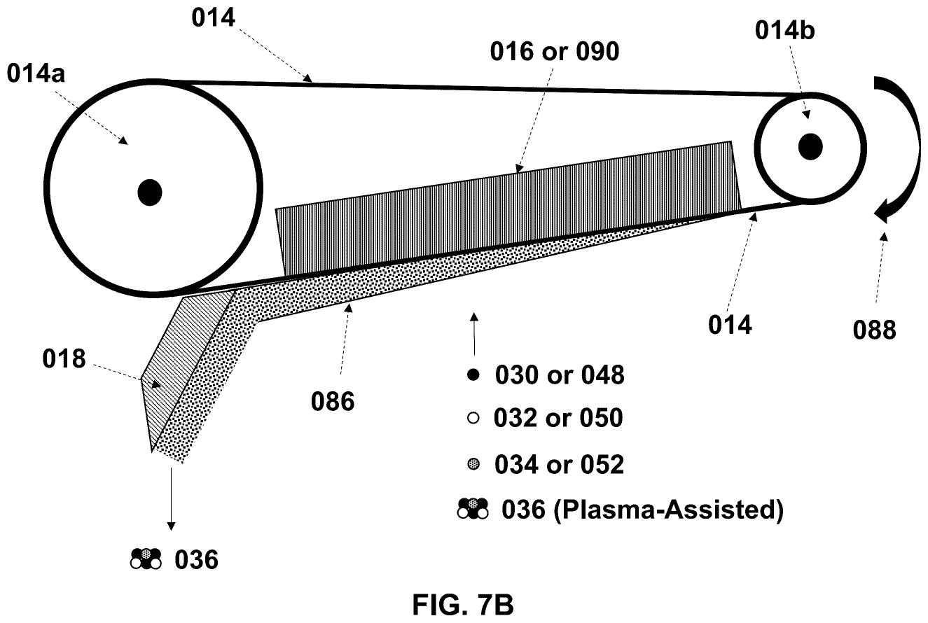

FIG. 7A: A schematic illustration of a rotating conveyor belt system, the system comprising a single rotating conveyor belt (014), a heat block (016) or cold block (090) depending on the processing approach, and a knife or blade (018). The system further comprises two pulley wheels (014a and 014b) of similar size and is rotating in the clockwise direction (088). A material layer (086) deposited on the surface of the single rotating conveyor belt (014) comprises alkali metal sulfide (030), phosphorous pentasulfide (032), and alkali-metal halide salt (034), or alkali metal (048), elemental sulfur (050), and phosphorous pentasulfide (052) in the case of a heat-assisted approach, and chalcogenide-based solid-state electrolyte (036) in the case of plasma-assisted processing (as well as the possibility of residual alkali-metal sulfide, phosphorous pentasulfide, and alkali-metal halide salt, or alkali-metal, elemental sulfur, and phosphorous pentasulfide). The knife or blade (018) removes the material layer (086) deposited on the surface of the single rotating conveyor belt (014), comprising entirely of chalcogenide-based solid-state electrolyte (036), which deposits into the at least one collection crucible at the bottom of the processing chamber (not shown).

FIG. 7B: A schematic illustration of a rotating conveyor belt system, the system comprising a single rotating conveyor belt (014), a heat block (016) or cold block (090) depending on the processing approach, and a knife or blade (018). The system further comprises two pulley wheels (014a and 014b) of different sizes and is rotating in the clockwise direction (088). A material layer (086) deposited on the surface of the single rotating conveyor belt (014) comprises alkali metal sulfide (030), phosphorous pentasulfide (032), and alkali-metal halide salt (034), or alkali metal (048), elemental sulfur (050), and phosphorous pentasulfide (052) in the case of a heat-assisted approach, and chalcogenide-based solid-state electrolyte (036) in the case of plasma-assisted processing (as well as the possibility of residual alkali-metal sulfide, phosphorous pentasulfide, and alkali-metal halide salt, or alkali-metal, elemental sulfur, and phosphorous pentasulfide). The knife or blade (018) removes the material layer (086) deposited on the surface of the single rotating conveyor belt (014), comprising entirely of chalcogenide-based solid-state electrolyte (036), which deposits into the at least one collection crucible at the bottom of the processing chamber (not shown).

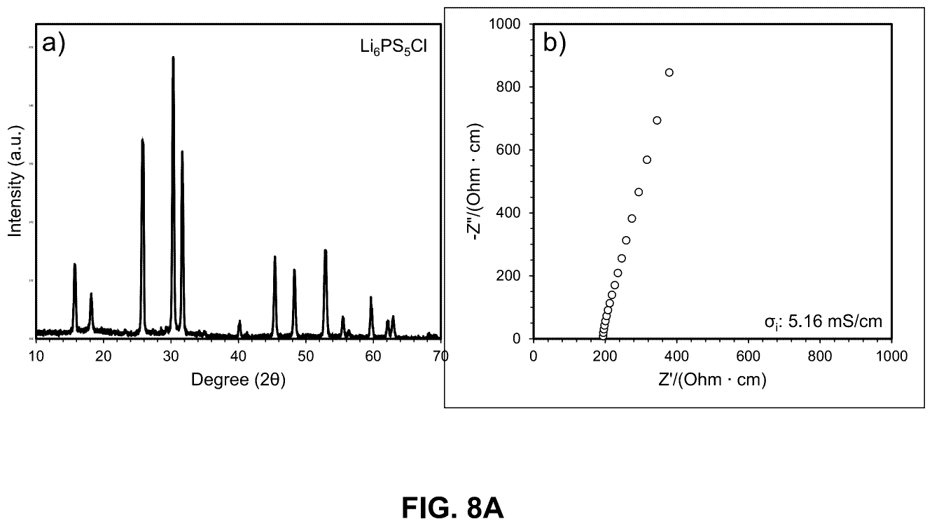

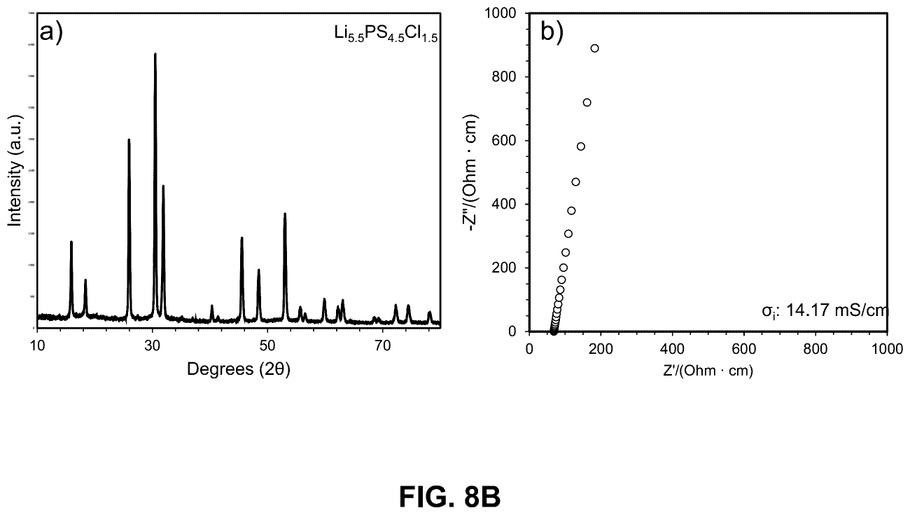

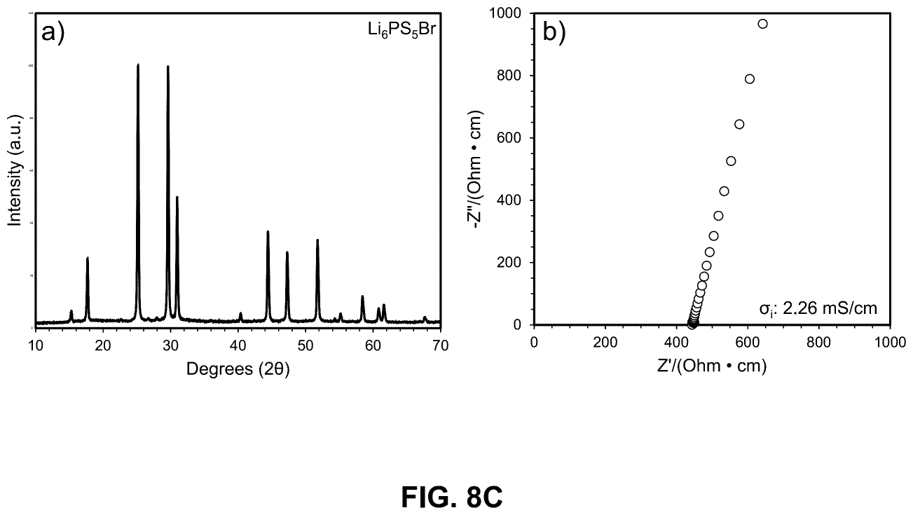

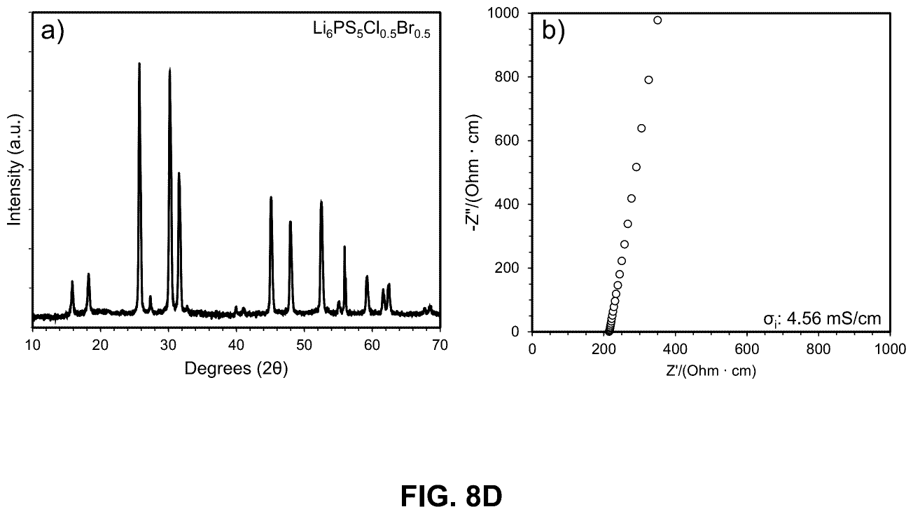

FIG. 8A: A representative x-ray diffraction pattern a) and a Nyquist plot from an electrochemical impedance spectroscopy measurement b) of a chalcogenide-based solid-state electrolyte with the chemical formula of Li₆PS₅Cl. A room temperature ionic conductivity of 5.16 mS/cm was derived from the Nyquist plot in panel b).

FIG. 8B: A representative x-ray diffraction pattern a) and a Nyquist plot from an electrochemical impedance spectroscopy measurement b) of a chalcogenide-based solid-state electrolyte with the chemical formula of Li_{5.5}PS_{4.5}Cl_{1.5}. A room temperature ionic conductivity of 14.17 mS/cm was derived from the Nyquist plot in panel b).

FIG. 8C: A representative x-ray diffraction pattern a) and a Nyquist plot from an electrochemical impedance spectroscopy measurement b) of a chalcogenide-based solid-state electrolyte with the chemical formula of Li₆PS₅Br. A room temperature ionic conductivity of 2.26 mS/cm was derived from the Nyquist plot in panel b).

FIG. 8D: A representative x-ray diffraction pattern a) and a Nyquist plot from an electrochemical impedance spectroscopy measurement b) of a chalcogenide-based solid-state electrolyte with the chemical formula of Li₆PS₅Cl_{0.5}Br_{0.5}. A room temperature ionic conductivity of 4.56 mS/cm was derived from the Nyquist plot in panel b).

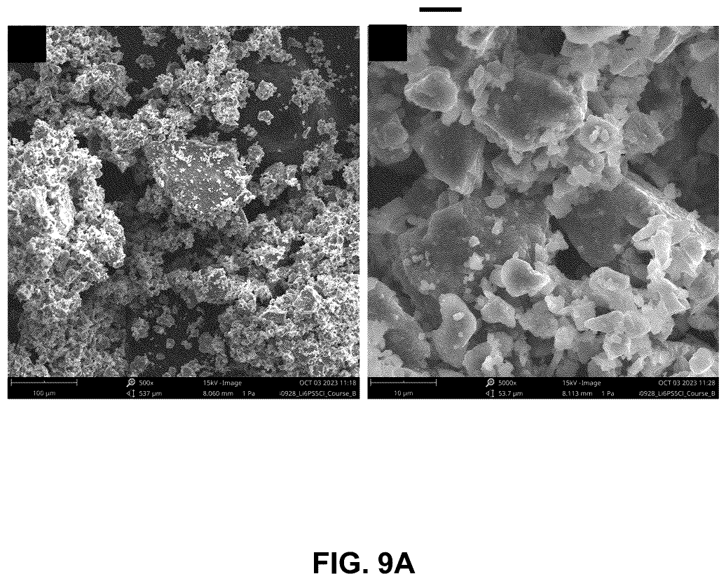

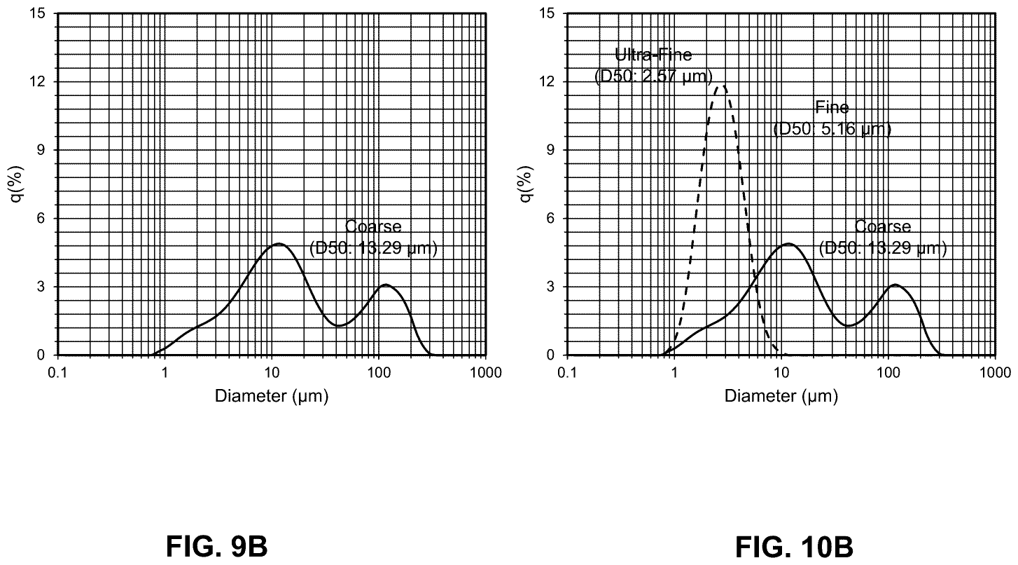

FIG. 9A: Representative scanning electron microscopy images of a chalcogenide-based solid-state electrolyte produced using a heat-assisted processing approach.

FIG. 9B: A representative particle size distribution plot of a chalcogenide-based solid-state electrolyte produced using a heat-assisted processing approach with a D50 value of 13.29 m.

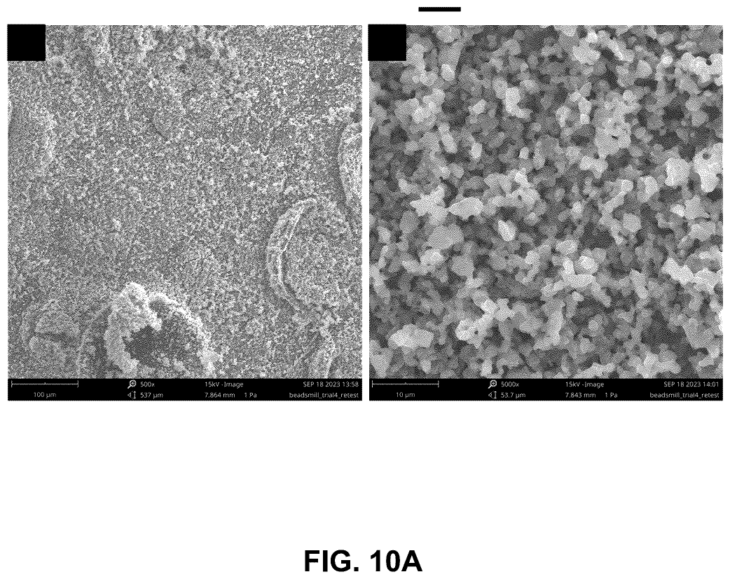

FIG. 10A: Representative scanning electron microscopy images of a chalcogenide-based solid-state electrolyte produced using a plasma-assisted processing approach.

FIG. 10B: A representative particle size distribution plot of a chalcogenide-based solid-state electrolyte produced using a plasma-assisted processing approach with a D50 value of 2.57 μm.

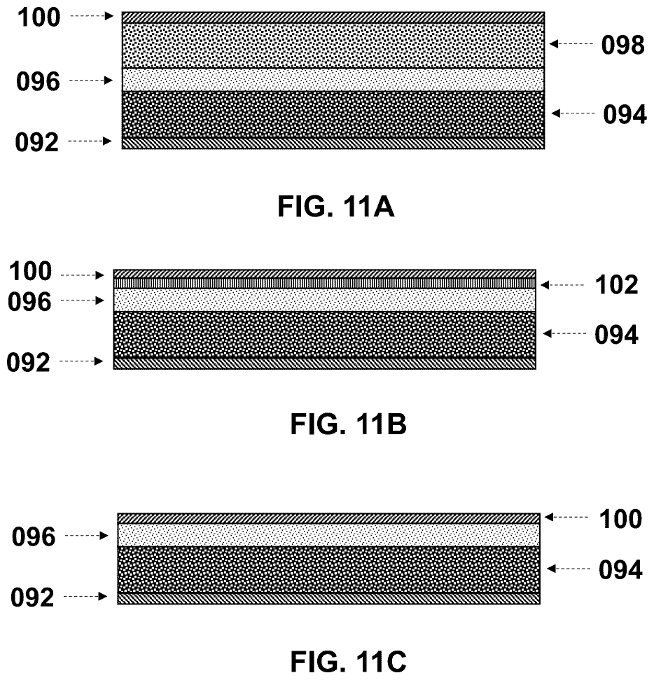

FIG. 11A: A schematic representation of a solid-state battery comprising chalcogenide-based solid-state electrolyte. The solid-state battery further comprises a composite cathode (094), a positive current collector (092), a solid-state electrolyte membrane (096), a composite anode (098), and a negative current collector (100). The composite cathode (094) and composite anode (098) further comprise chalcogenide-based solid-state electrolyte in the form of a catholyte and anolyte, respectively.

FIG. 11B: A schematic representation of a solid-state battery comprising chalcogenide-based solid-state electrolyte. The solid-state battery further comprises a composite cathode (094), a positive current collector (092), a solid-state electrolyte membrane (096), an alkali-metal anode (102), and a negative current collector (100). The composite cathode (094) further comprise chalcogenide-based solid-state electrolyte in the form of a catholyte.

FIG. 11C: A schematic representation of an anodeless solid-state battery comprising chalcogenide-based solid-state electrolyte. The solid-state battery further comprises a composite cathode (094), a positive current collector (092), a solid-state electrolyte membrane (096), and a and a negative current collector (100). The composite cathode (094) further comprise chalcogenide-based solid-state electrolyte in the form of a catholyte.

The above-described systems and methods can be ascribed to a sulfide-based solid-state electrolyte material that do not have an argyrodite crystal structure.

The above-described systems and methods can be ascribed to sulfide-based solid-state electrolyte materials with the general formula Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

The above-described systems and methods can be ascribed to sulfide-based solid-state electrolyte materials with the general formula Li₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof, and x is in the range of 0≤x≤2.

The above-described systems and methods can be ascribed to sulfide-based solid-state electrolyte materials with the general formula Na₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

The above-described systems and methods can be ascribed to sulfide-based solid-state electrolyte materials with the general formula Na₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

The above-described systems and methods can be ascribed to sulfide-based solid-state electrolyte materials with the general formula K₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

The above-described systems and methods can be ascribed to sulfide-based solid-state electrolyte materials with the general formula K₁₈₋₂ₘ₋ₓM₂^{m+}Y₍₉₋ₓ₎₊ₙXₓ, wherein M^{m+}=B³⁺, Ga³⁺, Sb³⁺, Si⁴⁺, Ge⁴⁺, P⁵⁺, As⁵⁺, or a combination thereof; Y²=O²⁻, S²⁻, Se²⁻, Te²⁻, or a combination thereof; X⁻=F⁻, Cl⁻, Br⁻, I⁻, or a combination thereof; and x is in the range of 0≤x≤2.

The above-described systems and methods can be ascribed to chalcogenide-based solid-state electrolyte for solid-state batteries with chemistries beyond lithium, sodium, and potassium, which may include, for example, aluminum ion, magnesium ion, iron ion, potassium ion, etc.

The above-describes system and methods can be ascribed to chalcogenide-based solid-state electrolytes for other types of secondary batteries including, for example, hybrid solid-state batteries, semi-hybrid solid-state batteries, lithium metal batteries, hybrid lithium metal batteries, semi-hybrid lithium metal batteries, anodeless batteries, anodeless lithium metal batteries, hybrid anodeless lithium metal batteries, semi-hybrid anodeless lithium metal batteries, lithium air batteries, lithium primary batteries, microbatteries, thin film batteries, lithium sulfur batteries, sodium metal batteries, hybrid sodium metal batteries, semi-hybrid sodium metal batteries, anodeless sodium metal batteries, hybrid anodeless sodium metal batteries, semi-hybrid anodeless sodium metal batteries, sodium air batteries, sodium primary batteries, sodium sulfur batteries, potassium metal batteries, hybrid potassium metal batteries, semi-hybrid potassium metal batteries, anodeless potassium metal batteries, hybrid anodeless potassium metal batteries, semi-hybrid anodeless potassium metal batteries, potassium air batteries, potassium primary batteries, potassium sulfur batteries, etc.

The above-described systems and methods can be ascribed to solid-state batteries for all types of electric vehicles including, but not limited to, sedan, coupe, convertible, hatchback, support utility, sports, compact, subcompact, minivan, van, luxury, truck, full size truck, pickup truck, economy, crossover, wagon, full-size, mix-size, bus, semi, etc.

The above-described systems and methods can be ascribed to solid-state batteries with the end use applications other than electric vehicles such as, for example, hybrid electric vehicles, mobile devices, handheld electronics, consumer electronics, medical, medical wearables, and wearables for portable energy storage.

The above-described systems and methods can be ascribed to solid-state batteries for grid scale energy storage backup systems.

The above-described systems and methods can be ascribed to solid-state batteries for longevity, higher energy density and power density and improved safety.

The above-described systems and methods can be ascribed for alternative energy storage technologies such as primary solid-state batteries and solid-state flow batteries.

The above-described systems and methods can be used in locations other than the vicinity of earth including in space, such as space stations, satellites, both natural and unnatural, and other planetary bodies such as mars.

In the drawings, the following reference numbers are noted: 002—Vacuum-compatible processing chamber; 004—Effusion cell EC-1V; 006—Effusion cell EC-2V; 008—Effusion cell EC-3V; 010—Inert gas inlet; 012—Vacuum inlet; 014—Rotating conveyor belt; 014a Pulley (closes to knife/blade); 014b Pulley; 016—Heat block; 018—Knife/blade; 020—Collection crucible; 022—Gearbox; 024—Chamber door; 026—Door hinge; 028—Door latch; 030—Alkali-metal sulfide; 032—Phosphorous pentasulfide; 034—Alkali-metal halide salt; 036—Chalcogenide-based solid-state electrolyte; 038—Vacuum and halogen gas compatible processing chamber; 040—Effusion cell EC-1G; 042—Effusion cell EC-2G; 044—Effusion cell EC-3G; 046—Halogen gas inlet; 048—Alkali-metal; 050—Elemental sulfur; 052—Phosphorous pentasulfide; 054—Halogen gas; 056—Anode; 058—Cathode; 060—External power source; 062—Plasma plume; 064—Effusion cell; 066—Reservoir/heat sink; 068—Tube; 070—Shutter; 072—Crucible; 074—Precursor; 076—Mounting flange; 078—Filament port; 079—Thermocouple port; 080—Chilled water port; 082—Thermal cracker cell; 084—Thermal cracker head; 086—Deposited material layer; 088—Rotation in clockwise direction; 090—Cold Block; 092—Positive current collector; 094—Composite cathode; 096—Solid-state electrolyte membrane; 098—Composite anode; 100—Negative current collector; 102—Alkali-metal anode

Although various embodiments of the disclosed system have been shown and described, modifications may occur to those skilled in the art upon reading the specification. The present application includes such modifications and is limited only by the scope of the claims.

What is claimed is:

1. A method for manufacturing chalcogenide-based solid-state electrolytes with the general formula A₁₂₋ₘ₋ₓM^{m}Y₍₆₋ₓ₎Xₓ, where
A is lithium, sodium, potassium, cesium, or rubidium;
M is boron (B³⁺), gallium (Ge³⁺), antimony (Sb³⁺), silicon (Si⁴⁺), germanium (Ga⁴⁺), tin (Sn⁴⁺), phosphorus (P⁵⁺), arsenic (As⁵⁺), or a combination thereof;
Y is sulfur, selenium, tellurium, or a combination thereof,
X is fluorine, chlorine, bromine, iodide, or a combination thereof, and
x is in the range of 00≤x≤2,
the method comprising:
generating a vapor of a first precursor material in a first effusion cell;
generating a vapor of a second precursor material in a second effusion cell;
generating a vapor of a third precursor material in a third effusion cell;
bringing together the generated vapors of the first, second, and third precursor materials in a vacuum-compatible processing chamber; and
initiating a reaction between the vapors of the first, second, and third precursor materials to produce the chalcogenide-based solid-state electrolyte, wherein the chemical formula of the chalcogenide-based solid-state electrolyte is governed by the flux ratio between the first, second, and third precursor vapors.

2. The method of claim 1, wherein at least one of the three effusion cells is at a temperature in the range of 200≤T≤1500° C. and used to evaporate an alkali-metal sulfide with the general formula A₂Y where A is lithium, sodium, potassium, cesium, or rubidium, and Y is sulfur, selenium, or tellurium.

3. The method of claim 1, wherein at least one of the three effusion cells is at a temperature in the range of 100≤T≤2000° C. and is used to evaporate a compound with an empirical formula M_{y}^{m+}Yₘ^{y-} where M^{m+} is boron (B³⁺), gallium (Ga³⁺), antimony (Sb³⁺), silicon (Si⁴⁺), germanium (Ge⁴⁺), tin (Sn⁴⁺), phosphorus (P⁵⁺), or arsenic (As⁵⁺) and Y^{y-} is sulfur (S²⁻), selenium (Se²⁻), or tellurium (Te²⁻).

4. The method of claim 1, wherein at least one of the three effusion cells is at a temperature in the range of 500≤T≤2000° C. and is used to evaporate an alkali-metal halide salt with the general formula AX where A is lithium, sodium, potassium, cesium, or rubidium, and X is fluorine, chlorine, bromine, or iodine, and has a temperature in the range of 500≤T≤2000° C.

5. The method of claim 1, wherein at least one of the three effusion cells is at a temperature in the range of 200≤T≤1500° C. and used to evaporate an alkali-metal sulfide with the general formula A₂Y where A is lithium, sodium, potassium, cesium, or rubidium, and Y is sulfur, selenium, or tellurium, wherein at least one of the three effusion cells is at a temperature in the range of 100≤T≤2000° C. and is used to evaporate a compound with an empirical formula M_{y}^{m+}Yₘ^{y-} where M^{m+} is boron (B³⁺), gallium (Ga³⁺), antimony (Sb³⁺), silicon (Si⁴⁺), germanium (Ge⁴⁺), tin (Sn⁴⁺), phosphorus (P⁵⁺), or arsenic (As⁵⁺) and Y^{y-} is sulfur (S²⁻), selenium (Se²⁻), or tellurium (Te²⁻), wherein at least one of the three effusion cells is at a temperature in the range of 500≤T≤2000° C. and is used to evaporate an alkali-metal halide salt with the general formula AX where A is lithium, sodium, potassium, cesium, or rubidium, and X is fluorine, chlorine, bromine, or iodine, and has a temperature in the range of 500≤T≤2000° C., and wherein the chemical formula of the chalcogenide-based solid-state electrolyte is governed by the flux ratio between the evaporated alkali-metal sulfide (A₂Y), the evaporated compound with an empirical formula M_{y}^{m+}Yₘ^{y-}, the evaporated alkali-metal halide salt (AX), and is derived from equation EQ1:
$$( 12 - m - 2 x ) {A}_{2} Y + ( \frac{2}{y} ) {M}_{y}^{m +} {Y}_{m}^{y -} + ( 2 x ) A X = 2 ( {A}_{( 12 - m - x )} {M}^{m +} {Y}_{( 6 - x )} {X}_{x} )$$
where A is lithium, sodium, potassium, cesium, or rubidium, M^{m+} is boron (B³⁺), gallium (Ge³⁺), antimony (Sb³⁺), silicon (Si⁴⁺), germanium (Ge⁴⁺), tin (Sn⁴⁺), phosphorus (P⁵⁺), or arsenic (As⁵⁺), Y is sulfur, selenium, or tellurium, X is fluorine, chlorine, bromine, iodide, and x is in the range of 0≤x≤2.

6. The method of claim 2, wherein the flux of the evaporated alkali-metal sulfide is derived from the equation 12−m−2x, where m is 3⁺, 4+, or 5⁺, and x is in the range of 0<x<2.

7. The method of claim 3, wherein the flux of the evaporated compound with an empirical formula M_{y}^{m+}Yₘ^{y-} is derived from the equation 2/y and can be kept at 1 as a constant.

8. The method of claim 4, wherein the flux of the evaporated alkali-metal halide salt (AX) of is derived from equation 2x, where x is in the range of 0<x<2.

9. The method of claim 1, wherein the vacuum-compatible processing chamber further comprises a plasma generating system comprising a cathode, an anode, and an electric field therebetween, wherein the electric field generates a plasma plume that can activate the formation of chalcogenide-based solid-state electrolytes.

10. A method for manufacturing chalcogenide-based solid-state electrolytes with the general formula A₁₂₋ₘ₋ₓM^{m}Y₍₆₋ₓ₎Xₓ, where
A is lithium, sodium, potassium, cesium, or rubidium;
M is boron (B³⁺), gallium (Ge³⁺), antimony (Sb³⁺), silicon (Si⁴⁺), germanium (Ga⁴⁺), tin (Sn⁴⁺), phosphorus (P⁵⁺), arsenic (As⁵⁺), or a combination thereof;
Y is sulfur, selenium, tellurium, or a combination thereof,
X is fluorine, chlorine, bromine, iodide, or a combination thereof, and
x is in the range of 0≤x≤2,
the method comprising:
generating a vapor of a first precursor material in a first effusion cell;
generating a vapor of a second precursor material in a second effusion cell;
generating a vapor of a third precursor material in a third effusion cell;
providing a halogen gas acting as a fourth precursor material;
bringing together the generated vapors of the first, second, third, and fourth precursor materials in a vacuum and halogen gas compatible processing chamber; and
initiating a reaction between the vapors of the first, second, third and fourth precursor materials to produce the chalcogenide-based solid-state electrolyte, wherein the chemical formula of the chalcogenide-based solid-state electrolyte is governed by the flux ratio between the first, second, third, and fourth precursor vapors.

11. The method of claim 10, wherein at least one of the three effusion cells has a temperature in the range of 200≤T≤1500° C. and used to evaporate an alkali-metal (A) such as lithium, sodium, potassium, cesium, or rubidium.

12. The method of claim 10, wherein at least one of the three effusion cells is at a temperature in the range of 100≤T≤900° C. and used to evaporate elemental chalcogenide material (Y) such as sulfur, selenium, or tellurium.

13. The method of claim 10, wherein at least one of the three effusion cells is at a temperature in the range of 100≤T≤2000° C. and is used to evaporate a compound with an empirical formula M_{y}^{m+}Yₘ^{y-} where M^{m+} is boron (B³⁺), gallium (Ga³⁺), antimony (Sb³⁺), silicon (Si⁴⁺), germanium (Ge⁴⁺), tin (Sn⁴⁺), phosphorus (P⁵⁺), or arsenic (As⁵⁺) and Y^{y-} is sulfur (S²⁻), selenium (Se²⁻), or tellurium (Te²⁻).

14. The method of claim 10, wherein the halogen gas (X₂) includes fluorine gas, chlorine gas, bromine gas, iodine gas, or a combination thereof.

15. The method of claim 10,
wherein at least one of the three effusion cells has a temperature in the range of 200≤T≤1500° C. and used to evaporate an alkali-metal (A) such as lithium, sodium, potassium, cesium, or rubidium,
wherein at least one of the three effusion cells is at a temperature in the range of 100≤T≤900° C. and used to evaporate elemental chalcogenide material (Y) such as sulfur, selenium, or tellurium,
wherein at least one of the three effusion cells is at a temperature in the range of 100≤T≤2000° C. and is used to evaporate a compound with an empirical formula M_{y}^{m+}Yₘ^{y-} where M^{m+} is boron (B³⁺), gallium (Ga³⁺), antimony (Sb³⁺), silicon (Si⁴⁺), germanium (Ge⁴⁺), tin (Sn⁴⁺), phosphorus (P⁵⁺), or arsenic (As⁵⁺) and Y^{y-} is sulfur (S²⁻), selenium (Se²⁻), or tellurium (Te²⁻),
wherein the halogen gas (X₂) includes fluorine gas, chlorine gas, bromine gas, iodine gas, or a combination thereof, and
wherein the chemical formula of the chalcogenide-based solid-state electrolyte is governed by the flux ratio between the evaporated alkali-metal (A), the evaporated elemental chalcogenide material (Y), the evaporated compound with an empirical formula M_{y}^{m+}Yₘ^{y-}, and the halogen gas (X₂), and is derived from equation EQ2:
$$( 24 - 2 m - 2 x ) A + ( 12 - m - 2 x ) Y + ( \frac{2}{y} ) {M}_{y}^{m +} {Y}_{m}^{y -} + ( x ) {X}_{2} = 2 ( {A}_{( 12 - m - x )} {M}^{m} {Y}_{( 6 - x )} {X}_{x} )$$
where A is lithium, sodium, potassium, cesium, or rubidium, M^{m+} is boron (B³⁺), gallium (Ge³⁺), antimony (Sb³⁺), silicon (Si⁴⁺), germanium (Ge⁴⁺), tin (Sn⁴⁺), phosphorus (P⁵⁺), or arsenic (As⁵⁺), Y is sulfur, selenium, or tellurium, X is fluorine, chlorine, bromine, iodide, and x is in the range of 0≤x≤2.

16. The method of claim 15, wherein the flux of the evaporated alkali-metal is derived from the equation 24−2m−2x, where m is 3⁺, 4+, or 5⁺, and x is in the range of 0<x<2.

17. The method of claim 15, wherein the flux of the evaporated elemental chalcogenide material is derived from the equation 12−m−2x, where m is 3⁺, 4+, or 5⁺, and x is in the range of 0<x<2.

18. The method of claim 15, wherein the flux of the evaporated compound with an empirical formula M_{y}^{m+}Yₘ^{y-} is derived from the equation 2/y and can be kept at 1 as a constant.

19. The method of claim 15, wherein the flux of the halogen gas (X₂) is derived from x(X₂), where x is in the range of 0<x<2.

20. The method of claim 10, wherein the vacuum and halogen gas compatible processing chamber further comprises a plasma generating system comprising a cathode, an anode, and an electric field therebetween, wherein the electric field generates a plasma plume that can activate the formation of chalcogenide-based solid-state electrolytes.
